(19) United States
(12) Patent Application Publication
(10) Pub. No.: US 2023/0052866 A1
(43) Pub. Date: Feb. 16, 2023

(54) POSITIVE ELECTRODE ACTIVE MATERIAL, SECONDARY BATTERY, AND ELECTRONIC DEVICE

(71) Applicant: SEMICONDUCTOR ENERGY LABORATORY CO., LTD., ATSUGI-SHI, KANAGAWA-KEN (JP)

(72) Inventors: Mayumi MIKAMI, Atsugi, Kanagawa (JP); Jo SAITO, Atsugi, Kanagawa (JP); Teruaki OCHIAI, Atsugi, Kanagawa (JP); Yohei MOMMA, Isehara, Kanagawa (JP); Yoshimi NAKASHIMA, Isehara, Kanagawa (JP); Yoshiharu ASADA, Odawara, Kanagawa (JP); Kazuki TANEMURA, Isehara, Kanagawa (JP)

(21) Appl. No.: 17/788,844

(22) PCT Filed: Dec. 15, 2020
(86) PCT No.: PCT/IB2020/061919

§ 371 Date: Jun. 24, 2022

(30) Foreign Application Priority Data
Dec. 27, 2019 (JP) 2019-238662
Oct. 26, 2020 (JP) 2020-178781

(51) Int. Cl. H01M 4/525; H01M 10/0525; H01M 4/36

(52) U.S. Cl. CPC H01M 4/525; H01M 10/0525; H01M 4/366; H01M 2004/8689

(57) ABSTRACT

A positive electrode active material having a crystal structure that is unlikely to be broken by repeated charging and discharging is provided. A positive electrode active material with high charge and discharge capacity is provided. A positive electrode active material including lithium, cobalt, nickel, magnesium, and oxygen, in which the a-axis lattice constant of an outermost surface layer of the positive electrode active material is larger than the a-axis lattice constant of an inner portion and in which the c-axis lattice constant of the outermost surface layer is larger than the c-axis lattice constant of the inner portion. A rate of change between the a-axis lattice constant of the outermost surface layer and the a-axis lattice constant of the inner portion is preferably larger than 0 and less than or equal to 0.12, and a rate of change between the c-axis lattice constant of the outermost surface layer and the c-axis lattice constant of the inner portion is preferably larger than 0 and less than or equal to 0.18.

### TECHNICAL FIELD

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Documents 1 to 3). Crystal structures of positive electrode active materials have also been studied (Non-Patent Documents 1 to 3).

X-ray diffraction (XRD) is one of methods used for analysis of a crystal structure of a positive electrode active material. With the use of the ICSD (Inorganic Crystal Structure Database) described in Non-Patent Document 4, XRD data can be analyzed.

### REFERENCE

### Patent Document

[Patent Document 1] Japanese Published Patent Application No. H8-236114
[Patent Document 2] Japanese Published Patent Application No. 2002-124262
[Patent Document 3] Japanese Published Patent Application No. 2002-358953

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4] Belsky, A. et al., “New developments in the Inorganic Crystal Structure Database (ICSD): accessibility in support of materials research and design”, Acta Cryst., (2002) B58, 364-369.

### SUMMARY OF THE INVENTION

### Problems to be Solved by the Invention

However, development of lithium-ion secondary batteries and positive electrode active materials used therein has room for improvement in terms of charge and discharge capacity, cycle performance, reliability, safety, cost, and the like.

An object of one embodiment of the present invention is to provide a positive electrode active material which suppresses a decrease in charge and discharge capacity due to charge and discharge cycles when used in a lithium-ion secondary battery. Another object is to provide a positive electrode active material having a crystal structure that is unlikely to be broken by repeated charging and discharging. Another object is to provide a positive electrode active material with high charge and discharge capacity. Another object is to provide a highly safe or highly reliable secondary battery.

Another object of one embodiment of the present invention is to provide a positive electrode active material, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

### Means for Solving the Problems

One embodiment of the present invention is a positive electrode active material including lithium, cobalt, nickel, magnesium, and oxygen, in which an a-axis lattice constant of an outermost surface layer of the positive electrode active material A_{surface} is larger than an a-axis lattice constant of an inner portion A_{core} and in which a c-axis lattice constant of the outermost surface layer C_{surface} is larger than a c-axis lattice constant of the inner portion C_{core}.

In the above, a rate of change R_{A} obtained by dividing a difference Δ_{A} between the a-axis lattice constant of the outermost surface layer A_{surface} and the a-axis lattice constant of the inner portion A_{core} by the lattice constant A_{core} is preferably larger than 0 and less than or equal to 0.12, and a rate of change R_{C} obtained by dividing a difference Δ_{C} between the c-axis lattice constant of the outermost surface layer C_{surface} and the c-axis lattice constant of the inner portion C_{core} by the lattice constant C_{core} is larger than 0 and less than or equal to 0.18.

In the above, the rate of change R_{A} is preferably larger than or equal to 0.05 and less than or equal to 0.07, and the rate of change R_{C} is preferably larger than or equal to 0.09 and less than or equal to 0.12.

In the above, the difference Δ_{C} between the c-axis lattice constant of the outermost surface layer C_{surface} and the c-axis lattice constant of the inner portion C_{core} is preferably larger than the difference Δ_{A} between the a-axis lattice constant of the outermost surface layer A_{surface} and the a-axis lattice constant of the inner portion A_{core}.

Another embodiment of the present invention is a positive electrode active material including lithium, cobalt, nickel, magnesium, and oxygen, in which at least part of an outermost surface layer of the positive electrode active material has a layered rock-salt crystal structure having a transition metal site layer and a lithium site layer alternately and in which part of the lithium site layer includes a metal element having a larger atomic number than lithium.

In the above, the metal element having a larger atomic number than lithium is preferably magnesium, cobalt, or aluminum.

In the above, in a cross-sectional TEM image of the outermost surface layer, a luminance of the lithium site layer is preferably greater than or equal to 3% and less than or equal to 60% of a luminance of the transition metal site layer.

In the above, a nickel concentration in the outermost surface layer is preferably less than or equal to 1 atomic %, and a nickel concentration is preferably greater than or equal to 0.05% and less than or equal to 4% of a cobalt concentration in the entire positive electrode active material.

In the above, the outermost surface layer preferably includes a region in which bright spots indicating a rock-salt crystal structure belonging to a space group Fm-3m or Fd-3m are observed and bright spots indicating a layered rock-salt crystal structure belonging to a space group R-3m are observed in a nanobeam electron diffraction pattern, and the inner portion preferably includes a region in which bright spots indicating the layered rock-salt crystal structure belonging to the space group R-3m are observed in a nanobeam electron diffraction pattern.

In the above, a spin density attributed to any one or more of a divalent nickel ion, a trivalent nickel ion, a divalent cobalt ion, and a tetravalent cobalt ion is preferably higher than or equal to 2.0×10¹⁷ spins/g and lower than or equal to 1.0×10²¹ spins/g.

In the above, the positive electrode active material preferably includes aluminum, and an aluminum concentration is preferably greater than or equal to 0.05% and less than or equal to 4% of a cobalt concentration in the entire positive electrode active material.

In the above, a peak of the aluminum concentration is preferably positioned at a depth of greater than or equal to 5 nm and less than or equal to 30 nm toward a center from a surface by energy dispersive X-ray spectroscopy on a cross section of the positive electrode active material.

Another embodiment of the present invention is a lithium-ion secondary battery including a positive electrode active material, in which the positive electrode active material includes lithium, cobalt, nickel, magnesium, and oxygen; in which an a-axis lattice constant of an outermost surface layer of the positive electrode active material A_{surface} is larger than an a-axis lattice constant of an inner portion A_{core}; and in which a c-axis lattice constant of the outermost surface layer of the positive electrode active material C_{surface} is larger than a c-axis lattice constant of the inner portion C_{core}.

Another embodiment of the present invention is an electronic device including the above-described secondary battery.

### Effect of the Invention

With one embodiment of the present invention, a positive electrode active material which suppresses a decrease in charge and discharge capacity due to charge and discharge cycles when used in a lithium-ion secondary battery can be provided. Alternatively, a positive electrode active material having a crystal structure that is unlikely to be broken by repeated charging and discharging can be provided. Alternatively, a positive electrode active material with high charge and discharge capacity can be provided. Alternatively, a highly safe or highly reliable secondary battery can be provided.

With another embodiment of the present invention, a positive electrode active material, a power storage device, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. TA is a cross-sectional view of a positive electrode active material, and FIG. 1B, FIG. 1C1, and FIG. 1C2 are part of the cross-sectional view of the positive electrode active material.

FIG. 2A1 to FIG. 2C2 are part of the cross-sectional view of the positive electrode active material.

FIG. 3 is a cross-sectional view of a positive electrode active material.

FIG. 4 is a diagram illustrating the charge depth and crystal structures of a positive electrode active material.

FIG. 5 is a graph showing an XRD pattern calculated from crystal structures.

FIG. 6 is a diagram illustrating the charge depth and crystal structures of a positive electrode active material of a comparative example.

FIG. 7 is a graph showing an XRD pattern calculated from crystal structures.

FIG. 8A to FIG. 8C show lattice constants calculated from XRD.

FIG. 9A to FIG. 9C show lattice constants calculated from XRD.

FIG. 10 is a diagram showing a method for manufacturing a positive electrode active material.

FIG. 11 is a diagram showing a method for manufacturing a positive electrode active material.

FIG. 12 is a diagram showing a method for manufacturing a positive electrode active material.

FIG. 13 is a diagram showing a method for manufacturing a positive electrode active material.

FIG. 14 is a diagram showing a method for manufacturing a positive electrode active material.

FIG. 15 is a diagram showing a method for manufacturing a positive electrode active material.

FIG. 16A and FIG. 16B are cross-sectional views of an active material layer using a graphene compound as a conductive material.

FIG. 17A and FIG. 17B are diagrams illustrating examples of a secondary battery.

FIG. 18A to FIG. 18C are diagrams illustrating an example of a secondary battery.

FIG. 19A and FIG. 19B are diagrams illustrating an example of a secondary battery.

FIG. 20A to FIG. 20C are diagrams illustrating a coin-type secondary battery.

FIG. 21A to FIG. 21D are diagrams illustrating cylindrical secondary batteries.

FIG. 22A and FIG. 22B are diagrams illustrating an example of a secondary battery.

FIG. 23A to FIG. 23D are diagrams illustrating examples of secondary batteries.

FIG. 24A and FIG. 24B are diagrams illustrating examples of secondary batteries.

FIG. 25 is a diagram illustrating an example of a secondary battery.

FIG. 26A to FIG. 26C are diagrams illustrating a laminated secondary battery.

FIG. 27A and FIG. 27B are diagrams illustrating a laminated secondary battery.

FIG. 28 is an external view of a secondary battery.

FIG. 29 is an external view of a secondary battery.

FIG. 30A to FIG. 30C are diagrams illustrating a method for manufacturing a secondary battery.

FIG. 31A to FIG. 31H are diagrams illustrating examples of electronic devices.

FIG. 32A to FIG. 32C are diagrams illustrating an example of an electronic device.

FIG. 33 is a diagram illustrating examples of electronic devices.

FIG. 34A to FIG. 34D are diagrams illustrating examples of electronic devices.

FIG. 35A to FIG. 35C are diagrams illustrating examples of electronic devices.

FIG. 36A to FIG. 36C are diagrams illustrating examples of vehicles.

FIG. 37A to FIG. 37D are surface SEM images of positive electrode active materials.

FIG. 38A is a cross-sectional TEM image of a positive electrode active material. FIG. 38B and FIG. 38C are selected-area electron diffraction patterns of part of FIG. 38A.

FIG. 39A and FIG. 39B are nanobeam electron diffraction patterns of the positive electrode active material.

FIG. 40A is a cross-sectional TEM image of the positive electrode active material. FIG. 40B and FIG. 40C are nanobeam electron diffraction patterns of part of FIG. 40A.

FIG. 41A is a cross-sectional TEM image of the positive electrode active material. FIG. 41B and FIG. 41C are nanobeam electron diffraction patterns of part of FIG. 41A.

FIG. 42A to FIG. 42C are cross-sectional STEM images of the positive electrode active material.

FIG. 43A is a cross-sectional STEM image of the positive electrode active material and a diagram obtained by rotating FIG. 42B. FIG. 43B shows a result of measuring the luminance in FIG. 43A.

FIG. 44A is a graph obtained by correcting the background in FIG. 43B. FIG. 44B is a cross-sectional STEM bright-field image of the positive electrode active material.

FIG. 45A is a cross-sectional HAADF-STEM image of the positive electrode active material.

FIG. 45B to FIG. 45F show results of EDX surface analysis.

FIG. 46A is a cross-sectional HAADF-STEM image of the positive electrode active material.

FIG. 46B to FIG. 46D show results of EDX surface analysis.

FIG. 47A is a cross-sectional HAADF-STEM image of the positive electrode active material.

FIG. 47B to FIG. 47E are images obtained by inverting the brightness of the results of EDX surface analysis.

FIG. 48 is a cross-sectional HAADF-STEM image of the positive electrode active material.

FIG. 49A and FIG. 49B show results of EDX line analysis of the positive electrode active material.

FIG. 50A and FIG. 50B are SEM images of positive electrode active materials.

FIG. 51A and FIG. 51B show grayscale values of the positive electrode active materials.

FIG. 52A and FIG. 52B are luminance histograms of the positive electrode active materials.

FIG. 53 shows XRD patterns of positive electrode active materials.

FIG. 54A and FIG. 54B show XRD patterns obtained by enlarging part of FIG. 53.

FIG. 55 shows XRD patterns of the positive electrode active material.

FIG. 56A and FIG. 56B show XRD patterns obtained by enlarging part of FIG. 55.

FIG. 57 shows XRD patterns of the positive electrode active material.

FIG. 58A and FIG. 58B show XRD patterns obtained by enlarging part of FIG. 57.

FIG. 59 shows XRD patterns of the positive electrode active material.

FIG. 60A and FIG. 60B show XRD patterns obtained by enlarging part of FIG. 59.

FIG. 61A and FIG. 61B are graphs showing cycle performance of positive electrode active materials.

FIG. 62A and FIG. 62B are graphs showing cycle performance of positive electrode active materials.

FIG. 63A and FIG. 63B are graphs showing cycle performance of positive electrode active materials.

FIG. 64A and FIG. 64B are graphs showing cycle performance of positive electrode active materials.

FIG. 65A and FIG. 65B are graphs showing cycle performance of positive electrode active materials.

FIG. 66A and FIG. 66B are graphs showing cycle performance of positive electrode active materials.

FIG. 67A and FIG. 67B are graphs showing cycle performance of positive electrode active materials.

FIG. 68A and FIG. 68B are graphs showing cycle performance of a positive electrode active material.

### MODE FOR CARRYING OUT THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing a minus sign (−) in front of the number instead of placing a bar over the number.

In this specification and the like, segregation refers to a phenomenon in which, in a solid made of a plurality of elements (e.g., A, B, and C), a certain element (e.g., B) is spatially non-uniformly distributed.

A surface of a positive electrode active material refers to a surface of a composite oxide including a surface portion including the above-mentioned outermost surface layer, an inner portion, and the like. Therefore, the positive electrode active material does not include a carbonic acid, a hydroxy group, or the like which is chemically adsorbed after formation of the positive electrode active material. Furthermore, an electrolyte solution, a binder, a conductive material, and a compound originating from any of these that are attached to the positive electrode active material are not included either. Not all of the positive electrode active material need to be a region including a lithium site that contributes to charging and discharging.

In this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may partly exist as long as two-dimensional diffusion of lithium ions is possible. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist partly.

In this specification and the like, a mixture refers to a plurality of materials mixed. Among mixtures, a mixture in which mutual diffusion of elements has occurred may be referred to as a composite. The composite may partly contain an unreacted material. The positive electrode active material may also be referred to as a composite, a composite oxide, or a material.

In this specification and the like, a theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the charge depth obtained when all lithium that can be inserted and extracted is inserted is 0, and the charge depth obtained when all lithium that can be inserted and extracted and is contained in a positive electrode active material is extracted is 1.

In general, a positive electrode active material having the layered rock-salt crystal structure has an unstable crystal structure when lithium between layers consisting of a transition metal and oxygen decreases. For this reason, in a general secondary battery using lithium cobalt oxide, the charge depth, the charge voltage (in the case of a lithium counter electrode), and the charge capacity are limited to about 0.4, 4.3 V, and 160 mAh/g, respectively, in charging.

In contrast, a positive electrode active material with a charge depth of greater than or equal to 0.74 and less than or equal to 0.9, more specifically, a charge depth of greater than or equal to 0.8 and less than or equal to 0.83 is referred to as a high-voltage charged positive electrode active material. Thus, for example, LiCoO₂ charged to a charge capacity of 219.2 mAh/g is a high-voltage charged positive electrode active material. In addition, LiCoO₂ that is subjected to constant current charging in an environment at 25° C. and charge voltage of higher than or equal to 4.525 V and lower than or equal to 4.7 V (in the case of a lithium counter electrode), and then subjected to constant voltage charging until the current value becomes 0.01 C or approximately ⅕ to 1/100 of the current value at the time of the constant current charging is also referred to as a high-voltage charged positive electrode active material. Note that C is an abbreviation for Capacity rate, and 1C refers to the current amount with which the charge and discharge capacity of a secondary battery is fully charged or fully discharged in one hour.

For a positive electrode active material, insertion of lithium ions is called discharging. A positive electrode active material with a charge depth of less than or equal to 0.06 or a positive electrode active material from which more than or equal to 90% of the charge capacity is discharged from a high-voltage charged state is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In this specification and the like, an example in which a lithium metal is used as a counter electrode in a secondary battery using a positive electrode and a positive electrode active material of one embodiment of the present invention is described in some cases; however, the secondary battery of one embodiment of the present invention is not limited to this example. Another material such as graphite or lithium titanate may be used as a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. The secondary battery of one embodiment of the present invention using a lithium counter electrode is charged and discharged at a voltage higher than a general charge voltage of approximately 4.7 V in some cases; however, charging and discharging may be performed at a lower voltage. Charging and discharging at a lower voltage may lead to the cycle performance better than that described in this specification and the like.

In this specification and the like, a charge voltage and a discharge voltage are voltages in the case of using a lithium counter electrode, unless otherwise specified. Note that even when the same positive electrode is used, the charge and discharge voltages of a secondary battery vary depending on the material used for the negative electrode. For example, the potential of graphite is approximately 0.1 V (vs Li/Li⁺); hence, the charge and discharge voltages in the case of using a graphite negative electrode are lower than those in the case of using a lithium counter electrode by approximately 0.1 V.

### Embodiment 1

In this embodiment, a positive electrode active material of one embodiment of the present invention is described with reference to FIG. 1 to FIG. 9.

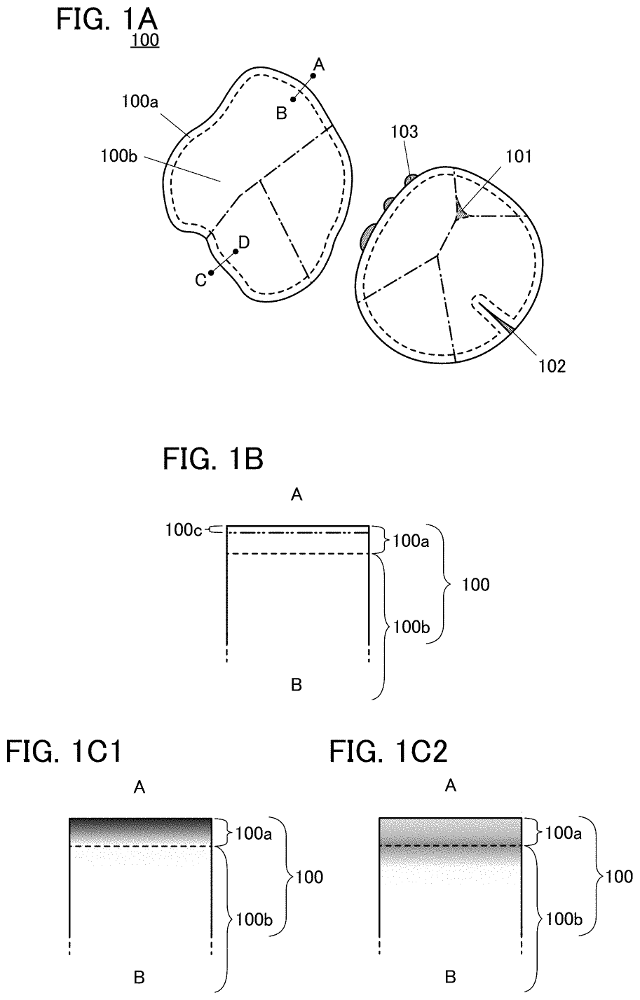

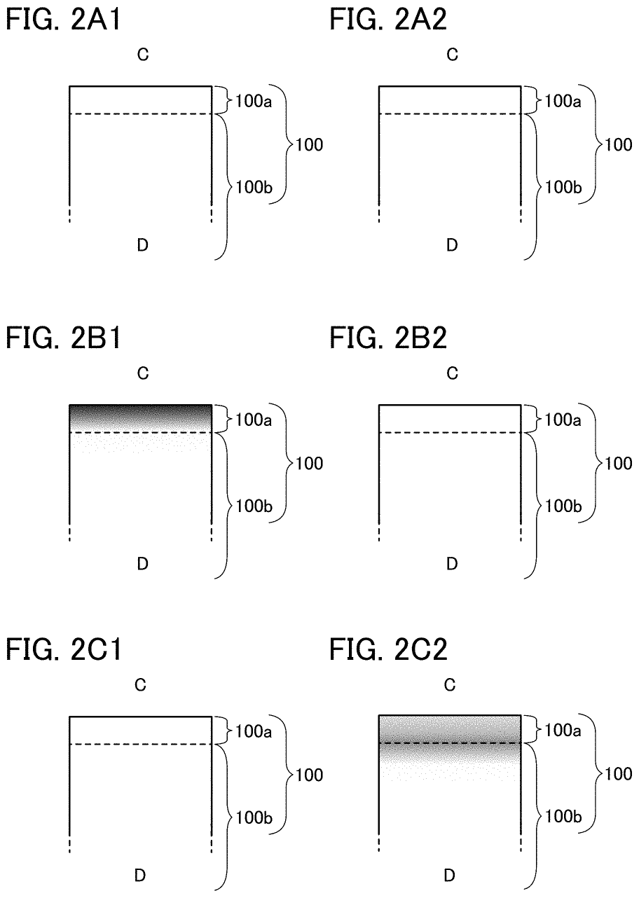

FIG. 1A is a cross-sectional view of a positive electrode active material 100 of one embodiment of the present invention. FIG. 1B, FIG. 1C1, and FIG. 1C2 show enlarged views of a portion near A-B in FIG. 1A. FIG. 2A1, FIG. 2A2, FIG. 2B1, FIG. 2B2, FIG. 2C1, and FIG. 2C2 show enlarged views of a portion near C-D in FIG. 1A.

As illustrated in FIG. 1A to FIG. 2C2, the positive electrode active material 100 includes a surface portion 100a and an inner portion 100b. In each drawing, the dashed line denotes a boundary between the surface portion 100a and the inner portion 100b. In FIG. 1A, the dashed-dotted line denotes part of a crystal grain boundary. Furthermore, the positive electrode active material 100 includes an outermost surface layer 100c in part of the surface portion 100a. In FIG. 1B, the dashed double-dotted line denotes a boundary of the outermost surface layer 100c in the surface portion 100a.

In this specification and the like, the surface portion 100a refers to a region that is up to approximately 10 nm in depth from the surface toward the inner portion of the positive electrode active material. A plane generated by a split or a crack may also be considered as the surface. The surface portion 100a may also be referred to as the vicinity of a surface, a region in the vicinity of a surface, a shell, or the like. The inner portion 100b refers to a region deeper than the surface portion 100a of the positive electrode active material. The inner portion 100b may also be referred to as an inner region, a core, or the like. Furthermore, the outermost surface layer 100c refers to a region that is up to 3 nm in depth from the surface toward the inner portion 100b in the surface portion 100a of the positive electrode active material.

### <Each Region and Lattice Constants>

The positive electrode active material 100 of one embodiment of the present invention preferably has a crystal structure in both the surface portion 100a and the inner portion 100b. The a-axis lattice constant in the crystal structure of the surface portion 100a is preferably larger than the a-axis lattice constant A_{core} in the crystal structure of the inner portion 100b. Furthermore, the b-axis lattice constant in the crystal structure of the surface portion 100a is preferably larger than the b-axis lattice constant B_{core} in the crystal structure of the inner portion 100b. Moreover, the c-axis lattice constant in the crystal structure of the surface portion 100a is preferably larger than the c-axis lattice constant C_{core} in the crystal structure of the inner portion 100b.

Furthermore, the outermost surface layer 100c in the positive electrode active material 100 also preferably has a crystal structure. The a-axis lattice constant A_{surface} in the crystal structure of the outermost surface layer 100c is preferably larger than the a-axis lattice constant of the surface portion 100a and the a-axis lattice constant A_{core} of the inner portion 100b. Furthermore, the b-axis lattice constant B_{surface} in the crystal structure of the outermost surface layer 100c is preferably larger than the b-axis lattice constant of the surface portion 100a and the b-axis lattice constant B_{core} of the inner portion 100b. Moreover, the c-axis lattice constant C_{surface} in the crystal structure of the outermost surface layer 100c is preferably larger than the c-axis lattice constant of the surface portion 100a and the c-axis lattice constant C_{core} of the inner portion 100b.

Furthermore, a difference obtained by subtracting the a-axis lattice constant A_{core} of the inner portion from the a-axis lattice constant A_{surface} of the outermost surface layer is referred to as Δ_{A}. Similarly, a difference obtained by subtracting the c-axis lattice constant C_{core} of the inner portion from the c-axis lattice constant C_{surface} of the outermost surface layer is referred to as Δ_{C}. At this time, Δ_{A} is preferably larger than Δ_{C}.

As shown by Formula 1 and Formula 2 below, a value obtained by dividing Δ_{A} by A_{core} is a rate of change R_{A}. A value obtained by dividing Δ_{C} by C_{core} is a rate of change R_{C}.

$$\begin{matrix}[ Formula 1 ] & \\ {R}_{A} = \frac{{A}_{surface} - {A}_{core}}{{A}_{core}} & ( Formula 1 )\end{matrix}$$

$$\begin{matrix}[ Formula 2 ] & \\ {R}_{C} = \frac{{C}_{surface} - {C}_{core}}{{C}_{core}} & ( Formula 2 )\end{matrix}$$

At this time, the rate of change R_{A} is preferably larger than 0 and less than or equal to 0.12, further preferably larger than or equal to 0.05 and less than or equal to 0.07. Alternatively, the rate of change R_{A} is preferably larger than 0 and less than or equal to 0.07. Alternatively, the rate of change R_{A} is preferably larger than or equal to 0.05 and less than or equal to 0.12.

The rate of change R_{C} is preferably larger than 0 and less than or equal to 0.18, further preferably larger than or equal to 0.09 and less than or equal to 0.12. Alternatively, the rate of change R_{C} is preferably larger than 0 and less than or equal to 0.12. Alternatively, the rate of change R_{C} is preferably larger than or equal to 0.09 and less than or equal to 0.18.

For easy comparison between regions, the lattice constants are calculated on the assumption that the regions belong to the same space group.

For example, calculation is preferably performed using a model in which each of the regions has the same crystal structure, belong to the same space group, and has the same number of atoms per unit cell. For example, although the layered rock-salt structure belonging to R-3m cannot be expressed by Fm-3m, the rock-salt structure belonging to Fm-3m can be expressed by R-3m. Thus, for example, in the case where the inner portion 100b has a feature of the layered rock-salt structure belonging to R-3m and the surface portion 100a and the outermost surface layer 100c have a feature of the rock-salt structure belonging to Fm-3m, the lattice constants in each of the regions are calculated using the layered rock-salt crystal structure belonging to the space group R-3m as a model, whereby the comparison of the lattice constants between the regions is facilitated. Note that the a-axis and the b-axis are equal in length in the layered rock-salt crystal structure belonging to the space group R-3m; thus, the a-axis is representatively described below regarding the layered rock-salt crystal structure belonging to the space group R-3m.

Even if every region is difficult to express with the same space group, in the case where anion packing is almost common, models having the same number of anions can be considered as having equivalent symmetry. In this case, instead of the lattice constants, the distance between anions may be used for comparison of the regions. For example, anions in each of the rock-salt structure, the layered rock-salt structure, and the spinel structure have the cubic close-packed structure (ccp arrangement), and they have an almost common anion packed structure. In this case, the structures having different space groups can be compared as having similar symmetry. The distance between anions can be calculated from the Rietveld analysis result of the XRD pattern, for example.

Described below is an example of using the layered rock-salt crystal structure belonging to the space group R-3m as a model for calculation of lattice constants in each region; however, one embodiment of the present invention is not limited to this. An optimal structure is preferably selected in accordance with the material of the positive electrode active material 100. For example, the crystal structure that occupies the largest volume among the crystal structures in the positive electrode active material 100 is preferably adopted. Other than the layered rock-salt structure, a crystal structure such as the rock-salt structure, the spinel structure, or the olivine structure can be used, for example.

Judgement of whether the surface portion 100a, the inner portion 100b, and the outermost surface layer 100c have a crystal structure and determination of lattice constants in the case of having a crystal structure can be performed with electron diffraction such as cross-sectional TEM, cross-sectional STEM, selected-area electron diffraction, or nanobeam electron diffraction, for example.

When a regular atomic arrangement can be observed in a cross-sectional TEM image, a cross-sectional STEM image, or the like, the region can be regarded as having a crystal structure. When a diffraction pattern having regular spots is observed in an electron diffraction pattern or the like, the region can be regarded as having a crystal structure.

The selected-area electron diffraction and the nanobeam electron diffraction can analyze the crystal structure of a small region of approximately 20 nm and a smaller region of approximately 1 nm, respectively, and are suitable for determination of lattice constants in the surface portion 100a and the outermost surface layer 100c.

It should be noted that a measurement error owing to distortion in camera length or the like might be generated in these electron diffraction methods. Thus, the lattice constants obtained by the electron diffraction methods preferably have two significant digits. Alternatively, the lattice constants obtained by these electron diffraction methods may be corrected by referring to the lattice constants obtained by powder XRD, literature values, or the like.

For example, the inner portion 100b occupies most of the volume of the positive electrode active material 100. Thus, the lattice constants of the entire positive electrode active material 100 obtained by power XRD can be considered as being equal to the lattice constants of the inner portion 100b obtained by electron diffraction. The corrected lattice constants of the surface portion 100a and the outermost surface layer 100c can be obtained from the ratio of lattice constants, which are obtained by electron diffraction, of the inner portion 100b to the surface portion 100a and the outermost surface layer 100c and the lattice constants obtained by power XRD.

The surface portion 100a preferably has a higher concentration of an added element, which is described later, than the inner portion 100b. The additive preferably has a concentration gradient. In the case where a plurality of kinds of added elements are included, the added elements preferably exhibit concentration peaks at different depths from a surface.

For example, an added element X preferably has a concentration gradient as shown in FIG. 1C1 by gradation, in which the concentration increases from the inner portion 100b toward the surface. As examples of the added element X which preferably has such a concentration gradient, magnesium, fluorine, titanium, silicon, phosphorus, boron, calcium, and the like can be given.

Another added element Y preferably has a concentration gradient as shown in FIG. 1C2 by gradation and exhibits a concentration peak at a deeper region than the concentration peak in FIG. 1C1. The concentration peak may be located in the surface portion 100a or located deeper than the surface portion 100a. The concentration peak is preferably located in a region other than the outermost surface layer 100c. For example, the peak is preferably located in a region that is 5 nm to 30 nm inclusive in depth from the surface. As examples of the added element Y which preferably has such a concentration gradient, aluminum and manganese can be given.

It is preferable that the crystal structure continuously change from the inner portion 100b toward the surface portion 100a and the outermost surface layer 100c owing to the above-described concentration gradient of the added element.

For example, a case where the inner portion 100b has the layered rock-salt crystal structure is described. A feature of the layered rock-salt crystal structure is having a transition metal M layer and a lithium layer alternately between anions of the cubic close-packed structure. Therefore, the transition metal M layer having a large atomic number, which is observed with high luminance, and the lithium layer, which is observed with low luminance, are alternately observed in the inner portion 100b by cross-sectional TEM or the like. Note that oxygen anions and fluorine anions, which both have a small atomic number, are observed with almost the same luminance as lithium. These elements having small atomic numbers are not expressed by clear bright spots and have only a slight difference in brightness from the background, in some cases.

In this specification and the like, in the case of having the layer observed with high luminance and the layer observed with low luminance alternately in a cross-sectional TEM image or the like, the region is regarded as having a feature of the layered rock-salt crystal structure. This feature is observed when the layered rock-salt crystal structure is seen from a direction perpendicular to the c-axis. If the layered rock-salt crystal structure is seen from the other directions, that feature cannot be observed in some cases.

While in the outermost surface layer 100c, the concentration of the added element is high and thus the added element enters some lithium sites. Since the lithium sites are surrounded by anions of oxygen or the like, a metal element such as magnesium or aluminum among the added elements is likely to enter some of the lithium sites. Furthermore, a transition metal M, for example, cobalt, might enter some of the lithium sites. These elements have larger atomic numbers than lithium and are observed with higher luminance than lithium by cross-sectional TEM or the like.

In some cases, the added element or lithium enters some of transition metal M sites. In this cases, the added element or lithium is observed with lower luminance than the transition metal M by cross-sectional TEM or the like.

When many cation substitutions described above occur, a feature of the rock-salt crystal structure without any difference between lithium sites and transition metal sites is offered. Having the feature of the rock-salt crystal structure is indicative of the existence of an enough concentration of the added element. When the added element exists at an enough concentration, the dissolution of the transition metal M, extraction of oxygen, and the like, which can occur at the time of charging at high voltage, can be inhibited. Thus, battery characteristics, especially continuous charge tolerance, can be improved, thereby providing a highly safe and reliable secondary battery.

Furthermore, it is preferable that the outermost surface layer 100c also have the feature of the layered rock-salt crystal structure, similarly to the inner portion 100b. When the surface is covered with only the rock-salt crystal structure, a lithium diffusion path might be obstructed and thus the internal resistance at the time of charging and discharging might be increased. For the same reason, the feature of the rock-salt crystal structure is preferably limited to the region from the surface to approximately 3 nm.

Therefore, the outermost surface layer 100c preferably has both the feature of the layered rock-salt crystal structure and the feature of the rock-salt crystal structure. In other words, the outermost surface layer 100c preferably has the layered rock-salt crystal structure having the layer observed with high luminance and the layer observed with low luminance alternately in a cross-sectional TEM image or the like and also has a metal having a larger atomic number than lithium in some lithium sites.

When the added element exists at a preferable concentration in some lithium sites in the outermost surface layer 100c, the luminance of a lithium site layer is greater than or equal to 3% and less than or equal to 60%, preferably greater than or equal to 4% and less than or equal to 50%, further preferably greater than or equal to 6% and less than or equal to 40% of the luminance of a transition metal M site layer in a cross-sectional TEM image. Alternatively, the luminance of the lithium site layer is preferably greater than or equal to 3% and less than or equal to 50%, greater than or equal to 3% and less than or equal to 40%, greater than or equal to 4% and less than or equal to 60%, greater than or equal to 4% and less than or equal to 40%, greater than or equal to 6% and less than or equal to 60%, or greater than or equal to 6% and less than or equal to 50% of the luminance of the transition metal M site layer. Note that the lithium site layer and the transition metal M site layer used for comparison preferably have a width of 5 nm or more parallel to the arrangement of the transition metal M.

The luminance in cross-sectional TEM or the like can be calculated by estimating the luminance of pixels in a cross-sectional TEM dark-field image, for example. Similarly, the luminance of the transition metal M site layer and the luminance of the lithium site layer can be calculated by estimating the luminance of pixels that are parallel to these layers. Specifically, an image is expressed by a grayscale with black set at a luminance of 0 and white set at a luminance of 255, and the luminance of pixels are estimated column by column. For easy comparison of the luminance of the metal site layer, the correction for omitting the luminance derived from an element having a small atomic number, such as oxygen, may be performed.

Note that a sample of the cross-sectional TEM or the like has a thickness of approximately 20 nm to 200 nm. For this reason, in the case where the surface of the positive electrode active material 100 is uneven, a precise luminance cannot be obtained in a shallow portion from the surface, in some cases. Thus, the luminance needs to be compared between the portions from which luminance can be stably obtained. For example, when the maximum value of the luminance of the transition metal M site layer is assumed to be 1, the transition metal M site layer having a luminance of 0.7 or higher can be regarded as exhibiting stable luminance.

In this specification and the like, the surface of the positive electrode active material 100 in a cross-sectional TEM image, a cross-sectional STEM image, or the like refers to a plane in which a metal element having a larger atomic number than lithium is first observed. More specifically, the surface of the positive electrode active material 100 refers to a point in which an atomic nucleus of a metal element having a larger atomic number than lithium, that is, a luminance peak in the cross-sectional TEM image or the like first exists.

At least part of the outermost surface layer 100c in the positive electrode active material has both the feature of the layered rock-salt crystal structure and the feature of the rock-salt crystal structure as described above. Although the above-described features are easily observed when a crystal plane exposed on the surface of the positive electrode active material is substantially parallel to the (001) plane of R-3m, these features cannot be observed clearly depending on the crystal plane. Thus, the luminance ratio between the transition metal site layer and the lithium site layer does not necessarily have to be within the above-described ranges.

Furthermore, electron diffraction can also analyze the features of the layered rock-salt crystal structure and the rock-salt crystal structure.

The rock-salt structure holds one kind of cations and has high symmetry. In contrast, the layered rock-salt structure holds two kinds of regularly arranged cations and has lower symmetry than the rock-salt structure and thus has double the bright spots corresponding to a particular plane orientation of the rock-salt structure.

In the case of the crystal structure having both of the features of the rock-salt structure and the layered rock-salt structure, a plane orientation where a bright spot with high luminance and a bright spot with low luminance are alternately arranged in a diffraction image exists. A bright spot common between the rock-salt structure and the layered rock-salt structure has high luminance, whereas a bright spot caused only in the layered rock-salt structure has low luminance.

Note that the transition metal M, especially cobalt and nickel, is preferably dissolved uniformly in the entire positive electrode active material 100. In the case where the concentration of a kind of the transition metal M, e.g., nickel, is low, the concentration is sometimes below the detection limit of the analysis of XPS, XPS, or the like.

When the atomic number of nickel is less than the atomic number of cobalt by 2 atomic % or more, nickel in a lithium composite oxide accounts for lower than or equal to 0.5 atomic %. The detection limit of XPS and EDX is approximately 1 atomic %. Thus, when nickel is dissolved uniformly in the entire positive electrode active material 100, the concentration can be below the detection limit of the analyzing method such as XPS or EDX. In this case, the concentration below the detection limit indicate that the nickel concentration is lower than or equal to 1 atomic % or that nickel is dissolved in the entire positive electrode active material 100.

Using ICP-MS or the like, the transition metal can be quantified even when the concentration is lower than or equal to 1 atomic %.

Note that an added element that is widely dissolved in the inner portion 100b of the positive electrode active material 100 and does not have a concentration gradient may be included. A kind of the transition metal M, e.g., manganese, included in the positive electrode active material 100 may have a concentration gradient in which the concentration increases from the inner portion 100b to the surface.

### <Contained Element>

The positive electrode active material 100 contains lithium, the transition metal M, oxygen, and an added element. The positive electrode active material 100 can be regarded as a composite oxide represented by LiMO₂ to which an added element is added. Note that the positive electrode active material of one embodiment of the present invention needs to have a crystal structure of a lithium composite oxide represented by LiMO₂, but the composition is not strictly limited to Li:M:O=1:1:2.

As the transition metal M contained in the positive electrode active material 100, a metal that can form, together with lithium, a composite oxide having the layered rock-salt structure belonging to the space group R-3m is preferably used. For example, at least one of manganese, cobalt, and nickel can be used. That is, as the transition metal contained in the positive electrode active material 100, cobalt may be used alone, nickel may be used alone, cobalt and manganese may be used, cobalt and nickel may be used, or cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Specifically, using cobalt at greater than or equal to 75 atomic %, preferably greater than or equal to 90 atomic %, further preferably greater than or equal to 95 atomic % as the transition metal M contained in the positive electrode active material 100 brings many advantages such as relatively easy synthesis, easy handling, and excellent cycle performance. Moreover, when nickel is contained as the transition metal M in addition to cobalt in the above range, a shift in a layered structure formed of octahedrons of cobalt and oxygen is sometimes inhibited. This is preferable because the inhibition of the shift enables higher stability of the crystal structure particularly in a high-temperature charged state in some cases.

Note that manganese is not necessarily contained as the transition metal M. When the positive electrode active material 100 is substantially free from manganese, the above advantages, including relatively easy synthesis, easy handling, and excellent cycle performance, are sometimes enhanced. The weight of manganese contained in the positive electrode active material 100 is preferably less than or equal to 600 ppm, further preferably less than or equal to 100 ppm, for example.

Using nickel at greater than or equal to 33 atomic %, preferably greater than or equal to 60 atomic %, further preferably greater than or equal to 80 atomic % as the transition metal M contained in the positive electrode active material 100 is preferable because in that case, the cost of the raw materials might be lower than that in the case of using a large amount of cobalt and charge and discharge capacity per weight might be increased.

Note that nickel is not necessarily contained as the transition metal M.

As the added element contained in the positive electrode active material 100, at least one of magnesium, fluorine, aluminum, titanium, zirconium, vanadium, iron, chromium, niobium, cobalt, arsenic, zinc, silicon, sulfur, phosphorus, and boron is preferably used. Such added elements further stabilize the crystal structure of the positive electrode active material 100 in some cases as described later. The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the added element may be rephrased as a mixture, a constituent of a material, an impurity element, or the like.

Note that as the added element, magnesium, fluorine, aluminum, titanium, zirconium, vanadium, iron, chromium, niobium, cobalt, arsenic, zinc, silicon, sulfur, phosphorus, or boron is not necessarily contained.

In order to prevent breakage of a layered structure formed of octahedrons of cobalt and oxygen even when lithium is extracted from the positive electrode active material 100 of one embodiment of the present invention owing to charging, the positive electrode active material 100 is reinforced with the surface portion 100a having a high added-element concentration, i.e., the outer portion of the particle.

The added-element concentration gradient is preferably similar throughout the surface portion 100a of the positive electrode active material 100. In other words, it is preferable that the reinforcement derived from the high impurity concentration uniformly occurs in the surface portion 100a. When the surface portion 100a partly has reinforcement, stress might be concentrated on parts that do not have reinforcement. The concentration of stress on part of a particle might cause defects such as cracks from that part, leading to cracking of the positive electrode active material and a decrease in charge and discharge capacity.

Note that in this specification and the like, uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface portion, a surface, a projection, a depression, and an inner portion.

Note that all the added elements do not necessarily have similar concentration gradients throughout the surface portion 100a of the positive electrode active material 100. For example, FIG. 2A1, FIG. 2B1, and FIG. 2C1 show examples of distribution of the added element X in the vicinity of C-D in FIG. 1A. FIG. 2A2, FIG. 2B2, and FIG. 2C2 show examples of distribution of the added element Y in the vicinity of C-D.

For example, as shown in FIG. 2A1 and FIG. 2A2, there may be a region of the surface portion 100a where neither the added element X nor the added element Y exists. As shown in FIG. 2B1 and FIG. 2B2, there may be a region where the added element X exists but the added element Y does not exist. As shown in FIG. 2C1 and FIG. 2C2, there may be a region where the added element X does not exist but the added element Y exists. The added element Y in FIG. 2C2 preferably has a peak in a region that is not in the outermost surface layer in a manner similar to that of FIG. 1C2, and preferably has a peak in a region that is 3 nm to 30 nm from the surface, for example.

Furthermore, the positive electrode active material 100 may include a filling portion 102 and a projection 103 as shown in FIG. 1A. The added element may exist in the filling portion 102 and the projection 103 at a higher concentration than that in the inner portion 100b or the surface portion 100a.

The positive electrode active material 100 has a depression, a crack, a concave, a V-shaped cross section, or the like in some cases. These are examples of defects, and when charging and discharging are repeated, dissolution of the transition metal M, breakage of a crystal structure, cracking of the positive electrode active material 100, extraction of oxygen, or the like might be derived from these defects. However, when there is a filling portion 102 that fills such defects, dissolution of the transition metal M or the like can be inhibited. Thus, the positive electrode active material 100 can have high reliability and excellent cycle performance.

The positive electrode active material 100 may include a projection 103, which is a region where the added element is unevenly distributed.

As described above, an excessive amount of the added element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the added element is insufficient, the added element is not distributed throughout the surface portion 100a, which might diminish the effect of inhibiting degradation of a crystal structure. The impurity element (also referred to as the added element) is required to be contained in the positive electrode active material 100 at an appropriate concentration; however, the adjustment of the concentration is not easy.

For this reason, in the positive electrode active material 100, when the region where the impurity element is unevenly distributed is included, part of the excess impurity is removed from the inner portion 100b, so that the impurity concentration can be appropriate in the inner portion 100b. This can inhibit an internal resistance increase, a charge and discharge capacity decrease, and the like when the positive electrode active material 100 is used for a secondary battery. A feature of inhibiting an internal resistance increase in a secondary battery is extremely preferable especially in charging and discharging at a high rate such as charging and discharging at 2C or more.

In the positive electrode active material 100 including the region where the impurity element is unevenly distributed, addition of excess impurities to some extent in the formation process is acceptable. This is preferable because the margin of production can be increased.

In this specification and the like, uneven distribution refers to a state where a concentration of a certain element is different from that in other regions, and may be rephrased as segregation, precipitation, unevenness, deviation, high concentration, low concentration, or the like.

Magnesium, which is an example of the added element X, is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. Magnesium can inhibit extraction of oxygen around magnesium at the time of high voltage charging. An appropriate concentration of magnesium does not have an adverse effect on insertion or extraction of lithium in charging and discharging, and is thus preferable. However, excess magnesium might adversely affect insertion and extraction of lithium. Thus, as will be described later, the concentration of the transition metal M is preferably higher than that of magnesium in the surface portion 100a, for example.

Aluminum, which is an example of the added element Y, is trivalent and can exist at a transition metal site in a layered rock-salt crystal structure. Aluminum can inhibit dissolution of surrounding cobalt. The bonding strength of aluminum with oxygen is high, thereby inhibiting extraction of oxygen around aluminum. Hence, aluminum contained as the added element enables the positive electrode active material 100 to have the crystal structure that is unlikely to be broken by repeated charging and discharging.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

An oxide of titanium is known to have superhydrophilicity. Accordingly, the positive electrode active material 100 including an oxide of titanium in the surface portion 100a presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a charge and discharge capacity decrease due to repeated charging and discharging.

A short circuit of a secondary battery might cause not only malfunction in charging operation and/or discharging operation of the secondary battery but also heat generation and firing. In order to obtain a safe secondary battery, a short-circuit current is preferably inhibited even at a high charge voltage. In the positive electrode active material 100 of one embodiment of the present invention, a short-circuit current is inhibited even at a high charge voltage; thus, a secondary battery having high charge and discharge capacity and a high level of safety can be obtained.

The concentration gradient of the added element can be evaluated using energy dispersive X-ray spectroscopy (EDX), electron probe microanalysis (EPMA), or the like. In the EDX measurement, the measurement in which a region is measured while scanning the region and evaluated two-dimensionally is referred to as EDX surface analysis. The measurement by line scan, which is performed to evaluate the atomic concentration distribution in a positive electrode active material particle, is referred to as line analysis. Furthermore, extracting data of a linear region from EDX surface analysis is referred to as line analysis in some cases. The measurement of a region without scanning is referred to as point analysis.

By EDX surface analysis (e.g., element mapping), the concentrations of the added element in the surface portion 100a including the outermost surface layer 100c, the inner portion 100b, the vicinity of the crystal grain boundary, and the like of the positive electrode active material 100 can be quantitatively analyzed. By EDX line analysis, the concentration distribution and the highest concentration of the added element can be analyzed.

When the positive electrode active material 100 containing magnesium as the added element is subjected to the EDX line analysis, a peak of the magnesium concentration in the surface portion 100a is preferably exhibited by a region that is 3 nm in depth, i.e., the outermost surface layer 100c, further preferably 1 nm in depth, still further preferably 0.5 nm in depth from the surface toward the center of the positive electrode active material 100.

When the positive electrode active material 100 contains magnesium and fluorine as the added elements, the distribution of fluorine preferably overlaps with the distribution of magnesium. Thus, in the EDX line analysis, a peak of the fluorine concentration in the surface portion 100a is preferably exhibited by a region that is 3 nm in depth, i.e., the outermost surface layer 100c, further preferably 1 nm in depth, still further preferably 0.5 nm in depth from the surface toward the center of the positive electrode active material 100.

Note that the concentration distribution may differ between the added elements. For example, in the case where the positive electrode active material 100 contains aluminum as the added element, the distribution of aluminum is preferably slightly different from that of magnesium and that of fluorine as described above. For example, in the EDX line analysis, the peak of the magnesium concentration is preferably closer to the surface than the peak of the aluminum concentration is in the surface portion 100a. For example, the peak of the aluminum concentration is preferably located at a depth of greater than or equal to 0.5 nm and less than or equal to 50 nm, further preferably greater than or equal to 5 nm and less than or equal to 30 nm from the surface toward the center of the positive electrode active material 100. Alternatively, the peak of the aluminum concentration is preferably located at a depth of greater than or equal to 0.5 nm and less than or equal to 30 nm. Further alternatively, the peak of the aluminum concentration is preferably located at a depth of greater than or equal to 5 nm and less than or equal to 50 nm.

When the positive electrode active material 100 is subjected to line analysis or surface analysis, the atomic ratio of an impurity element I to the transition metal M (I/M) in the surface portion 100a is preferably greater than or equal to 0.05 and less than or equal to 1.00. When the impurity element is titanium, the atomic ratio of titanium to the transition metal M (Ti/M) is preferably greater than or equal to 0.05 and less than or equal to 0.4, further preferably greater than or equal to 0.1 and less than or equal to 0.3. When the added element is magnesium, the atomic ratio of magnesium to the transition metal M (Mg/M) is preferably greater than or equal to 0.4 and less than or equal to 1.5, further preferably greater than or equal to 0.45 and less than or equal to 1.00. When the impurity element is fluorine, the atomic ratio of fluorine to the transition metal M (F/M) is preferably greater than or equal to 0.05 and less than or equal to 1.5, further preferably greater than or equal to 0.3 and less than or equal to 1.00.

According to results of the EDX line analysis, where a surface of the positive electrode active material 100 is can be estimated as follows. A point where the detected amount of an element which uniformly exists in the inner portion 100b of the positive electrode active material 100, e.g., oxygen or the transition metal M such as cobalt, is ½ of the detected amount thereof in the inner portion 100b is assumed as the surface.

Since the positive electrode active material 100 is a composite oxide, the detected amount of oxygen is preferably used to estimate where the surface is. Specifically, an average value Oₐᵥₑ of the oxygen concentration of a region of the inner portion 100b where the detected amount of oxygen is stable is calculated first. At this time, in the case where oxygen O_{background} which is probably led from chemical adsorption or the background is detected outside the surface, O_{background} is subtracted from the measurement value to obtain the average value Oₐᵥₑ of the oxygen concentration. The measurement point where the measurement value which is closest to ½ of the average value Oₐᵥₑ, or ½Oₐᵥₑ, is obtained can be estimated to be the surface of the positive electrode active material.

Where the surface is can also be estimated with the use of the transition metal M contained in the positive electrode active material 100. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

When the positive electrode active material 100 is subjected to line analysis or surface analysis, the ratio of the added element I to the transition metal M (I/M) in the vicinity of the crystal grain boundary is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 020 and less than or equal to 0.30, greater than or equal to 020 and less than or equal to 0.20, greater than or equal to 025 and less than or equal to 0.50, greater than or equal to 025 and less than or equal to 0.20, greater than or equal to 0.030 and less than or equal to 0.50, or greater than or equal to 0.030 and less than or equal to 0.30.

For example, when the added element is magnesium and the transition metal M is cobalt, the atomic ratio of magnesium to cobalt (Mg/Co) is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the atomic ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

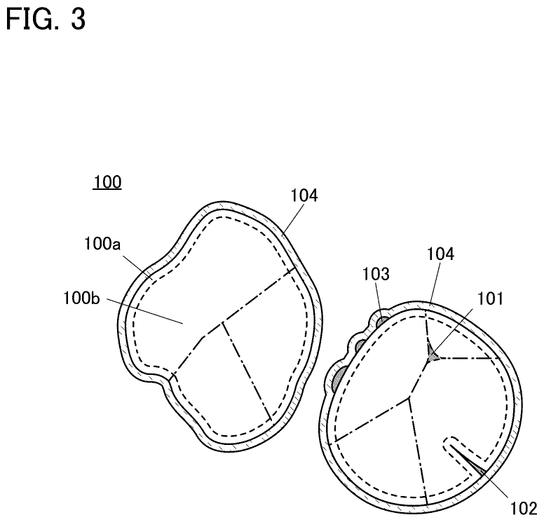

The positive electrode active material 100 may include a coating film in at least part of its surface. FIG. 3 shows an example of the positive electrode active material 100 including a coating film 104.

The coating film 104 is preferably formed by deposition of a decomposition product of an electrolyte solution due to charging and discharging, for example. A coating film originating from an electrolyte solution, which is formed on the surface of the positive electrode active material 100, is expected to improve charge and discharge cycle performance particularly when charging with high voltage is repeated. This is because an increase in impedance of the surface of the positive electrode active material is inhibited or dissolution of the transition metal M is inhibited, for example. The coating film 104 preferably contains carbon, oxygen, and fluorine, for example. The coating film can have high quality easily when the electrolyte solution partly includes LiBOB and/or suberonitrile (SUN), for example. Accordingly, the coating film 104 preferably contains boron and/or nitrogen to have high quality. The coating film 104 does not necessarily cover the positive electrode active material 100 entirely.

### <Crystal Structure>

A material with a layered rock-salt crystal structure, such as lithium cobalt oxide (LiCoO₂), is known to have a high discharge capacity and excel as a positive electrode active material of a secondary battery. Examples of a material with a layered rock-salt crystal structure include a composite oxide represented by LiMO₂.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage are performed on LiNiO₂, the crystal structure might be broken because of the distortion. The influence of the Jahn-Teller effect is suggested to be small in LiCoO₂; hence, LiCoO₂ is preferable because the tolerance at the time of high voltage charging is higher in some cases.

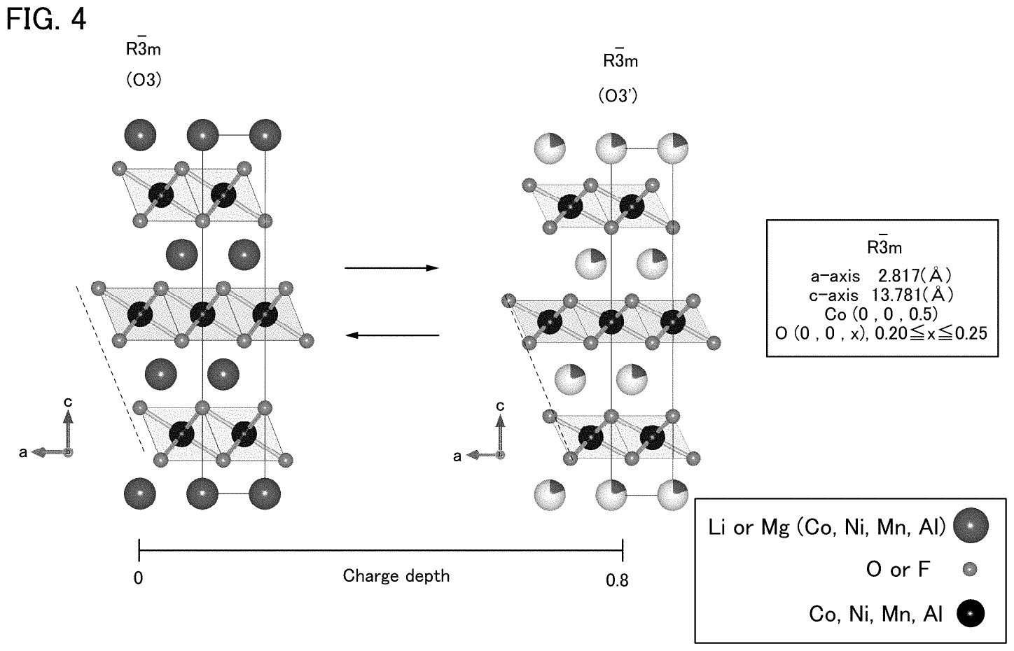

Positive electrode active materials are described with reference to FIG. 4 to FIG. 7. In FIG. 4 to FIG. 7, the case where cobalt is used as the transition metal M contained in the positive electrode active material is described.

### <Conventional Positive Electrode Active Material>

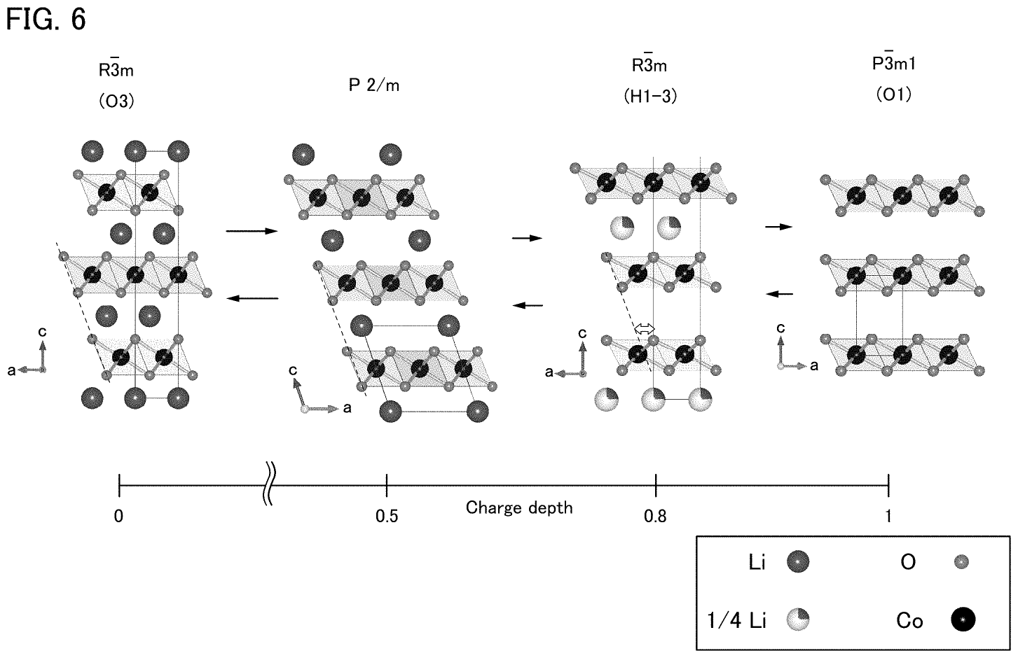

A positive electrode active material shown in FIG. 6 is lithium cobalt oxide (LiCoO₂) to which fluorine and magnesium are not added in a formation method described later. As described in Non-Patent Documents 1 and 2 and the like, the crystal structure of the lithium cobalt oxide shown in FIG. 6 changes with the charge depth.

As shown in FIG. 6, in lithium cobalt oxide with a charge depth of 0 (discharged state), there is a region having a crystal structure belonging to the space group R-3m, lithium occupies octahedral sites, and a unit cell includes three CoO₂ layers. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3 ml and includes one CoO₂ layer in a unit cell. Hence, this crystal structure is referred to as an 01 type crystal structure in some cases.

Lithium cobalt oxide with a charge depth of approximately 0.8 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 6, and other drawings, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material is selected such that the value of goodness of fit (GOF) is smaller in Rietveld analysis of XRD, for example.

When charging at a high charge voltage of 4.6 V or more with reference to the redox potential of a lithium metal or charging with a large charge depth of 0.8 or more and discharging are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the arrow in FIG. 6, the CoO₂ layer in the H1-3 type crystal structure largely shifts from R-3m (O3). Such a dynamic structural change can adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as P-3 ml (O1), included in the H1-3 type crystal structure is highly likely to be unstable.

Accordingly, the repeated charging and discharging with high voltage gradually break the crystal structure of lithium cobalt oxide. The broken crystal structure triggers deterioration of the cycle performance. This is because the broken crystal structure has a smaller number of sites where lithium can exist stably and makes it difficult to insert and extract lithium.

### <Positive Electrode Active Material of One Embodiment of the Present Invention>

### <<Crystal Structure>>

In the positive electrode active material 100 of one embodiment of the present invention, the shift in CoO₂ layers can be small in repeated charging and discharging with high voltage. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high voltage charged state. Thus, in the positive electrode active material of one embodiment of the present invention, a short circuit is unlikely to occur while the high voltage charged state is maintained, in some cases. This is preferable because the safety is further improved.

The positive electrode active material of one embodiment of the present invention has a small crystal-structure change and a small volume difference per the same number of atoms of the transition metal M between a sufficiently discharged state and a high voltage charged state.

FIG. 4 shows a crystal structure of the positive electrode active material 100 before and after charging and discharging. The positive electrode active material 100 is a composite oxide containing lithium, cobalt as the transition metal M, and oxygen. In addition to the above-described elements, magnesium is preferably contained as the added element. Furthermore, fluorine is preferably contained as the added element.

The crystal structure with a charge depth of 0 (discharged state) in FIG. 4 is R-3m (O3), which is the same as in FIG. 6. Meanwhile, the positive electrode active material 100 with a charge depth in a sufficiently charged state includes a crystal whose structure is different from the H1-3 type crystal structure. This structure belongs to the space group R-3m and is not the spinel crystal structure but has symmetry in cation arrangement similar to that of the spinel structure because an ion of cobalt, magnesium, or the like occupies a site coordinated to six oxygen atoms. Furthermore, the symmetry of CoO₂ layers of this structure is the same as that in the O3 type structure. This structure is thus referred to as the O3′ type crystal structure or the pseudo-spinel crystal structure in this specification and the like. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms; also in this case, the ion arrangement has symmetry similar to that of the spinel structure.

Although a chance of the existence of lithium is the same in all lithium sites in FIG. 4, the positive electrode active material 100 of one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

The O3′ type crystal structure can be regarded as a crystal structure that contains Li between layers randomly and is similar to a CdCl₂ type crystal structure. The crystal structure similar to the CdCl₂ type crystal structure is close to a crystal structure of lithium nickel oxide (Li_{0.06}NiO₂) charged to a charge depth of 0.94; however, pure lithium cobalt oxide or a layered rock-salt positive electrode active material containing a large amount of cobalt is known not to have such a crystal structure generally.

In the positive electrode active material 100 of one embodiment of the present invention, a change in the crystal structure caused when a large amount of lithium is extracted by charging with high voltage is smaller than that in a conventional positive electrode active material. As denoted by the dotted lines in FIG. 4, for example, the CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. In addition, the positive electrode active material 100 of one embodiment of the present invention might have the O3′ type crystal structure even at a lower charge voltage (e.g., a charge voltage of greater than or equal to 4.5 V and less than 4.6 V with reference to the potential of a lithium metal).

Thus, in the positive electrode active material 100 of one embodiment of the present invention, the crystal structure is unlikely to be broken even when charging and discharging with high voltage are repeated.

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material 100 of one embodiment of the present invention can maintain the crystal structure belonging to R-3m (O3) and moreover, can have the O3′ type crystal structure at higher charge voltages, e.g., a voltage of the secondary battery of greater than 4.5 V and less than or equal to 4.6 V. In addition, the positive electrode active material 100 of one embodiment of the present invention can have the O3′ type crystal structure at lower charge voltages, e.g., at a voltage of the secondary battery of greater than or equal to 4.2 V and less than 4.3 V, in some cases.

Note that in the unit cell of the O3′ type crystal structure, the coordinates of cobalt and oxygen can be represented by Co (0, 0, 0.5) and O (0, 0, x) within the range of 0.20≤x≤0.25.

A slight amount of the added element such as magnesium randomly existing between the CoO₂ layers, i.e., in lithium sites, can suppress a shift in the CoO₂ layers at the time of charging with high voltage. Thus, magnesium between the CoO₂ layers makes it easier to obtain the O3′ type crystal structure. Therefore, magnesium is preferably distributed throughout a particle of the positive electrode active material 100 of one embodiment of the present invention. To distribute magnesium throughout the particle, heat treatment is preferably performed in the formation process of the positive electrode active material 100 of one embodiment of the present invention.

However, heat treatment at an excessively high temperature may cause cation mixing, which increases the possibility of entry of the added element such as magnesium into the cobalt sites. Magnesium in the cobalt sites does not have the effect of maintaining the structure belonging to R-3m at the time of charging with high voltage. Furthermore, heat treatment at an excessively high temperature might have an adverse effect; for example, cobalt might be reduced to have a valence of two or lithium might be evaporated.

In view of the above, a fluorine compound is preferably added to lithium cobalt oxide before the heat treatment for distributing magnesium throughout the particle. The addition of the fluorine compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 and less than 0.04, still further preferably approximately 0.02 the number of atoms of the transition metal M. Alternatively, the number of magnesium atoms in the positive electrode active material of one embodiment of the present invention is preferably greater than or equal to 0.001 times and less than 0.04 or greater than or equal to 0.01 and less than or equal to 0.1 the number of atoms of the transition metal M. The magnesium concentration described here may be a value obtained by element analysis on the whole particles of the positive electrode active material using ICP-MS or the like, or may be a value based on the ratio of the raw materials mixed in the process of forming the positive electrode active material, for example.

As a metal other than cobalt (hereinafter, a metal Z), one or more metals selected from nickel, aluminum, manganese, titanium, vanadium, and chromium may be added to lithium cobalt oxide, for example, and in particular, at least one of nickel and aluminum is preferably added. In some cases, manganese, titanium, vanadium, and chromium are likely to have a valence of four stably and thus contribute highly to a stable structure. The addition of the metal Z may enable the positive electrode active material of one embodiment of the present invention to have a more stable crystal structure in high-voltage charged state, for example. Here, in the positive electrode active material of one embodiment of the present invention, the metal Z is preferably added at a concentration that does not greatly change the crystallinity of the lithium cobalt oxide. For example, the metal Z is preferably added at an amount with which the aforementioned Jahn-Teller effect is not exhibited.

As shown in introductory remarks in FIG. 4, aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the charge and discharge capacity of the positive electrode active material decreases in some cases. As an example, one reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as a metal Z in addition to magnesium, the charge and discharge capacity per weight and per volume can be increased in some cases. When the positive electrode active material of one embodiment of the present invention contains aluminum as the metal Z in addition to magnesium, the charge and discharge capacity per weight and per volume can be increased in some cases. When the positive electrode active material of one embodiment of the present invention contains nickel and aluminum in addition to magnesium, the charge and discharge capacity per weight and per volume can be increased in some cases.

The concentrations of the elements contained in the positive electrode active material of one embodiment of the present invention, such as magnesium and the metal Z, are described below using the number of atoms.

The number of nickel atoms in the positive electrode active material 100 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms in the positive electrode active material 100 of one embodiment of the present invention is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The nickel concentration described here may be a value obtained by element analysis on the whole particles of the positive electrode active material using GD-MS, ICP-MS, or the like, or may be a value based on the ratio of the raw materials mixed in the process of forming the positive electrode active material, for example.

Nickel contained at any of the above concentrations easily forms a solid solution uniformly throughout the positive electrode active material 100 and thus particularly contributes to stabilization of the crystal structure of the inner portion 100b. When divalent nickel exists in the inner portion 100b, a slight amount of the added element having a valence of two and randomly existing in lithium sites, such as magnesium, might be able to exist more stably in the vicinity of the divalent nickel. Thus, even when charging and discharging with high voltage are performed, dissolution of magnesium might be inhibited. Accordingly, charge and discharge cycle performance might be improved. Such a combination of the effect of nickel in the inner portion 100b and the effect of magnesium, aluminum, titanium, fluorine, or the like in the surface portion 100a extremely effectively stabilizes the crystal structure at the time of charging with high voltage.

The number of aluminum atoms in the positive electrode active material of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms in the positive electrode active material of one embodiment of the present invention is preferably greater than or equal to 0.05% and less than or equal to 2%, or greater than or equal to 0.1% and less than or equal to 4% of the number of cobalt atoms. The aluminum concentration described here may be a value obtained by element analysis on the whole particles of the positive electrode active material using GD-MS, ICP-MS, or the like, or may be a value based on the ratio of the raw materials mixed in the process of forming the positive electrode active material, for example.

It is preferable that the positive electrode active material of one embodiment of the present invention contain an element Wand phosphorus be used as the element W. The positive electrode active material of one embodiment of the present invention further preferably includes a compound containing phosphorus and oxygen.

When the positive electrode active material of one embodiment of the present invention includes a compound containing the element W, a short circuit can be inhibited while a high voltage charged state is maintained, in some cases.

When the positive electrode active material of one embodiment of the present invention contains phosphorus as the element X, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in hydrogen fluoride concentration in the charge solution may inhibit corrosion of a current collector or separation of a coating film or may inhibit a reduction in adhesion properties due to gelling or insolubilization of PVDF.

When containing magnesium in addition to the element X, the positive electrode active material of one embodiment of the present invention is extremely stable in a high voltage charged state. When the element X is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to and 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the whole particles of the positive electrode active material using ICP-MS or the like, or may be a value based on the ratio of the raw materials mixed in the process of forming the positive electrode active material, for example.

The positive electrode active material sometimes has a crack. When an inner portion of the positive electrode active material with a crack surface includes phosphorus, more specifically, a compound containing phosphorus and oxygen or the like, crack development is inhibited in some cases.

### <<Surface Portion>>

It is preferable that magnesium be distributed throughout a particle of the positive electrode active material 100 of one embodiment of the present invention, and it is further preferable that the magnesium concentration in the surface portion 100a be higher than the average magnesium concentration in the whole particle. Alternatively, it is preferable that the magnesium concentration in the surface portion 100a be higher than the magnesium concentration in the inner portion 100b. For example, the magnesium concentration in the surface portion 100a measured by XPS or the like is preferably higher than the average magnesium concentration in the whole particles measured by ICP-MS or the like. Alternatively, the magnesium concentration in the surface portion 100a measured by EDX surface analysis or the like is preferably higher than the magnesium concentration in the inner portion 100b.

In the case where the positive electrode active material 100 of one embodiment of the present invention contains an element other than cobalt, for example, one or more metals selected from nickel, aluminum, manganese, iron, and chromium, the concentration of the metal in the surface portion 100a is preferably higher than the average concentration of the added element in the whole particle. Alternatively, the concentration of the metal in the surface portion 100a is preferably higher than that in the inner portion 100b. For example, the concentration of the element other than cobalt in the surface portion 100a measured by XPS or the like is preferably higher than the average concentration of the element in the whole particles measured by ICP-MS or the like. Alternatively, the concentration of the element other than cobalt in the surface portion 100a measured by EDX surface analysis or the like is preferably higher than the concentration of the added element other than cobalt in the inner portion 100b.

The surface portion is in a state where bonds are cut unlike the crystal's inner portion, and lithium is extracted from the surface during charging; thus, the lithium concentration in the surface portion tends to be lower than that in the inner portion. Therefore, the surface portion tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of fluorine in the surface portion 100a of the positive electrode active material 100 of one embodiment of the present invention is preferably higher than the average concentration in the whole particle. Alternatively, the fluorine concentration in the surface portion 100a is preferably higher than that in the inner portion 100b. When fluorine exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the added elements such as magnesium and fluorine are preferably higher than those in the inner portion. The surface portion 100a having such a composition preferably has a crystal structure stable at room temperature (25° C.). Accordingly, the surface portion 100a may have a crystal structure different from that of the inner portion 100b. For example, at least part of the surface portion 100a of the positive electrode active material 100 of one embodiment of the present invention may have a rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ crystal are presumed to form a cubic close-packed structure. When these crystals are in contact with each other, there exists a crystal plane at which orientations of cubic close-packed structures formed of anions are aligned with each other. Note that the space group of the layered rock-salt crystal and the O3′ crystal is R-3m, which is different from the space group Fm-3m (the space group of a general rock-salt crystal) and the space group Fd-3m (the space group having the simplest symmetry in rock-salt crystals) of rock-salt crystals; thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other.

The orientations of crystals in two regions being substantially aligned with each other can be judged, for example, from a TEM (transmission electron microscope) image, a STEM (scanning transmission electron microscope) image, a HAADF-STEM (high-angle annular dark-field scanning TEM) image, an ABF-STEM (annular bright-field scanning transmission electron microscope) image, or the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, a light element typified by oxygen or fluorine cannot be clearly observed in some cases; in such a case, alignment of orientations can be judged by arrangement of metal elements.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The added element X is preferably positioned in the surface portion 100a of the particle of the positive electrode active material 100 of one embodiment of the present invention. For example, the positive electrode active material 100 of one embodiment of the present invention may be covered with the coating film containing the added element X.

### <<Grain Boundary>>

It is further preferable that the added element contained in the positive electrode active material 100 of one embodiment of the present invention have the above-described distribution and be partly segregated in the crystal grain boundary 101 as shown in FIG. TA.

Specifically, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the magnesium concentration at the crystal grain boundary 101 and the vicinity thereof is, the more effectively the change in the crystal structure can be reduced.

When the magnesium concentration and the fluorine concentration are high at the crystal grain boundary and the vicinity thereof, the magnesium concentration and the fluorine concentration in the vicinity of a surface generated by a crack are also high even when the crack is generated along the crystal grain boundary 101 of the particle of the positive electrode active material 100 of one embodiment of the present invention. Thus, the positive electrode active material including a crack can also have an increased corrosion resistance to hydrofluoric acid.

Note that in this specification and the like, the vicinity of the crystal grain boundary 101 refers to a region of approximately 10 nm from the grain boundary. The crystal grain boundary refers to a plane where atomic arrangement is changed and which can be observed in an electron micrograph. Specifically, the crystal grain boundary refers to a portion where the angle formed by repetition of bright lines and dark lines in an electron microscope image exceeds 5° in an electron micrograph.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

### <Analysis Method>

Whether or not a given positive electrode active material is the positive electrode active material 100 of one embodiment of the present invention, which has the O3′ type crystal structure at the time of high voltage charging, can be judged by analyzing a positive electrode charged with high voltage by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

As described above, the positive electrode active material 100 of one embodiment of the present invention features in a small change in the crystal structure between a high voltage charged state and a discharged state. A material in which 50 wt % or more of the crystal structure largely changes between a high voltage charged state and a discharged state is not preferable because the material cannot withstand charging and discharging with high voltage. It should be noted that the intended crystal structure is not obtained in some cases only by addition of the added element. For example, in a high voltage charged state, lithium cobalt oxide containing magnesium and fluorine has the O3′ type crystal structure at 60 wt % or more in some cases, and has the H1-3 type crystal structure at 50 wt % or more in other cases. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD and other methods.

However, the crystal structure of a positive electrode active material in a high voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

High-voltage charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive additive, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is subjected to constant current charging at a freely selected voltage (e.g., 4.6 V, 4.65 V, or 4.7 V) and 0.5 C and then constant voltage charging until the current value reaches 0.01 C. Note that 1 C can be 137 mA/g or 200 mA/g. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere.

### <<XRD>>

The apparatus and conditions adopted in the XRD measurement are not particularly limited. The measurement can be performed with the apparatus and conditions as described below, for example.

XRD apparatus: D8 ADVANCE produced by Bruker AXS
X-ray source: CuKα radiation

### Output: 40 KV, 40 mA

Slit system: Div. Slit, 0.5°

### Detector: LynxEye

Scanning method: 2θ/θ continuous scanning
Measurement range (2θ): from 15° (degrees) to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

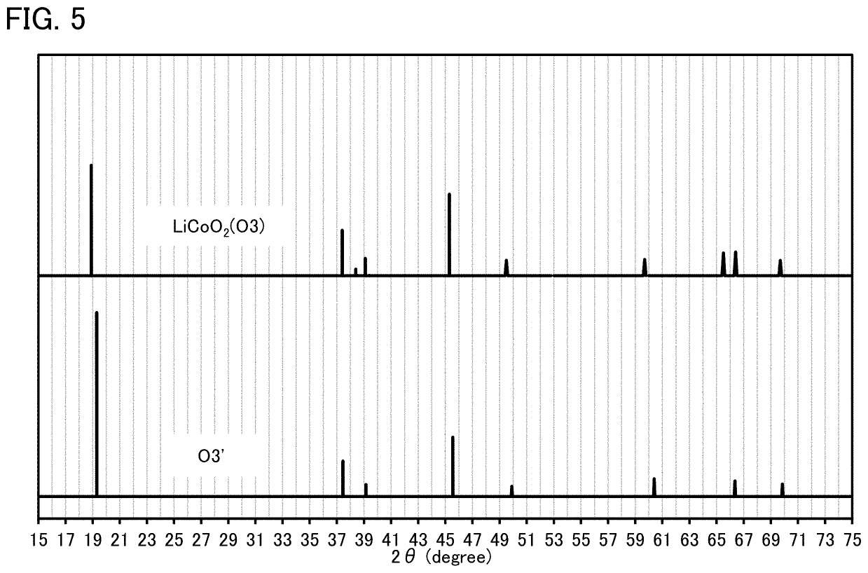

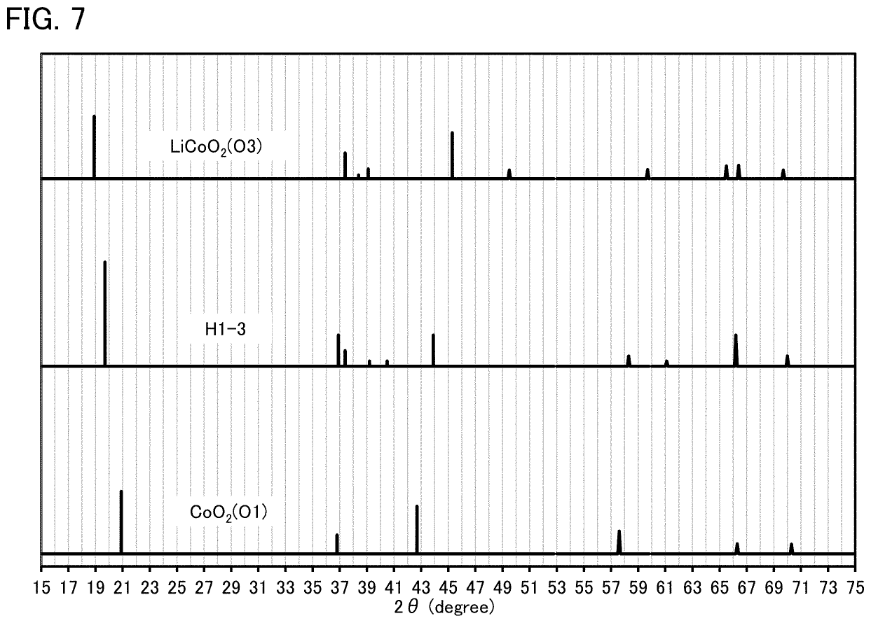

FIG. 5 and FIG. 7 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) were made from crystal structure data obtained from the Inorganic Crystal Structure Database (ICSD) (see Non-Patent Document 4) with Reflex Powder Diffraction, which is a module of Materials Studio (BIOVIA). The range of 2θ was from 15° to 75°, the step size was 0.01, the wavelength λ1 was 1.540562×10¹⁰ m, the wavelength λ2 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS Version 3 (crystal structure analysis software produced by Bruker Corporation), and the XRD pattern of the O3′ type crystal structure was made in a similar manner to other structures.

As shown in FIG. 5, the O3′ type crystal structure exhibits diffraction peaks at 2θ of 19.30±0.20° (greater than or equal to 19.10° and less than or equal to 19.50°) and 2θ of 45.55±0.100 (greater than or equal to 45.450 and less than or equal to 45.65°). More specifically, the O3′ type crystal structure exhibits sharp diffraction peaks at 2θ of 19.30±0.100 (greater than or equal to 19.200 and less than or equal to 19.40°) and 2θ of 45.55±0.05° (greater than or equal to 45.500 and less than or equal to 45.60°). By contrast, as shown in FIG. 7, the H1-3 type crystal structure and CoO₂ (P-3m1, O1) do not exhibit peaks at these positions. Thus, the peaks at 2θ of 19.30±0.20° and 2θ of 45.55±0.100 in a high voltage charged state can be the features of the positive electrode active material 100 of one embodiment of the present invention.

It can be said that the positions of the XRD diffraction peaks exhibited by the crystal structure with a charge depth of 0 are close to those of the XRD diffraction peaks exhibited by the crystal structure at the time of high voltage charging. More specifically, it can be said that a difference in the positions of two or more, preferably three or more of the main diffraction peaks between the crystal structures is 20=0.7 or less, preferably 20=0.5 or less.

Although the positive electrode active material 100 of one embodiment of the present invention has the O3′ type crystal structure at the time of high voltage charging, not all the particles necessarily have the O3′ type crystal structure. Some of the particles may have another crystal structure or be amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charging and discharging after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, the peak of the O3′ type crystal structure can be clearly observed after high voltage charging even under the same XRD measurement conditions as those of a positive electrode before charging and discharging. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

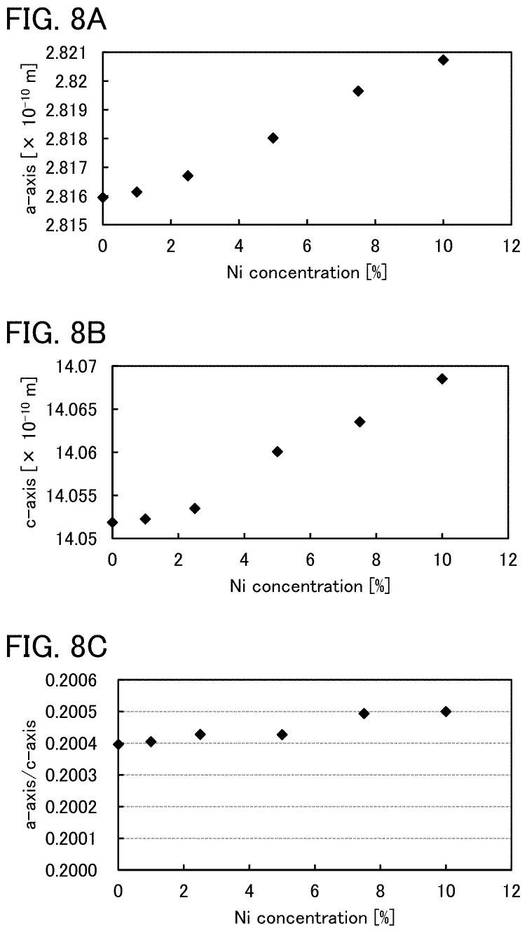

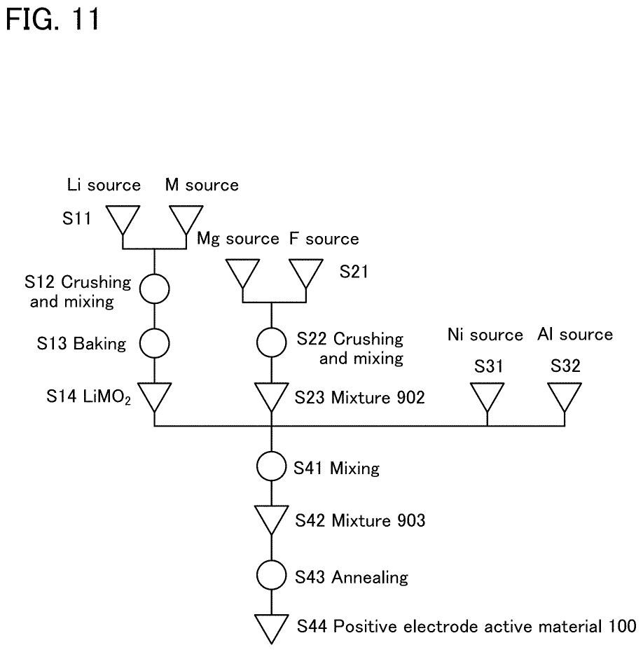

FIG. 8 shows the calculation results of the lattice constants of the a-axis and the c-axis by XRD in the case where the positive electrode active material of one embodiment of the present invention has a layered rock-salt crystal structure and contains cobalt and nickel. FIG. 8A shows the results of the a-axis, and FIG. 8B shows the results of the c-axis. Note that the XRD patterns of a powder after the synthesis of the positive electrode active material before incorporation into a positive electrode were used for the calculation. The nickel concentration on the horizontal axis represents a nickel concentration with the sum of cobalt atoms and nickel atoms assumed as 100%. The positive electrode active material was formed in accordance with the formation method in FIG. 11 described later except that the aluminum source was not used. The nickel concentration represents a nickel concentration with the sum of cobalt atoms and nickel atoms in a positive electrode active material assumed as 100%.

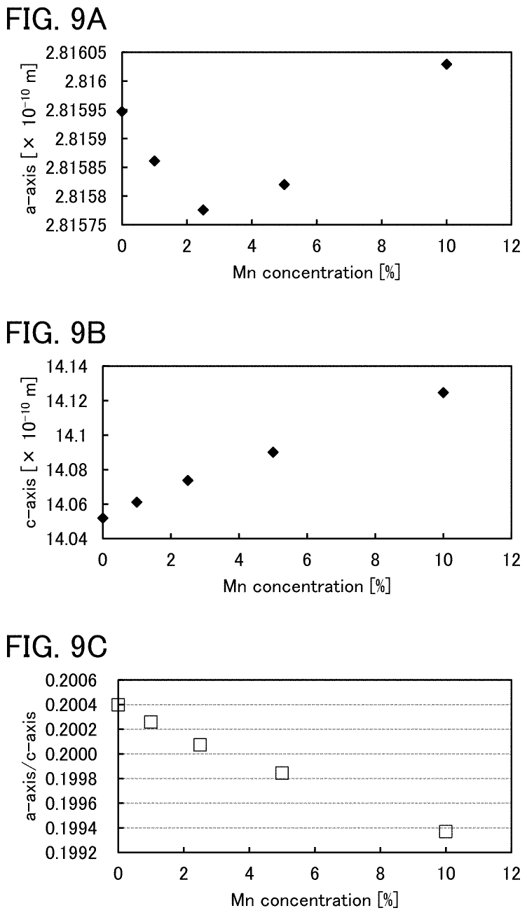

FIG. 9 shows the estimation results of the lattice constants of the a-axis and the c-axis by XRD in the case where the positive electrode active material of one embodiment of the present invention has a layered rock-salt crystal structure and contains cobalt and manganese. FIG. 9A shows the results of the a-axis, and FIG. 9B shows the results of the c-axis. Note that the lattice constants shown in FIG. 9 were obtained by XRD measurement of a powder after the synthesis of the positive electrode active material before incorporation into a positive electrode. The manganese concentration on the horizontal axis represents a manganese concentration with the sum of cobalt atoms and manganese atoms assumed as 100%. The positive electrode active material was formed in accordance with the formation method of FIG. 11 described later except that a manganese source was used instead of the nickel source and the aluminum source was not used. The manganese concentration represents a manganese concentration with the sum of cobalt atoms and manganese atoms assumed as 100% in Step S21.

FIG. 8C shows values obtained by dividing the lattice constants of the a-axis by the lattice constants of the c-axis (a-axis/c-axis) in the positive electrode active material, whose results of the lattice constants are shown in FIG. 8A and FIG. 8B. FIG. 9C shows values obtained by dividing the lattice constants of the a-axis by the lattice constants of the c-axis (a-axis/c-axis) in the positive electrode active material, whose results of the lattice constants are shown in FIG. 9A and FIG. 9B.

As shown in FIG. 8C, the value of a-axis/c-axis tends to significantly change between nickel concentrations of 5% and 7.5%, and the distortion of the a-axis becomes large. This distortion may be the Jahn-Teller distortion. It is suggested that an excellent positive electrode active material with small Jahn-Teller distortion can be obtained at a nickel concentration of lower than 7.5%.

FIG. 9A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 100a are not limited to the above ranges. In other words, the nickel concentration and the manganese concentration in the surface portion 100a may be higher than the above concentrations in some cases.

Preferable ranges of the lattice constants of the positive electrode active material of one embodiment of the present invention are examined above. In the layered rock-salt crystal structure of the particle of the positive electrode active material in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be the state of a powder before the formation of a positive electrode of a secondary battery.

Alternatively, in the layered rock-salt crystal structure of particle of the positive electrode active material in the discharged state or the state where charging and discharging are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charging and discharging are not performed is subjected to XRD analysis, a first peak is observed at 20 of greater than or equal to 18.50° and less than or equal to 19.30°, and a second peak is observed at 20 of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a, the outermost surface layer 100c, or the like can be analyzed by electron diffraction of a cross section of the positive electrode active material 100, for example.

### <<XPS>>

A region that is approximately 2 nm to 8 nm (normally, less than or equal to 5 nm) in depth from a surface can be analyzed by X-ray photoelectron spectroscopy (XPS); thus, the concentrations of elements in approximately half the surface portion 100a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When the positive electrode active material 100 of one embodiment of the present invention is subjected to XPS analysis, the number of atoms of the added element is preferably greater than or equal to 1.6 times and less than or equal to 6.0 times, further preferably greater than or equal to 1.8 times and less than 4.0 times the number of atoms of the transition metal M. When the added element is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum can be used as an X-ray source, for example. An extraction angle is, for example, 45°. For example, the measurement can be performed using the following apparatus and conditions.

Measurement device: Quantera II produced by PHI, Inc.
X-ray source: monochromatic Al (1486.6 eV)
Detection area: 100 μm ϕ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the added elements that preferably exist in the surface portion 100a in a large amount, such as magnesium and aluminum, measured by XPS or the like are preferably higher than the concentrations measured by inductively coupled plasma mass spectrometry (ICP-MS), glow discharge mass spectrometry (GD-MS), or the like.

When a cross section of the positive electrode active material 100 is exposed by processing and analyzed by TEM-EDX, the concentrations of magnesium and aluminum in the surface portion 100a are preferably higher than those in the inner portion 100b. An FIB (Focused Ion Beam) can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals M, not be unevenly distributed in the surface portion 100a but be distributed in the entire positive electrode active material 100. Note that one embodiment of the present invention is not limited thereto in the case where the above-described region where the added element is unevenly distributed exists.

### <<ESR>>

As described above, the positive electrode active material of one embodiment of the present invention preferably contains cobalt and nickel as the transition metal and magnesium as the added element. It is preferable that Ni²⁺ be substituted for part of Co³⁺ and Mg²⁺ be substituted for part of Li⁺ accordingly. Accompanying the substitution of Mg²⁺ for Li⁺, the Ni²⁺ might be reduced to be Ni³⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably higher than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by electron spin resonance (ESR), for example.

### <<EPMA>>

Elements can be quantified by electron probe microanalysis (EPMA). In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the added element existing in the surface portion might be lower than the concentration obtained in XPS. The concentration of the added element existing in the surface portion might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the added element increases from the inner portion toward the surface portion. Specifically, each of magnesium, fluorine, titanium, and silicon preferably has a concentration gradient in which the concentration increases from the inner portion toward the surface as shown in FIG. 1C1. The concentration of aluminum preferably has a peak in a region deeper than the region where the concentration of any of the above elements has a peak, as shown in FIG. 2C2. The aluminum concentration peak may be located in the surface portion or located deeper than the surface portion.

Note that the surface and the surface portion of the positive electrode active material of one embodiment of the present invention do not contain a carbonic acid, a hydroxy group, or the like which is chemisorbed after formation of the positive electrode active material. Furthermore, an electrolyte solution, a binder, a conductive material, and a compound originating from any of these that are attached to the surface of the positive electrode active material are not contained either. Thus, in quantification of the elements contained in the positive electrode active material, correction may be performed to exclude carbon, hydrogen, excess oxygen, excess fluorine, and the like that might be detected in surface analysis such as XPS and EPMA.

### <<Surface Roughness and Specific Surface Area>>

The positive electrode active material 100 of one embodiment of the present invention preferably has a smooth surface with little unevenness. A smooth surface with little unevenness indicates favorable distribution of the added element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction was performed using regression curves (quadratic regression), parameters for calculating roughness were obtained from data subjected to slope correction, and root-mean-square surface roughness (RMS) was obtained by calculating standard deviation. This surface roughness refers to the surface roughness of part of the particle periphery (at least 400 nm) of the positive electrode active material.

On the surface of the particle of the positive electrode active material 100 of this embodiment, roughness (RMS: root-mean-square surface roughness), which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably less than or equal to 2.1.

This embodiment can be implemented in combination with any of the other embodiments.

### Embodiment 2

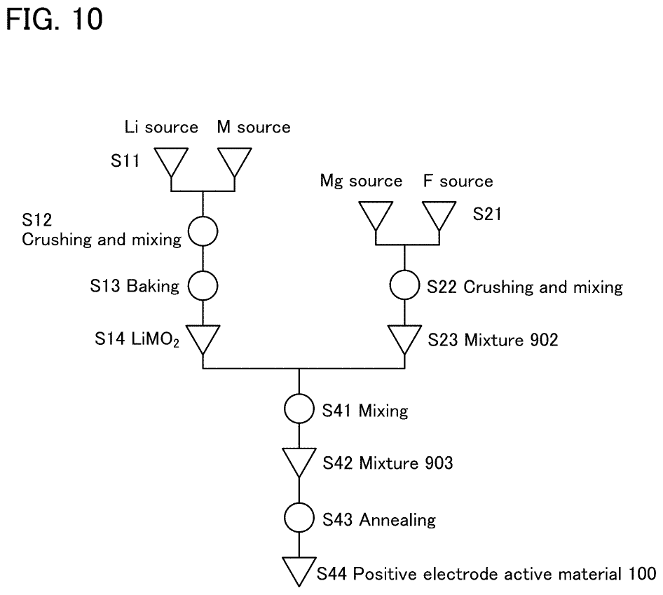

In this embodiment, an example of a method of forming a positive electrode active material of one embodiment of the present invention will be described with reference to FIG. 10 to FIG. 14.

### <Step S11>

First, in Step S11 in FIG. 10, a lithium source and a transition metal M source are prepared as materials of a composite oxide (LiMO₂) containing lithium, a transition metal M, and oxygen.

As the lithium source, for example, lithium carbonate, lithium fluoride, lithium hydroxide, lithium oxide, or the like can be used.

As the transition metal M, a metal which together with lithium can form a composite oxide having the layered rock-salt structure belonging to the space group R-3m is preferably used. For example, at least one of manganese, cobalt, and nickel can be used. That is, as the transition metal M source, only cobalt may be used; only nickel may be used; two types of metals of cobalt and manganese or cobalt and nickel may be used; or three types of metals of cobalt, manganese, and nickel may be used.

When metals that can form a composite oxide having the layered rock-salt structure are used, cobalt, manganese, and nickel are preferably mixed at the ratio at which the composite oxide can have the layered rock-salt crystal structure. In addition, aluminum may be added to the transition metal as long as the composite oxide can have the layered rock-salt crystal structure.

As the transition metal M source, oxide or hydroxide of the metal described as an example of the transition metal M, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S12>

Next, in Step S12, the lithium source and the transition metal M source are mixed. The mixing can be performed by a dry process or a wet process. For example, a ball mill, a bead mill, or the like can be used for the mixing. When the ball mill is used, a zirconia ball is preferably used as grinding media, for example.

### <Step S13>

Next, in Step S13, the materials mixed in the above manner are heated. This step is sometimes referred to as baking or first heating to distinguish this step from a heating step performed later. The heating is preferably performed at a temperature higher than or equal to 800° C. and lower than 1100° C., further preferably at a temperature higher than or equal to 900° C. and lower than or equal to 1000° C., and still further preferably at approximately 950° C. Alternatively, the heating is preferably performed at a temperature higher than or equal to 800° C. and lower than or equal to 1000° C. Alternatively, the heating is preferably performed at a temperature higher than or equal to 900° C. and lower than or equal to 1100° C. An excessively low temperature might lead to insufficient decomposition and melting of the lithium source and the transition metal M source. An excessively high temperature, on the other hand, might cause a defect due to excessive reduction of the metal taking part in an oxidation-reduction reaction and used as the transition metal M, evaporation of lithium, or the like. The use of cobalt as the transition metal M, for example, may lead to a defect in which cobalt has divalence.

The heating time can be longer than or equal to an hour and shorter than or equal to 100 hours, for example, and is preferably longer than or equal to 2 hours and shorter than or equal to 20 hours. Alternatively, the heating time is preferably longer than or equal to an hour and shorter than or equal to 20 hours. Alternatively, the heating time is preferably longer than or equal to two hours and shorter than or equal to 100 hours. A shorter heating time is preferable in terms of productivity. Baking is preferably performed in an atmosphere with few moisture, such as dry air (e.g., the dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled to room temperature (25° C.). The temperature decreasing time from the specified temperature to room temperature is preferably longer than or equal to 10 hours and shorter than or equal to 50 hours, for example.

Note that the cooling to room temperature in Step S13 is not essential. As long as later steps of Step S41 to Step S44 are performed without problems, the cooling may be performed to a temperature higher than room temperature.

### <Step S14>

Next, in Step S14, the materials baked in the above manner are collected, whereby the composite oxide (LiMO₂) containing lithium, the transition metal M, and oxygen is obtained. Specifically, lithium cobalt oxide, lithium manganese oxide, lithium nickel oxide, lithium cobalt oxide in which manganese is substituted for part of cobalt, lithium cobalt oxide in which nickel is substituted for part of cobalt, lithium nickel-manganese-cobalt oxide, or the like is obtained.

Alternatively, a composite oxide containing lithium, the transition metal M, and oxygen that is synthesized in advance may be used in Step S14. In that case, Step S11 to Step S13 can be omitted.

For example, as a composite oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the median diameter (D50) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Alternatively, a lithium cobalt oxide particle (product name: CELLSEED C-5H) manufactured by NIPPON CHEMICAL INDUSTRIAL CO., LTD. can be used. This is lithium cobalt oxide in which the median diameter (D50) is approximately 6.5 μm, and the concentrations of elements other than lithium, cobalt, and oxygen are approximately equal to or less than those of C-TON in the impurity analysis by GD-MS.

In this embodiment, cobalt is used as the metal M, and lithium cobalt oxide particle synthesized in advance (CELLSEED C-TON manufactured by NIPPON CHEMICAL INDUSTRIAL CO., LTD.) is used.

### <Step S21>

Next, in Step S21, a halogen source such as a fluorine source or a chlorine source and a magnesium source are prepared as materials of a mixture 902. In addition, a lithium source is preferably prepared as well.

As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. The fluorine source is not limited to a solid, and for example, fluorine (F₂), carbon fluoride, sulfur fluoride, oxygen fluoride (e.g., OF₂, O₂F₂, O₃F₂, O₄F₂, and O₂F), or the like may be used and mixed in the atmosphere in a heating step described later. A plurality of fluorine sources may be mixed to be used. Among them, lithium fluoride, which has a relatively low melting point of 848° C. among solid-state fluorine sources, is preferable because it is easily melted in an annealing process described later.

As the magnesium source, for example, magnesium fluoride, magnesium oxide, magnesium hydroxide, magnesium carbonate, or the like can be used.

As the lithium source, for example, lithium fluoride, lithium carbonate, or the like can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a molar ratio of approximately LiF:MgF₂=65:35, the effect of lowering the melting point becomes the highest. On the other hand, when the amount of lithium fluoride increases, cycle performance might deteriorate because of a too large amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and smaller than 1.1 times a certain value.

In addition, in the case where the following mixing and grinding steps are performed by a wet process, a solvent is prepared. As the solvent, ketone such as acetone; alcohol such as ethanol or isopropanol; ether such as diethyl ether; dioxane; acetonitrile; N-methyl-2-pyrrolidone (NMP); or the like can be used. An aprotic solvent that hardly reacts with lithium is further preferably used. In this embodiment, acetone is used.

### <Step S22>

Next, in Step S22, the materials of the mixture 902 are mixed and ground. Although the mixing can be performed by a dry process or a wet process, the wet process is preferable because the materials can be ground to the smaller size. For example, a ball mill, a bead mill, or the like can be used for the mixing. When the ball mill is used, a zirconia ball is preferably used as grinding media, for example. The mixing step and the grinding step are preferably performed sufficiently to pulverize the mixture 902.

### <Step S23>

Next, in Step S23, the materials mixed and ground in the above manner are collected, whereby the mixture 902 is obtained. For example, the mixture 902 preferably has a D50 (median diameter) of greater than or equal to 600 nm and less than or equal to 20 μm, further preferably greater than or equal to 1 μm and less than or equal to 10 μm. Alternatively, the D50 is preferably greater than or equal to 600 nm and less than or equal to 10 μm. Alternatively, the D50 is preferably greater than or equal to 1 μm and less than or equal to 20 μm. When mixed with a composite oxide containing lithium, the transition metal M, and oxygen in the later step, the mixture 902 pulverized to such a small size is easily attached to surfaces of composite oxide particles uniformly. The mixture 902 is preferably attached to the surfaces of the composite oxide particles uniformly because both halogen and magnesium are easily distributed to the surface portion of the composite oxide particles after heating. When there is a region containing neither halogen nor magnesium in the surface portion, the positive electrode active material might be less likely to have an O3′ type crystal structure, which is described later, in the charged state.

### <Step S41>

Next, in Step S41, LiMO₂ obtained in Step S14 and the mixture 902 are mixed. The atomic ratio of the transition metal M in the composite oxide containing lithium, the transition metal, and oxygen to magnesium Mg in the mixture 902 is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the particles of the composite oxide. For example, conditions with a lower rotation frequency or shorter time than the mixing in Step S12 are preferable. In addition, it can be said that conditions of the dry process are less likely to break the particles than those of the wet process. For example, a ball mill, a bead mill, or the like can be used for the mixing. When the ball mill is used, a zirconia ball is preferably used as grinding media, for example.

### <Step S42>

Next, in Step S42, the materials mixed in the above manner are collected, whereby the mixture 903 is obtained.

Note that this embodiment describes a method for adding the mixture of lithium fluoride and magnesium fluoride to lithium cobalt oxide with few impurities; however, one embodiment of the present invention is not limited thereto. A mixture obtained through baking after addition of a magnesium source, a fluorine source, and the like to the starting material of lithium cobalt oxide may be used instead of the mixture 903 in Step S42. In that case, there is no need to separate steps Step S11 to Step S14 and steps Step S21 to Step S23, which is simple and productive.

Alternatively, lithium cobalt oxide to which magnesium and fluorine are added in advance may be used. When lithium cobalt oxide to which magnesium and fluorine are added is used, the process can be simpler because steps up to Step S42 can be omitted.

In addition, a magnesium source and a fluorine source may be further added to the lithium cobalt oxide to which magnesium and fluorine are added in advance.

### <Step S43>

Next, in Step S43, the mixture 903 is heated in an atmosphere containing oxygen. The heating further preferably has the adhesion preventing effect to prevent particles of the mixture 903 from adhering to one another. This step is sometimes referred to as annealing to distinguish this step from the heating step performed before.

Examples of the heating having the adhesion preventing effect are heating while the mixture 903 is being stirred and heating while a container containing the mixture 903 is being vibrated.

The heating temperature in Step S43 needs to be higher than or equal to the temperature at which a reaction between LiMO₂ and the mixture 902 proceeds. Here, the temperature at which the reaction proceeds is a temperature at which interdiffusion between elements included in LiMO₂ and the mixture 902 occurs. Thus, the heating temperature may be lower than the melting temperatures of these materials. For example, in an oxide, solid-phase diffusion occurs at a temperature that is 0.757 times (Tamman temperature T_{d}) the melting temperature Tₘ. Accordingly, for example, in the case where LiMO₂ is LiCoO₂, since the melting point of LiCO₂ is 1130° C., the temperature in Step S43 is higher than or equal to 500° C.

A temperature higher than or equal to the temperature at which at least part of the mixture 903 is melted is preferable because the reaction proceeds more easily. Accordingly, the annealing temperature is preferably higher than or equal to the eutectic point of the mixture 902. In the case where the mixture 902 includes LiF and MgF₂, the eutectic point of LiF and MgF₂ is around 742° C., and the temperature in Step S43 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the annealing temperature is further preferably higher than or equal to 830° C.

A higher annealing temperature is preferable because it facilitates the reaction, shortens the annealing time, and enables high productivity.

Note that the annealing temperature needs to be lower than or equal to a decomposition temperature of LiMO₂ (1130° C. in the case of LiCoO₂). At around the decomposition temperature, a slight amount of LiMO₂ might be decomposed. Thus, the annealing temperature is preferably lower than or equal to 1130° C., further preferably lower than or equal to 1000° C., further preferably lower than or equal to 950° C., and further preferably lower than or equal to 900° C.

In view of the above, the annealing temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the annealing temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the annealing temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

In addition, at the time of heating the mixture 903, the partial pressure of fluorine or a fluoride in the atmosphere is preferably controlled to be within an appropriate range.

In the formation method described in this embodiment, some of the materials, e.g., lithium fluoride as the fluorine source, function as a flux in some cases. Owing to this function, the annealing temperature can be lower than or equal to the decomposition temperature of LiMO₂, e.g., a temperature higher than or equal to 742° C. and lower than or equal to 950° C., which allows distribution of the additive such as magnesium in the surface portion and formation of the positive electrode active material having favorable performance.

Since a lithium fluoride gas is lighter in weight than oxygen, when lithium fluoride vaporizes by heating, lithium fluoride in the mixture 903 decreases. As a result, the function of a flux deteriorates. Therefore, heating needs to be performed while volatilization of lithium fluoride is inhibited. Note that even when lithium fluoride is not used as the fluorine source or the like, there is a possibility in that Li and F at a surface of LiMO₂ react with each other to generate lithium fluoride and vaporize. Therefore, such inhibition of volatilization is necessary also when a fluoride having a higher melting point than lithium fluoride is used.

In view of this, the mixture 903 is preferably heated in an atmosphere containing lithium fluoride, i.e., the mixture 903 is preferably heated in a state where the partial pressure of lithium fluoride in a heating furnace is high. Such heating can inhibit volatilization of lithium fluoride in the mixture 903.

The annealing is preferably performed for an appropriate time. The appropriate annealing time is changed depending on conditions, such as the annealing temperature, and the particle size and composition of LiMO₂ in Step S14. In the case where the particle size is small, the annealing is preferably performed at a lower temperature or for a shorter time than the case where the particle size is large, in some cases.

When the median diameter (D50) of the particles in Step S14 is approximately 12 μm, for example, the annealing temperature is preferably higher than or equal to 600° C. and lower than or equal to 950° C., for example. The annealing time is preferably longer than or equal to 3 hours, further preferably longer than or equal to 10 hours, still further preferably longer than or equal to 60 hours, for example.

On the other hand, when the median diameter (D50) of the particles in Step S24 is approximately 5 μm, the annealing temperature is preferably higher than or equal to 600° C. and lower than or equal to 950° C., for example. The annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

### <Step S44>

Next, in Step S44, the material annealed in the above manner is collected, whereby the positive electrode active materials 100 can be formed. Here, the collected particles are preferably made to pass through a sieve. Through the sieve, adhesion between the positive electrode active materials 100 can be solved.

Next, a formation method different from that of FIG. 10 will be described with reference to FIG. 11 to FIG. 14. Many portions are common to FIG. 10; hence, different portions will be mainly described. The description of FIG. 10 can be referred to for the common portions.

Although FIG. 10 shows the formation method in which LiMO₂ obtained in Step S14 and the mixture 902 are mixed in Step S41, one embodiment of the present invention is not limited to this. As in Step S31 and Step S32 in FIG. 11 to FIG. 14, another added element may be further mixed.

As the added element, one or more selected from nickel, aluminum, manganese, titanium, zirconium, vanadium, iron, chromium, niobium, cobalt, arsenic, zinc, silicon, sulfur, phosphorus, and boron can be used, for example. FIG. 11 to FIG. 14 show an example in which two kinds of added elements, i.e., a nickel source in Step S31 and an aluminum source in Step S32, are used.

These added elements are preferably obtained by pulverizing oxide, hydroxide, fluoride, or the like of the elements. The pulverization can be performed by wet process, for example.

As shown in FIG. 11, the nickel source and the aluminum source can be mixed at the same time as the mixture 902 is mixed in Step S42. This method is preferable for high productivity since the number of annealing times is small.

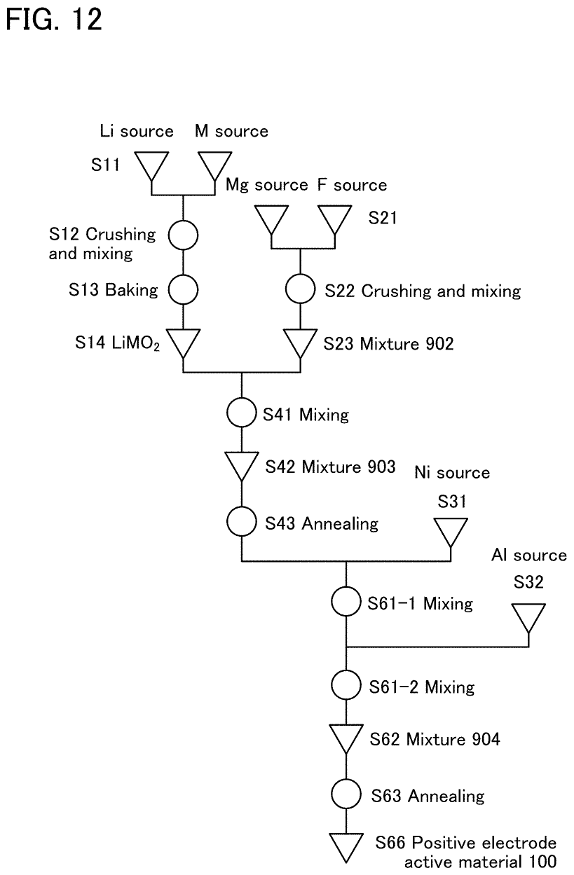

As shown in FIG. 12, a plurality of added element sources may be mixed in different steps. For example, the nickel source can be mixed in Step S61-1, and the aluminum source can be mixed in Step S61-2. In the case where the added element sources are mixed through a plurality of steps in this manner, the mixing method can be changed. For example, steps of mixing by a solid phase method using nickel hydroxide as the nickel source in Step S61-1 and mixing by a sol-gel method using aluminum alkoxide as the aluminum source in Step S61-2 are possible. Through these steps, more favorable distribution of the added elements can be obtained in some cases.

The sol-gel method can be performed in the following manner, for example.

First, an alkoxide of the added element is dissolved in alcohol. An alkoxy group of the alkoxide of the added element preferably has 1 to 18 carbon atoms and may or may not be carbon-substituted.

Aluminum isopropoxide, aluminum butoxide, aluminum ethoxide, or the like can be used as the aluminum alkoxide, for example.

As the alcohol serving as the solvent, methanol, ethanol, propanol, 2-propanol, butanol, or 2-butanol can be used, for example. An alcohol of a kind similar to that of the alkoxy group of the added element is preferably used. Water is contained in the solvent preferably at 3 vol % or less, further preferably at 0.3 vol % or less. The use of alcohol as the solvent can inhibit degradation of LiMO₂ in the formation process as compared with the case of using water.

Next, a process material is mixed into the alcohol solution of the alkoxide of the added element, followed by stirring in an atmosphere containing water vapor.

By being placed in an atmosphere containing H₂O, the alkoxide of the added element undergoes hydrolysis. Then, dehydration condensation occurs between the products. The repeated hydrolysis and dehydration condensation produces a sol of an oxide of the added element. This reaction also occurs on the process material, thereby forming a layer containing the added element on the surface. Next, the process material is collected, the alcohol is vaporized to obtain the mixture 903.

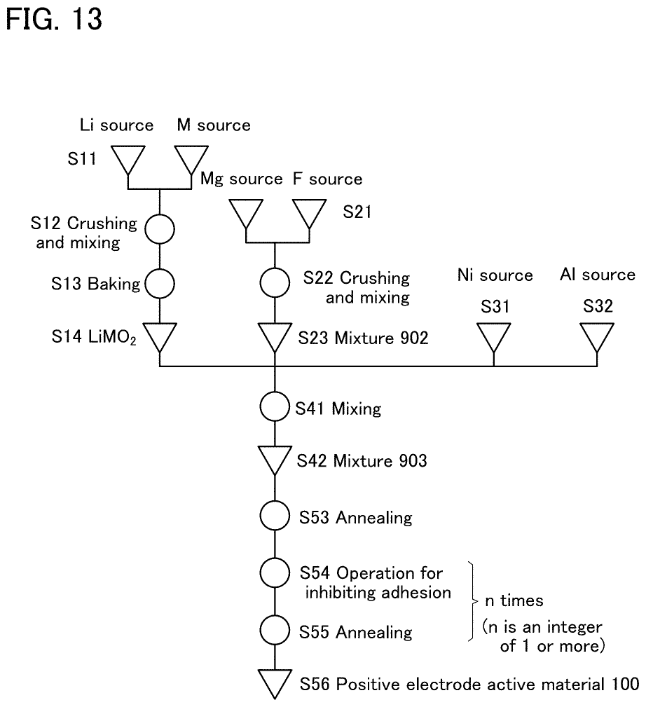

As shown in FIG. 13, annealing may be performed a plurality of times in Step S53 and Step S55, between which Step S54 of operation for inhibiting adhesion may be performed. For the annealing conditions of Step S53 and Step S55, the description of Step S43 can be referred to. Examples of the operation for inhibiting adhesion include crushing with a pestle, mixing with a ball mill, mixing with a planetary centrifugal mixer, making the mixture pass through a sieve, and vibrating a container containing the composite oxide.

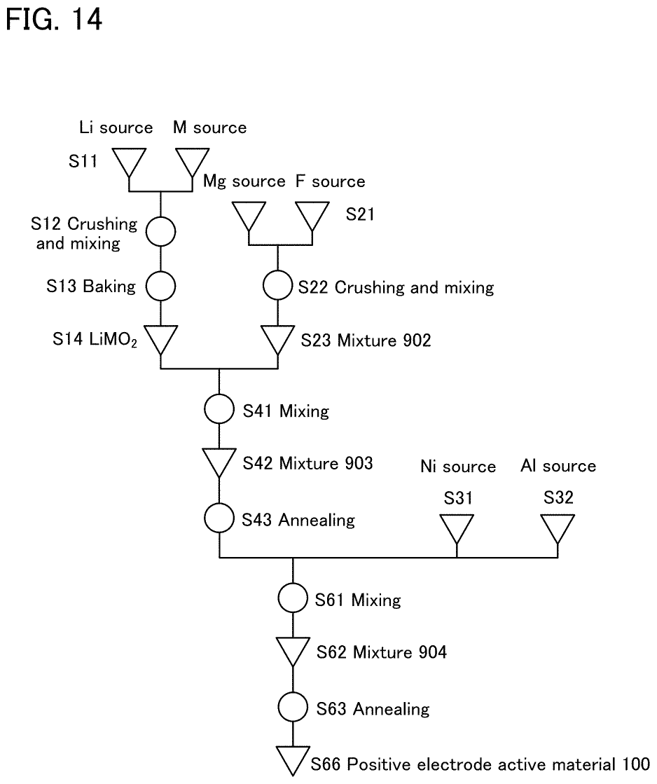

As shown in FIG. 14, LiMO₂ and the mixture 902 are mixed in Step S41 and annealed, and after that a nickel source and an aluminum source may be mixed in Step S61. The mixture here is referred to as a mixture 904. The mixture 904 is annealed again in Step S63. For the annealing conditions, the description of Step S43 can be referred to.

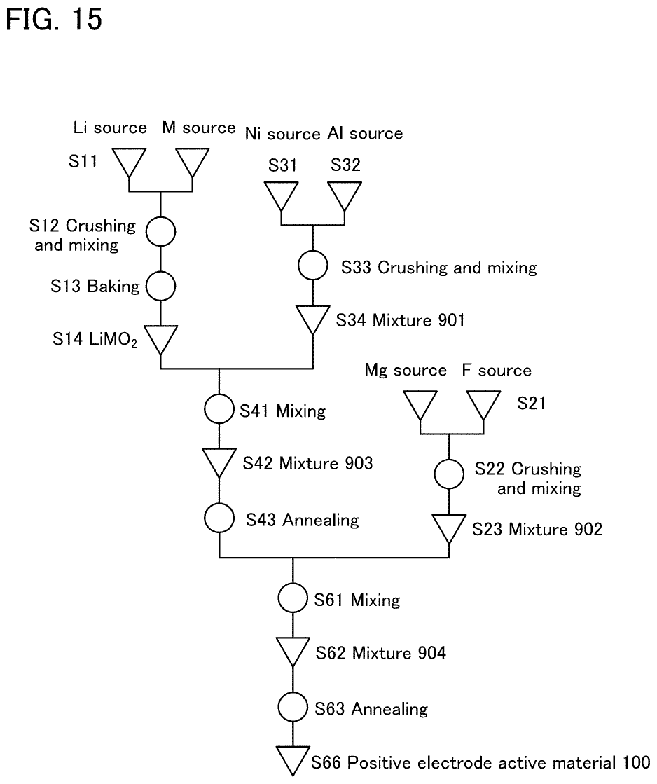

The order of the steps of introducing the added elements may be changed. For example, as shown in FIG. 15, a mixture 901 containing a nickel source and an aluminum source and LiMO₂ may be mixed, annealed in Step S43, and then mixed with the mixture 902 containing a magnesium source and a fluorine source.

When the step of introducing the transition metal M and the step of introducing the additive are separately performed in such a manner, the profiles in the depth direction of the elements can be made different from each other in some cases. For example, the concentration of an added element can be made higher in the surface portion than in the inner portion of the particle. Furthermore, with the number of atoms of the transition metal M as a reference, the ratio of the number of atoms of the added element with respect to the reference can be higher in the surface portion than in the inner portion.

This embodiment can be used in combination with the other embodiments.

### Embodiment 3

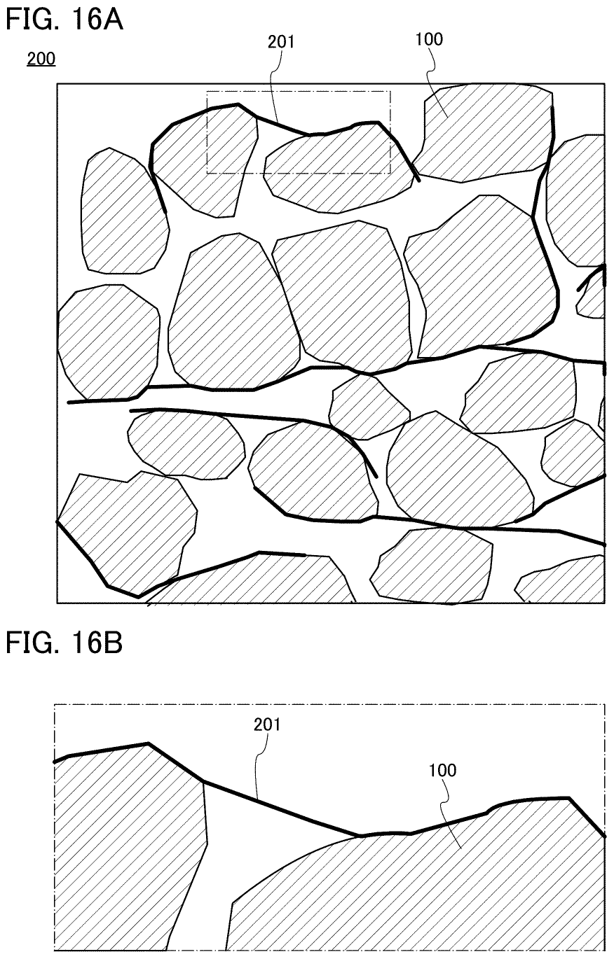

In this embodiment, examples of a secondary battery of one embodiment of the present invention are described with reference to FIG. 16 to FIG. 19.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material formed by the formation method described in the above embodiments is used.

The positive electrode active material described in the above embodiments and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ or LiNi₁₋ₓMₓO₂ (0<x<1) (M=Co, Al, or the like)) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide is measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured with, for example, an inductively coupled plasma mass spectrometer (ICP-MS). The proportion of oxygen in the whole particles of a lithium-manganese composite oxide can be measured by, for example, energy dispersive X-ray spectroscopy (EDX). Alternatively, the proportion of oxygen can be measured by ICP-MS combined with fusion gas analysis and valence evaluation of X-ray absorption fine structure (XAFS) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

A cross-sectional structure example of an active material layer 200 containing graphene or a graphene compound as a conductive material is described below.

FIG. 16A is a longitudinal cross-sectional view of the active material layer 200. The active material layer 200 includes particles of the positive electrode active material 100, graphene or a graphene compound 201 serving as the conductive material, and a binder (not illustrated).

The graphene compound 201 in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a small thickness, and thus a small amount of a graphene compound efficiently allows a conductive path to be formed in an active material layer. Hence, a graphene compound is preferably used as the conductive material, in which case the area where the active material and the conductive material are in contact with each other can be increased. Note that a graphene compound preferably clings to at least part of an active material particle. Alternatively, a graphene compound preferably overlays at least part of an active material particle. Alternatively, the shape of a graphene compound preferably conforms to at least part of the shape of an active material particle. The shape of an active material particle means, for example, unevenness of a single active material particle or unevenness formed by a plurality of active material particles. A graphene compound preferably surrounds at least part of an active material particle. A graphene compound may have a hole.

In the case where active material particles with a small diameter (e.g., 1 μm or less) are used, the specific surface area of the active material particles is large and thus more conductive paths for the active material particles are needed. In such a case, it is particularly preferred that a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charging and discharging may also be referred to as charging and discharging at a high rate, for example, at 1 C, 2 C, or 5 C or more.

The longitudinal cross section of the active material layer 200 in FIG. 16B shows substantially uniform dispersion of the sheet-like graphene or the graphene compound 201 in the active material layer 200. The graphene or the graphene compound 201 is schematically shown by the thick line in FIG. 16B but is actually a thin film having a thickness corresponding to the thickness of a single layer or a multi-layer of carbon molecules. A plurality of sheets of graphene or the plurality of graphene compounds 201 are formed to partly coat or adhere to the surfaces of the plurality of particles of the positive electrode active material 100, so that the plurality of sheets of graphene or the plurality of graphene compounds 201 make surface contact with the particles of the positive electrode active material 100.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the charge and discharge capacity of the secondary battery can be increased.

Here, it is preferable to perform reduction after a layer to be the active material layer 200 is formed in such a manner that graphene oxide is used as the graphene or the graphene compound 201 and mixed with an active material. That is, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the active material layer 200. The solvent is removed by volatilization from a dispersion medium in which graphene oxide is uniformly dispersed, and the graphene oxide is reduced; hence, the sheets of graphene or the graphene compounds 201 remaining in the active material layer 200 partly overlap with each other and are dispersed such that surface contact is made, thereby forming a three-dimensional conduction path. Note that graphene oxide can be reduced by heat treatment or with the use of a reducing agent, for example.

Unlike a conductive material in the form of particles, such as acetylene black, which makes point contact with an active material, the graphene or the graphene compound 201 is capable of making low-resistance surface contact; accordingly, the electrical conduction between the particles of the positive electrode active material 100 and the graphene or the graphene compound 201 can be improved with a small amount of the graphene and the graphene compound 201 compared with a normal conductive material. Thus, the proportion of the positive electrode active material 100 in the active material layer 200 can be increased, resulting in increased discharge capacity of the secondary battery.

It is possible to form, with a spray dry apparatus, a graphene compound serving as a conductive material as a coating film to cover the entire surface of the active material in advance and to form a conductive path between the active materials using the graphene compound.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### [Positive Electrode Current Collector]

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to m.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a secondary battery from exploding or catching fire even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂FsSO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio.

The electrolyte solution used for a secondary battery is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC and LiBOB are particularly preferable because they facilitate formation of a favorable coating film.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may alternatively be used. When the solid electrolyte is used, a separator and a spacer are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefn, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the charge and discharge capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### Structure Example 2 of Secondary Battery

A structure of a secondary battery including a solid electrolyte layer is described below as another structure example of a secondary battery.

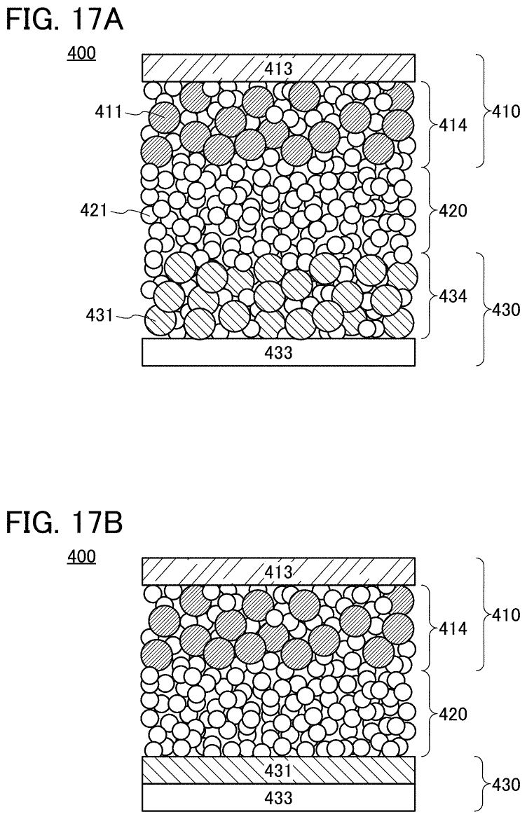

As illustrated in FIG. 17A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material formed by the formation method described in the above embodiments is used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metal lithium is used for the negative electrode 430, it is possible that the negative electrode 430 does not include the solid electrolyte 421 as illustrated in FIG. 17B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂Si₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₋ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

[Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

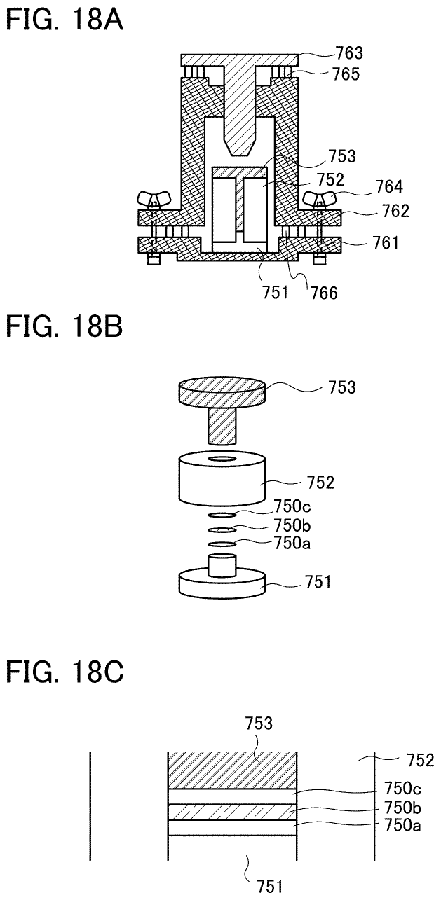

FIG. 18 shows an example of a cell for evaluating materials of an all-solid-state battery.

FIG. 18A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 18B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 18C. Note that the same portions in FIG. 18A, FIG. 18B, and FIG. 18C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

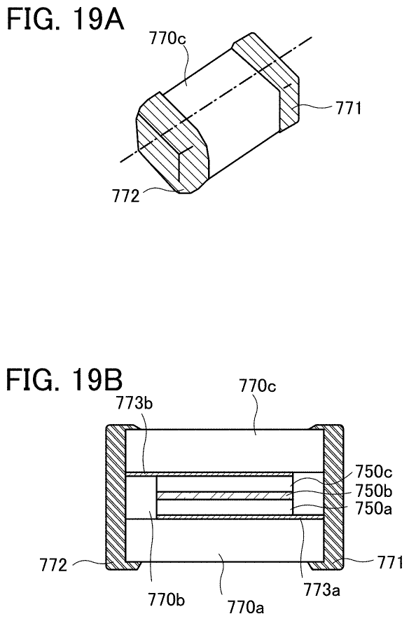

FIG. 19A is a perspective view of a secondary battery of one embodiment of the present invention that has an exterior body and a shape different from those in FIG. 18. The secondary battery in FIG. 19A includes external electrodes 771 and 772 and is sealed with an exterior body including a plurality of package components.

FIG. 19B illustrates an example of a cross section along the dashed-dotted line in FIG. 19A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

This embodiment can be implemented in appropriate combination with any of the other embodiments.

### Embodiment 4

In this embodiment, examples of a shape of a secondary battery including the positive electrode described in the above embodiment are described. For the materials used for the secondary battery described in this embodiment, the description of the above embodiment can be referred to.

### <Coin-Type Secondary Battery>

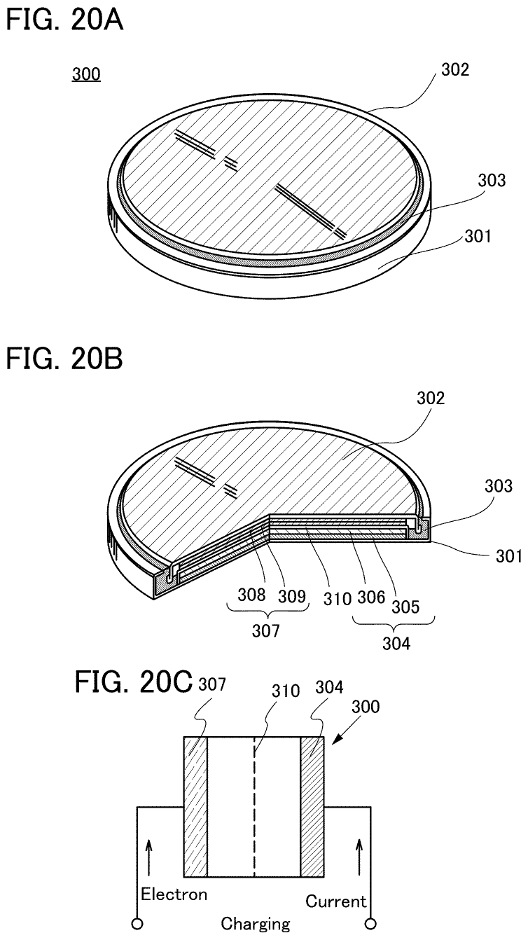

First, an example of a coin-type secondary battery is described. FIG. 20A is an external view of a coin-type (single-layer flat type) secondary battery, and FIG. 20B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte solution. Then, as illustrated in FIG. 20B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type secondary battery 300 is manufactured.

When the positive electrode active material described in the above embodiment is used in the positive electrode 304, the coin-type secondary battery 300 with high charge and discharge capacity and excellent cycle performance can be obtained.

Here, a current flow in charging a secondary battery is described with reference to FIG. 20C. When a secondary battery using lithium is regarded as a closed circuit, movement of lithium ions and the current flow are in the same direction. Note that in the secondary battery using lithium, the anode and the cathode interchange in charging and discharging, and the oxidation reaction and the reduction reaction interchange; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode” related to an oxidation reaction and a reduction reaction might cause confusion because the anode and the cathode interchange in charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive (plus) electrode or a negative (minus) electrode.

Two terminals illustrated in FIG. 20C are connected to a charger, and the secondary battery 300 is charged. As the charge of the secondary battery 300 proceeds, a potential difference between electrodes increases.

### <Cylindrical Secondary Battery>

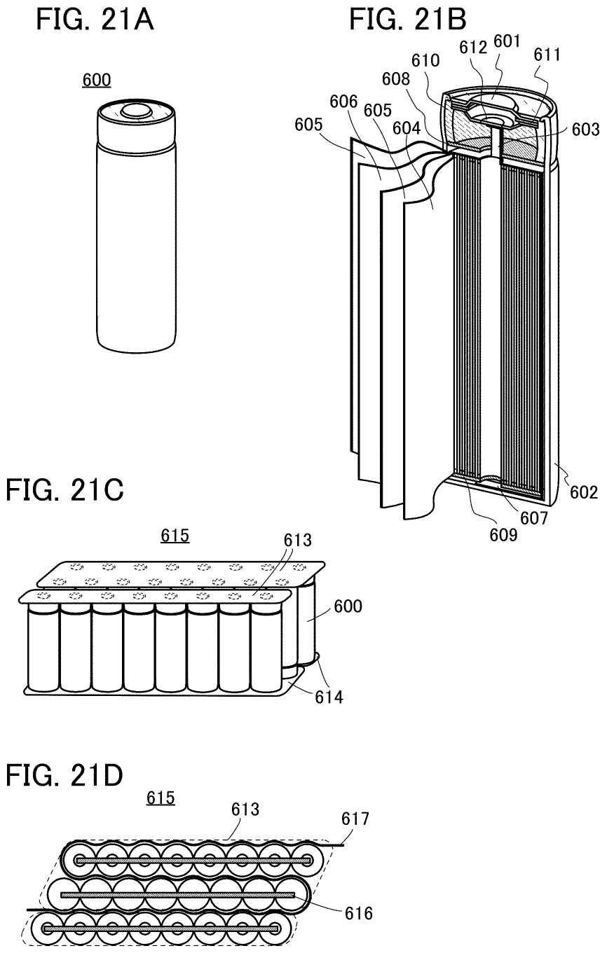

Next, an example of a cylindrical secondary battery is described with reference to FIG. 21. FIG. 21A shows an external view of a cylindrical secondary battery 600. FIG. 21B is a schematic cross-sectional view of the cylindrical secondary battery 600. The cylindrical secondary battery 600 includes, as illustrated in FIG. 21B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not illustrated) is injected inside the battery can 602 provided with the battery element. As the nonaqueous electrolyte solution, a nonaqueous electrolyte solution that is similar to that of the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC element (Positive Temperature Coefficient) 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

Furthermore, as illustrated in FIG. 21C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 21D is a top view of the module 615. The conductive plate 613 is shown by a dotted line for clarity of the diagram. As illustrated in FIG. 21D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be affected by the outside temperature. A heating medium included in the temperature control device 617 preferably has an insulating property and incombustibility.

When the positive electrode active material described in the above embodiment is used in the positive electrode 604, the cylindrical secondary battery 600 with high charge and discharge capacity and excellent cycle performance can be obtained.

### Structure Examples of Secondary Battery

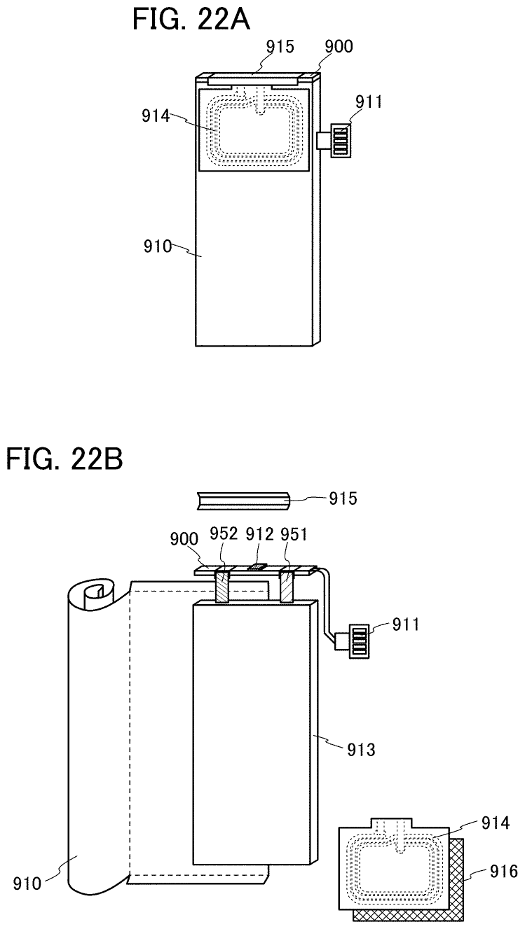

Other structure examples of secondary batteries are described with reference to FIG. 22 to FIG. 26.

FIG. 22A and FIG. 22B are external views of a battery pack. The battery pack includes a secondary battery 913 and a circuit board 900. A secondary battery 913 is connected to an antenna 914 through a circuit board 900. A label 910 is attached to the secondary battery 913. In addition, as illustrated in FIG. 22B, the secondary battery 913 is connected to a terminal 951 and a terminal 952. The circuit board 900 is fixed with a seal 915.

The circuit board 900 includes a terminal 911 and a circuit 912. The terminal 911 is connected to the terminal 951, the terminal 952, the antenna 914, and the circuit 912. Note that a plurality of terminals 911 may be provided to serve as a control signal input terminal, a power supply terminal, and the like.

The circuit 912 may be provided on the rear surface of the circuit board 900. Note that the shape of the antenna 914 is not limited to coil shapes, and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 914 may be a flat-plate conductor. The flat-plate conductor can serve as one of conductors for electric field coupling. That is, the antenna 914 may serve as one of two conductors of a capacitor. Thus, electric power can be transmitted and received not only by an electromagnetic field or a magnetic field but also by an electric field.

The battery pack includes a layer 916 between the antenna 914 and the secondary battery 913. The layer 916 has a function of blocking an electromagnetic field by the secondary battery 913, for example. As the layer 916, for example, a magnetic body can be used.

Note that the structure of the battery pack is not limited to that in FIG. 22.

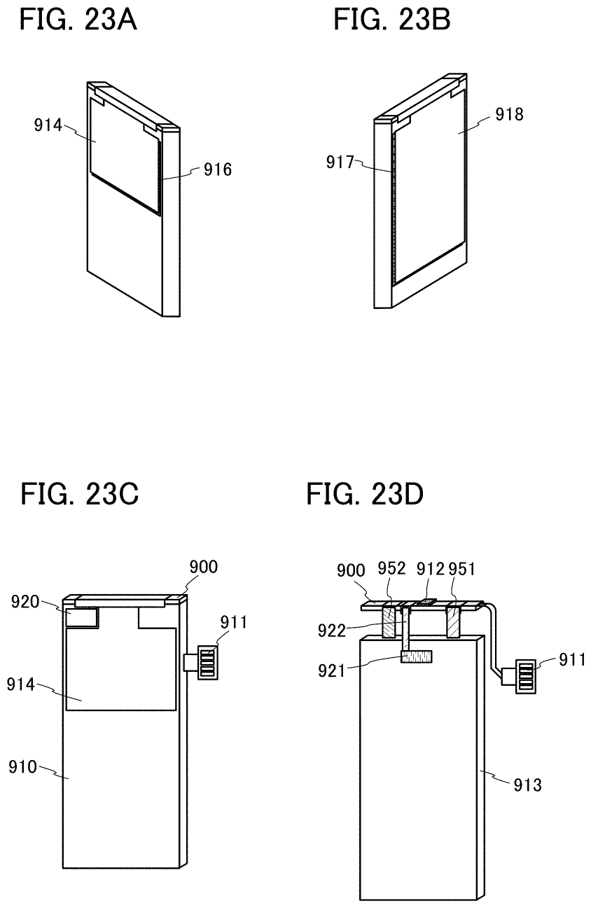

For example, as illustrated in FIG. 23A and FIG. 23B, two opposite surfaces of the secondary battery 913 illustrated in FIG. 22A and FIG. 22B may be provided with respective antennas. FIG. 23A is an external view seen from one side of the opposite surfaces, and FIG. 23B is an external view seen from the other side of the opposite surfaces. Note that for portions similar to those of the secondary battery illustrated in FIG. 22A and FIG. 22B, the description of the secondary battery illustrated in FIG. 22A and FIG. 22B can be appropriately referred to.

As illustrated in FIG. 23A, the antenna 914 is provided on one of the opposite surfaces of the secondary battery 913 with the layer 916 located therebetween, and as illustrated in FIG. 23B, an antenna 918 is provided on the other of the opposite surfaces of the secondary battery 913 with a layer 917 located therebetween. The layer 917 has a function of blocking an electromagnetic field by the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as illustrated in FIG. 23C, the secondary battery 913 illustrated in FIG. 22A and FIG. 22B may be provided with a display device 920. The display device 920 is electrically connected to the terminal 911. Note that the label 910 is not necessarily provided in a portion where the display device 920 is provided. Note that for portions similar to those of the secondary battery illustrated in FIG. 22A and FIG. 22B, the description of the secondary battery illustrated in FIG. 22A and FIG. 22B can be appropriately referred to.

The display device 920 may display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 23D, the secondary battery 913 illustrated in FIG. 22A and FIG. 22B may be provided with a sensor 921. The sensor 921 is electrically connected to the terminal 911 via a terminal 922. Note that for portions similar to those of the secondary battery illustrated in FIG. 22A and FIG. 22B, the description of the secondary battery illustrated in FIG. 22A and FIG. 22B can be appropriately referred to.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be detected and stored in a memory inside the circuit 912.

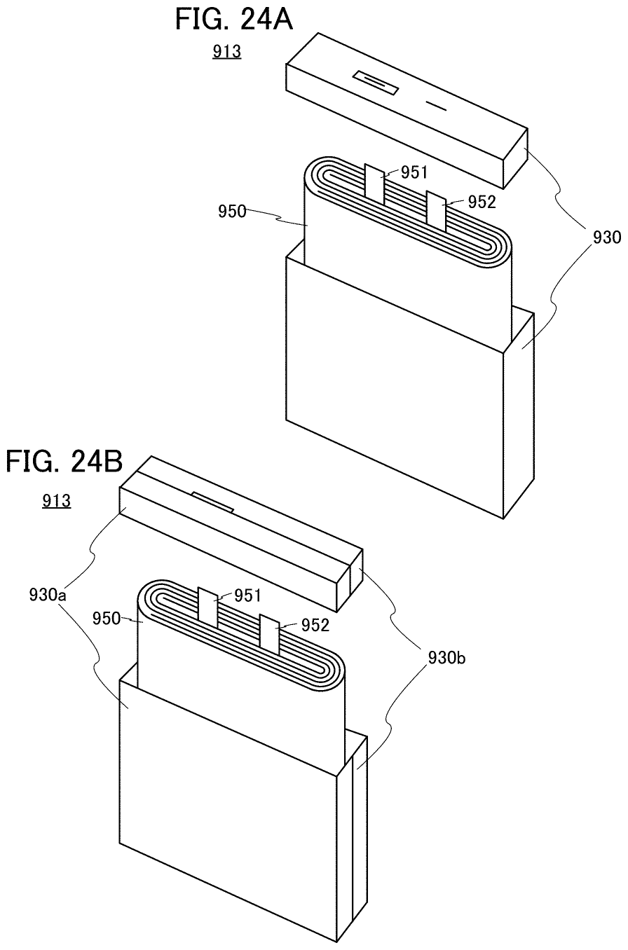

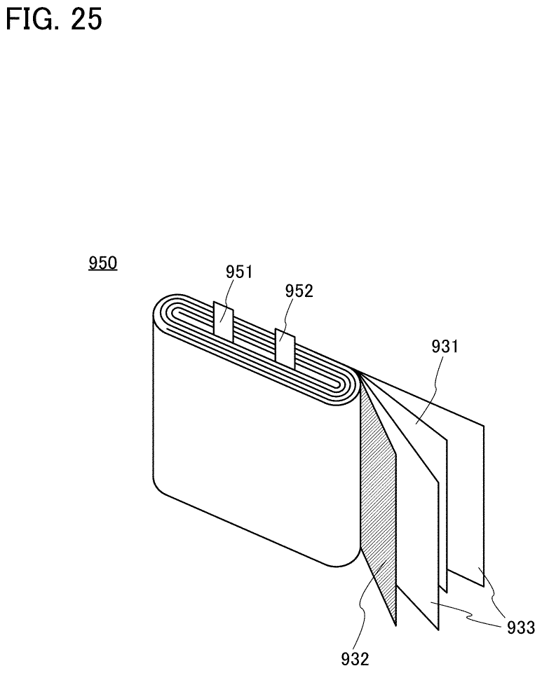

Furthermore, structure examples of the secondary battery 913 are described with reference to FIG. 24 and FIG. 25.

The secondary battery 913 illustrated in FIG. 24A includes a wound body 950 provided with the terminal 951 and the terminal 952 inside a housing 930. The wound body 950 is soaked in an electrolyte solution inside the housing 930. The terminal 952 is in contact with the housing 930. The use of an insulator or the like prevents contact between the terminal 951 and the housing 930. Note that in FIG. 24A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 24B, the housing 930 illustrated in FIG. 24A may be formed using a plurality of materials. For example, in the secondary battery 913 illustrated in FIG. 24B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 may be provided inside the housing 930a. For the housing 930b, a metal material can be used, for example.

FIG. 25 illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

The negative electrode 931 is connected to the terminal 911 illustrated in FIG. 22 via one of the terminal 951 and the terminal 952. The positive electrode 932 is connected to the terminal 911 illustrated in FIG. 22 via the other of the terminal 951 and the terminal 952.

When the positive electrode active material described in the above embodiment is used in the positive electrode 932, the secondary battery 913 with high charge and discharge capacity and excellent cycle performance can be obtained.

### <Laminated Secondary Battery>

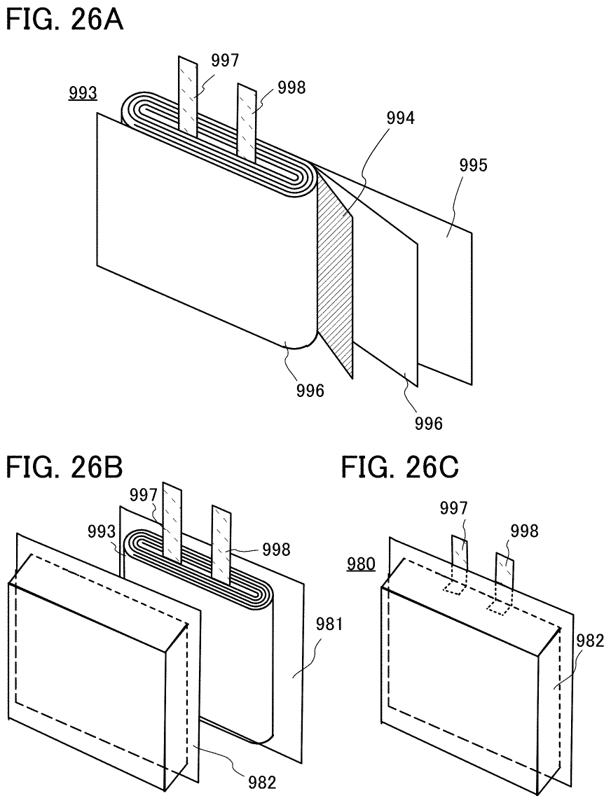

Next, an example of a laminated secondary battery is described with reference to FIG. 26 to FIG. 36. When the laminated secondary battery has flexibility and is used in an electronic device at least part of which is flexible, the secondary battery can be bent as the electronic device is bent.

A laminated secondary battery 980 is described with reference to FIG. 26. The laminated secondary battery 980 includes a wound body 993 illustrated in FIG. 26A. The wound body 993 includes a negative electrode 994, a positive electrode 995, and separators 996. The wound body 993 is, like the wound body 950 illustrated in FIG. 25, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be designed as appropriate depending on required charge and discharge capacity and element volume. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 26B, the above-described wound body 993 is packed in a space formed by bonding a film 981 and a film 982 having a depressed portion that serve as exterior bodies by thermocompression bonding or the like, whereby the secondary battery 980 as illustrated in FIG. 26C can be formed. The wound body 993 includes the lead electrode 997 and the lead electrode 998, and is soaked in an electrolyte solution inside the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 26B and FIG. 26C show an example of using two films, the wound body 993 may be placed in a space formed by bending one film.

When the positive electrode active material described in the above embodiment is used in the positive electrode 995, the secondary battery 980 with high charge and discharge capacity and excellent cycle performance can be obtained.

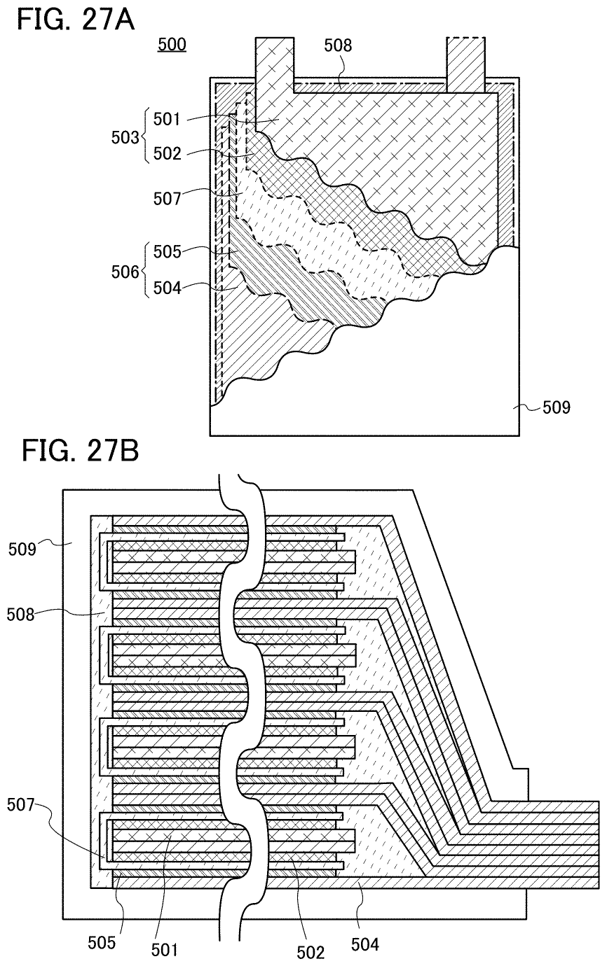

In FIG. 26, an example in which the secondary battery 980 includes a wound body in a space formed by films serving as exterior bodies is described; however, as illustrated in FIG. 27, a secondary battery may include a plurality of strip-shaped positive electrodes, a plurality of strip-shaped separators, and a plurality of strip-shaped negative electrodes in a space formed by films serving as exterior bodies, for example.

A laminated secondary battery 500 illustrated in FIG. 27A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 3 can be used as the electrolyte solution 508.

In the laminated secondary battery 500 illustrated in FIG. 27A, the positive electrode current collector 501 and the negative electrode current collector 504 also serve as terminals for electrical contact with the outside. For this reason, the positive electrode current collector 501 and the negative electrode current collector 504 may be arranged so that part of the positive electrode current collector 501 and part of the negative electrode current collector 504 are exposed to the outside of the exterior body 509. Alternatively, without exposing the positive electrode current collector 501 and the negative electrode current collector 504 from the exterior body 509 to the outside, a lead electrode may be used, and the lead electrode and the positive electrode current collector 501 or the negative electrode current collector 504 may be bonded by ultrasonic welding so that the lead electrode is exposed to the outside.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 27B shows an example of a cross-sectional structure of the laminated secondary battery 500. FIG. 27A shows an example in which only two current collectors are included for simplicity, but actually, a plurality of electrode layers are included as illustrated in FIG. 27B.

In FIG. 27B, the number of electrode layers is 16, for example. Note that the secondary battery 500 has flexibility even though the number of electrode layers is set to 16. FIG. 27B illustrates a structure including 8 layers of negative electrode current collectors 504 and 8 layers of positive electrode current collectors 501, i.e., 16 layers in total. Note that FIG. 27B illustrates a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high charge and discharge capacity. In contrast, with a small number of electrode layers, the secondary battery can have small thickness and high flexibility.

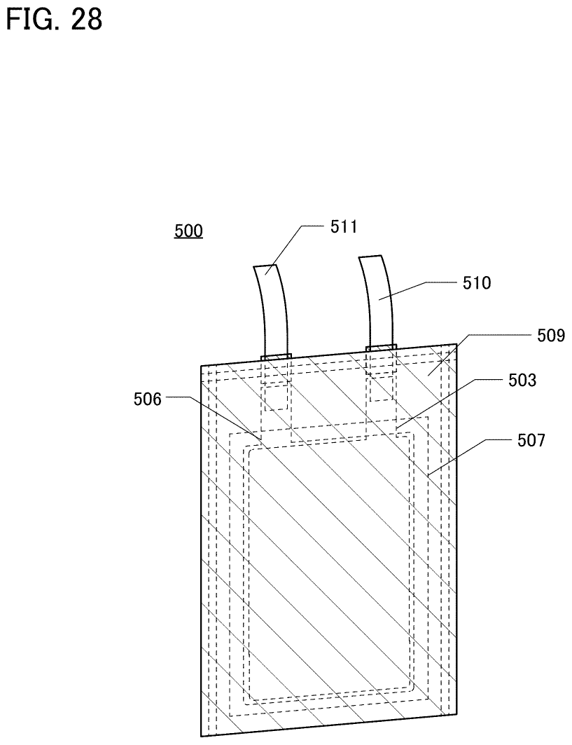

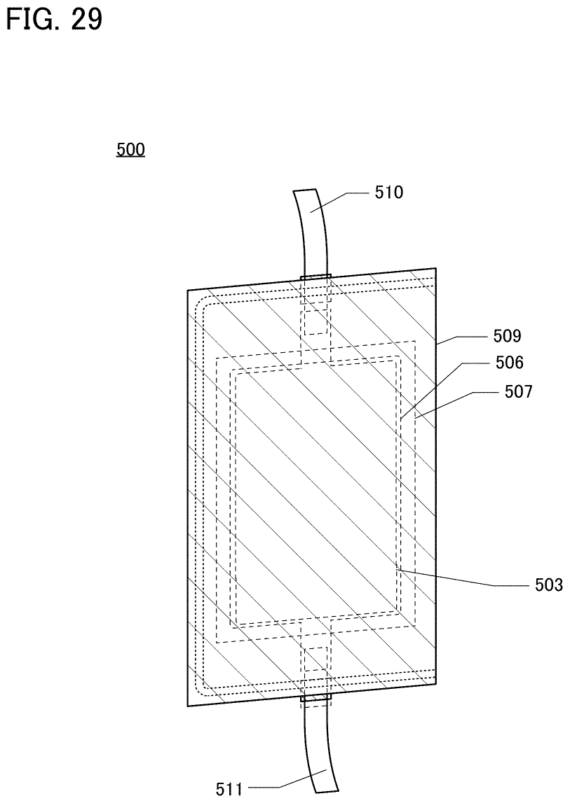

FIG. 28 and FIG. 29 each show an example of the external view of the laminated secondary battery 500. In FIG. 28 and FIG. 29, the positive electrode 503, the negative electrode 506, the separator 507, the exterior body 509, a positive electrode lead electrode 510, and a negative electrode lead electrode 511 are included.

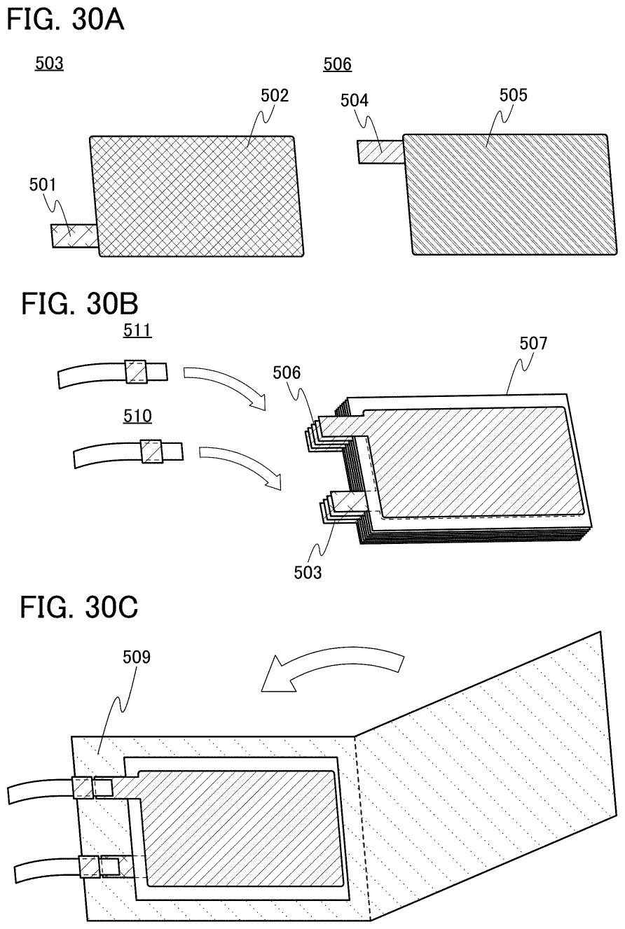

FIG. 30A illustrates external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 30A.

### <Method for Manufacturing Laminated Secondary Battery>

Here, an example of a method for manufacturing the laminated secondary battery whose external view is illustrated in FIG. 28 is described with reference to FIG. 30B and FIG. 30C.

First, the negative electrode 506, the separator 507, and the positive electrode 503 are stacked. FIG. 30B illustrates a stack including the negative electrode 506, the separator 507, and the positive electrode 503. Here, an example in which 5 negative electrodes and 4 positive electrodes are used is shown. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a portion shown by a dashed line as illustrated in FIG. 30C. Then, the outer edges of the exterior body 509 are bonded to each other. The bonding can be performed by thermocompression bonding, for example. At this time, an unbonded region (hereinafter referred to as an inlet) is provided for part (or one side) of the exterior body 509 so that the electrolyte solution 508 can be put later.

Next, the electrolyte solution 508 (not illustrated) is introduced into the exterior body 509 from the inlet of the exterior body 509. The electrolyte solution 508 is preferably introduced in a reduced pressure atmosphere or in an inert gas atmosphere. Lastly, the inlet is bonded. In the above manner, the laminated secondary battery 500 can be manufactured.

When the positive electrode active material described in the above embodiment is used in the positive electrode 503, the secondary battery 500 with high charge and discharge capacity and excellent cycle performance can be obtained.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charge and discharge of the all-solid-state battery can be suppressed, and the reliability of the all-solid-state battery can be improved.

This embodiment can be implemented in appropriate combination with any of the other embodiments.

### Embodiment 5

In this embodiment, examples of electronic devices each including the secondary battery of one embodiment of the present invention are described.

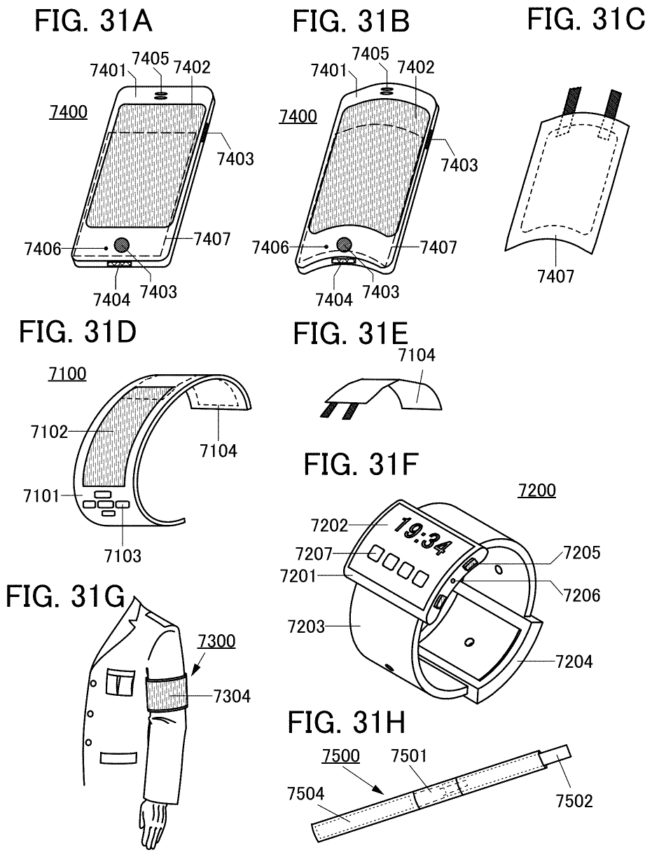

First, FIG. 31A to FIG. 31G show examples of electronic devices including the bendable secondary battery described in the above embodiment. Examples of electronic devices each including a bendable secondary battery include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house or a building or a curved interior/exterior surface of an automobile.

FIG. 31A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 31B illustrates the mobile phone 7400 that is curved. When the whole mobile phone 7400 is curved by external force, the secondary battery 7407 provided therein is also curved. FIG. 31C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 31D shows an example of a bangle display device. A portable display device 7100 includes a housing 7101, a display portion 7102, operation buttons 7103, and a secondary battery 7104. FIG. 31E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 31F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

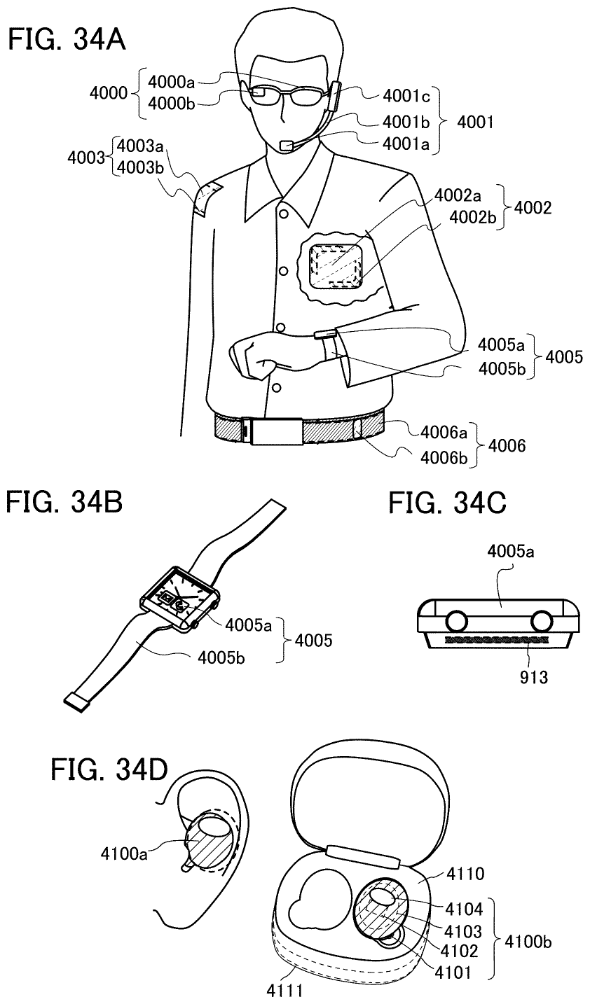

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 31E that is in the state of being curved can be provided in the housing 7201. Alternatively, the secondary battery 7104 illustrated in FIG. 34E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 31G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

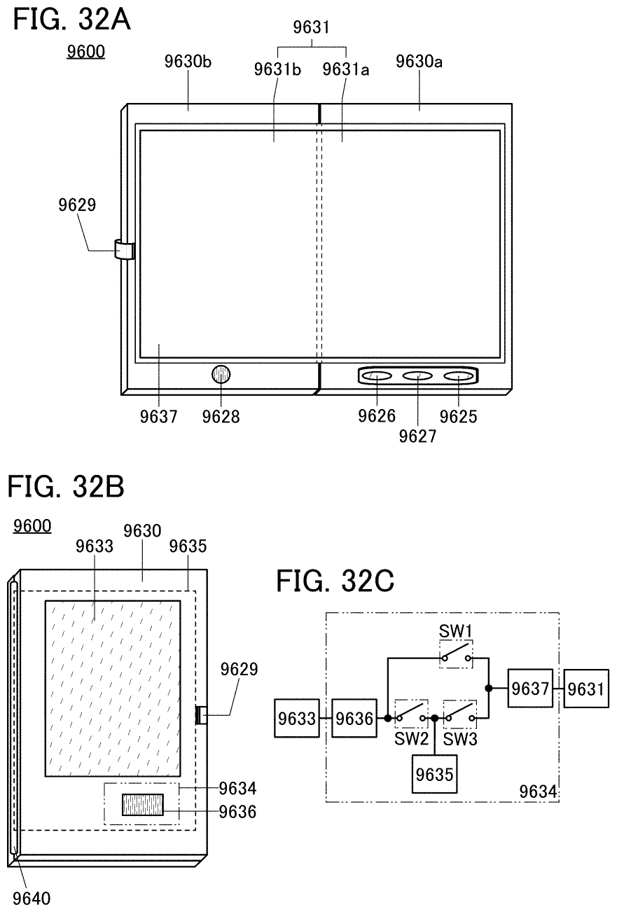

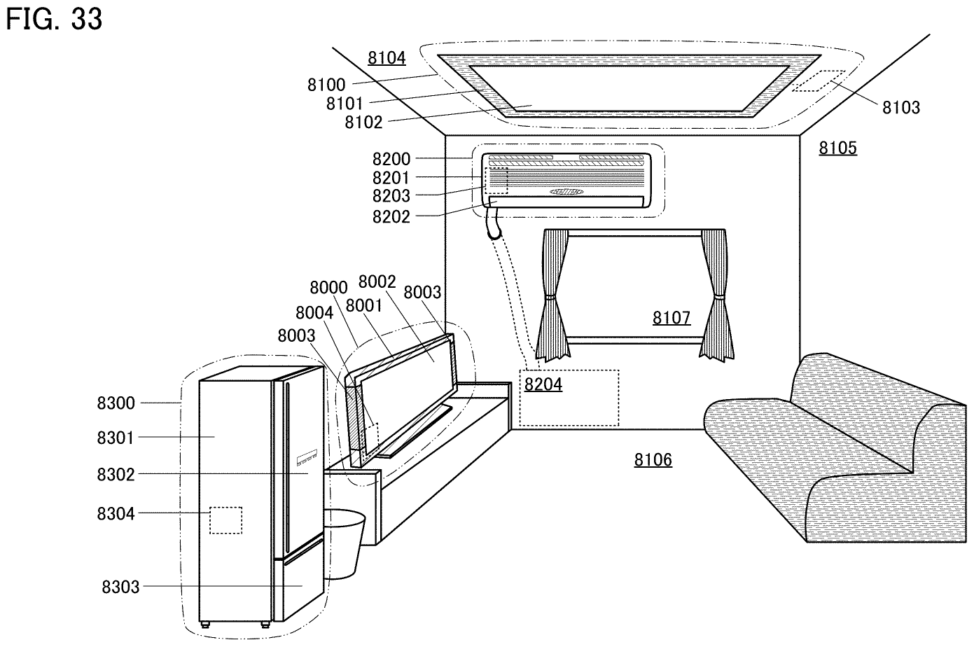

Examples of electronic devices each including the secondary battery with excellent cycle performance described in the above embodiment are described with reference to FIG. 31H, FIG. 32, and FIG. 33.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high charge and discharge capacity are desired in consideration of handling ease for users.

FIG. 31H is a perspective view of a device called a cigarette smoking device (electronic cigarette). In FIG. 31H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 illustrated in FIG. 31H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high charge and discharge capacity and excellent cycle performance, the small and lightweight electronic cigarette 7500 that can be used for a long time over a long period can be provided.

Next, FIG. 32A and FIG. 32B show an example of a tablet terminal that can be folded in half A tablet terminal 9600 illustrated in FIG. 32A and FIG. 32B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 32A illustrates the tablet terminal 9600 that is opened, and FIG. 32B illustrates the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

The entire region or part of the region of the display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display a keyboard on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may function as a switch for switching power on/off of the tablet terminal 9600. For another example, at least one of the switch 9625 to the switch 9627 may have a function of switching the display orientation between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use of the tablet terminal 9600 detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 32A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different sizes or different display quality. For example, one may be a display panel that can display higher-definition images than the other.

The tablet terminal 9600 is folded in half in FIG. 32B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

Note that as described above, the tablet terminal 9600 can be folded in half, and thus can be folded when not in use such that the housing 9630a and the housing 9630b overlap with each other. By the folding, the display portion 9631 can be protected, which increases the durability of the tablet terminal 9600. With the power storage unit 9635 including the secondary battery of one embodiment of the present invention, which has high charge and discharge capacity and excellent cycle performance, the tablet terminal 9600 that can be used for a long time over a long period can be provided.

The tablet terminal 9600 illustrated in FIG. 32A and FIG. 32B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, can supply electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 illustrated in FIG. 32B are described with reference to a block diagram in FIG. 32C. The solar cell 9633, the power storage unit 9635, the DCDC converter 9636, a converter 9637, switches SW1 to SW3, and the display portion 9631 are illustrated in FIG. 32C, and the power storage unit 9635, the DCDC converter 9636, the converter 9637, and the switches SW1 to SW3 correspond to the charge and discharge control circuit 9634 illustrated in FIG. 32B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Note that the solar cell 9633 is described as an example of a power generation unit; however, one embodiment of the present invention is not limited to this example. The power storage unit 9635 may be charged using another power generation unit such as a piezoelectric element or a thermoelectric conversion element (Peltier element). For example, the charge may be performed with a non-contact power transmission module that performs charge by transmitting and receiving power wirelessly (without contact), or with a combination of other charge units.

FIG. 33 illustrates other examples of electronic devices. In FIG. 33, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 33, an installation lighting device 8100 is an example of an electronic device including a secondary battery 8103 of one embodiment of the present invention. Specifically, the lighting device 8100 includes a housing 8101, alight source 8102, the secondary battery 8103, and the like. Although FIG. 33 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 33 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 33, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 33 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 33 as an example, the secondary battery of one embodiment of the present invention can be used in an air conditioner in which the function of an indoor unit and the function of an outdoor unit are integrated in one housing.

In FIG. 33, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 33. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. Therefore, the tripping of a breaker of a commercial power supply in use of the electronic device can be prevented by using the secondary battery of one embodiment of the present invention as an auxiliary power supply for supplying electric power which cannot be supplied enough by a commercial power supply.

In a time period when electronic devices are not used, particularly when the proportion of the amount of electric power which is actually used to the total amount of electric power which can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high charge and discharge capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

This embodiment can be implemented in appropriate combination with the other embodiments.

### Embodiment 6

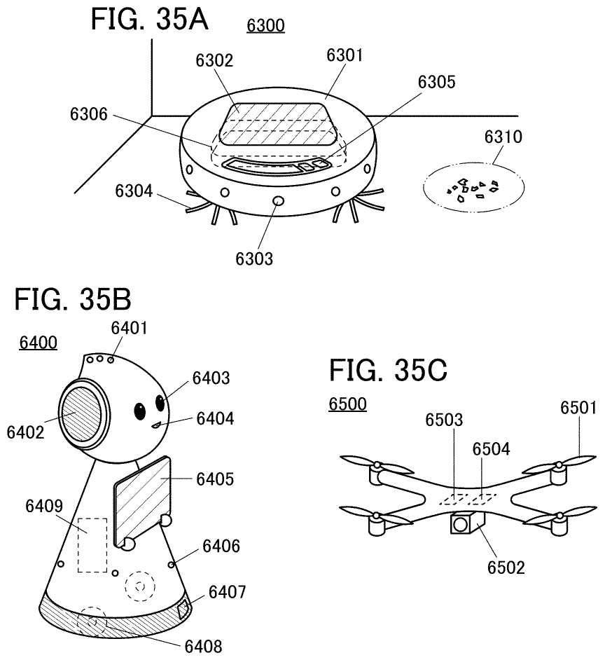

In this embodiment, examples of electronic devices each including the secondary battery described in the above embodiment are described with reference to FIG. 34A to FIG. 35C.

FIG. 34A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 34A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for along time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 34B is a perspective view of the watch-type device 4005 that is detached from an arm.

FIG. 34C is a side view. FIG. 34C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 34D illustrates an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably include a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4100. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 35A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 35B illustrates an example of a robot. A robot 6400 illustrated in FIG. 35B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 secondary battery of one embodiment of the present invention and a semiconductor device or an electronic component. The robot 6400 including the secondary battery of one embodiment of the present invention can be a highly reliable electronic device that can operate for a long time.

FIG. 35C illustrates an example of a flying object. A flying object 6500 illustrated in FIG. 35C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 7

In this embodiment, examples of vehicles each including the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

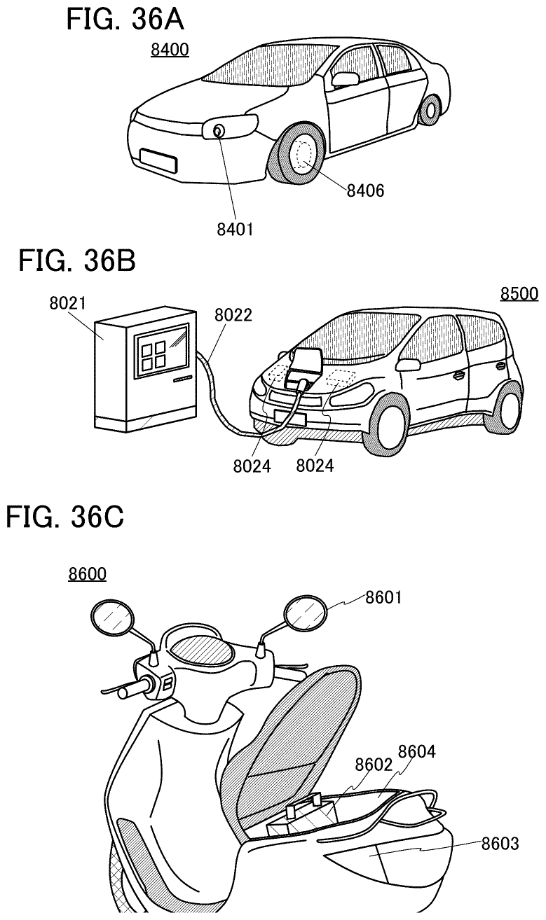

FIG. 36 illustrates examples of a vehicle including the secondary battery of one embodiment of the present invention. An automobile 8400 illustrated in FIG. 36A is an electric vehicle that runs on the power of an electric motor. Alternatively, the automobile 8400 is a hybrid electric vehicle capable of driving using either an electric motor or an engine as appropriate. The use of one embodiment of the present invention achieves a high-mileage vehicle. The automobile 8400 includes the secondary battery. As the secondary battery, the modules of the secondary batteries illustrated in FIG. 21C and FIG. 21D may be arranged to be used in a floor portion in the automobile. Alternatively, a battery pack in which a plurality of secondary batteries illustrated in FIG. 24 are combined may be placed in the floor portion in the automobile. The secondary battery can be used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 illustrated in FIG. 36B can be charged when the secondary battery included in the automobile 8500 is supplied with electric power through external charge equipment by a plug-in system, a contactless power feeding system, or the like. FIG. 36B illustrates a state where a secondary battery 8024 included in the automobile 8500 is charged with the use of a ground-based charging apparatus 8021 through a cable 8022. Charging can be performed as appropriate by a given method such as CHAdeMO (registered trademark) or Combined Charging System as a charging method, the standard of a connector, or the like. The charging apparatus 8021 may be a charge station provided in a commerce facility or a power supply in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 36C illustrates an example of a motorcycle including the secondary battery of one embodiment of the present invention. A motor scooter 8600 illustrated in FIG. 36C includes a secondary battery 8602, side mirrors 8601, and direction indicators 8603. The secondary battery 8602 can supply electric power to the direction indicators 8603.

In the motor scooter 8600 shown in FIG. 36C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the charge and discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### Example

In this example, the positive electrode active material 100 of one embodiment of the present invention was formed and the features were analyzed.

### <Formation of Positive Electrode Active Material>

Samples formed in this example are described with reference to the formation method shown in FIG. 14.

As the LiMO₂ in Step S14, with the use of cobalt as the transition metal M, a commercially available lithium cobalt oxide (Cellseed C-10N produced by NIPPON CHEMICAL INDUSTRIAL CO., LTD.) not containing any added element was prepared. Lithium fluoride and magnesium fluoride were mixed therewith by a solid phase method, as in Step S21 to Step S23 and Step S41 and Step S42. Lithium fluoride and magnesium fluoride were added such that the number of molecules of lithium fluoride was 0.33 and the number of molecules of magnesium fluoride was 1 with the number of cobalt atoms assumed as 100. The mixture here is the mixture 903.

Next, annealing was performed in a manner similar to that of Step S43. In a square-shaped alumina container, 30 g of the mixture 903 was placed, a lid was put on the container, and heating was performed in a muffle furnace. The atmosphere in the furnace was purged and oxygen gas was introduced; the oxygen flow was stopped during the heating. The annealing temperature was 900° C., and the annealing time was 20 hours.

After the heating, nickel hydroxide and aluminum hydroxide were added to and mixed with the composite oxide in a manner similar to that of Step S31, Step S32, Step S61, and Step S62. The addition was performed so that the number of nickel atoms was 0.5 and the number of aluminum atoms was 0.5 with the number of cobalt atoms assumed as 100. The mixture here is the mixture 904.

Next, annealing was performed in a manner similar to that of Step S63. In a square-shaped alumina container, 100 g of the mixture 904 was placed, a lid was put on the container, and heating was performed in a muffle furnace. The flow rate of oxygen gas during the heating was set at 10 L/minute. The annealing temperature was 850° C., and the annealing time was 10 hours. The positive electrode active material thus formed is referred to as Sample 1-1 (Step S66).

Next, a sample formed in a manner similar to that of Sample 1-1 except that the annealing in Step S43 was performed at 850° C. for 60 hours with the flow rate of oxygen gas during the heating set at 10 L/minute and the annealing in Step S63 was performed at 850° C. for 2 hours is referred to as Sample 1-2.

Next, a sample formed in a manner similar to that of Sample 1-1 except that the nickel source and the aluminum source were mixed together with the magnesium source and the fluorine source as in the formation method shown in FIG. 11 and the annealing in Step S43 was performed at 850° C. for 60 hours with the flow rate of oxygen gas during the heating set at 10 L/minute is referred to as Sample 1-3.

Next, a sample formed in a manner similar to that of Sample 1-1 except that the nickel source and the aluminum source were mixed first with the lithium cobalt oxide and after the annealing in Step S43 (850° C., 2 hours, the flow rate of oxygen gas during the heating at 10 L/minute), the magnesium source and the fluorine source were mixed and the annealing in Step S63 (850° C., 2 hours) was performed as in the formation method shown in FIG. 15 is referred to as Sample 1-4.

Next, a sample formed by mixing aluminum isopropoxide (Al(O-i-Pr)₃) as the aluminum source in a step different from the step of mixing the nickel source as in the formation method shown in FIG. 12 is referred to as Sample 1-5. In this case, isopropanol was used as a solvent of the Al isopropoxide. The mixture obtained by mixing in S61-1 and the Al isopropoxide were made to react with water contained in the air for 17 hours while being stirred. Then, the mixture was dried in a circulation drying furnace at 80° C. for 3 hours to be hardened, and the annealing in Step S63 (850° C., 2 hours) was performed. The other conditions were similar to those of Sample 1-2.

Next, a sample formed in a manner similar to that of Sample 1-5 except that the addition was performed so that the number of molecules of lithium fluoride was 0.66 and the number of molecules of magnesium fluoride was 2 with the number of cobalt atoms assumed as 100 is referred to as Sample 1-6.

Next, a sample formed by repeating the annealing and the operation for inhibiting adhesion a plurality of times as in the formation method shown in FIG. 13 is referred to as Sample 1-7. In this case, the first and the second annealings were performed at 900° C. for 10 hours, and the third annealing was performed at 920° C. for 10 hours. In the operation for inhibiting adhesion that was performed between annealings, the composite oxide was put in a mortar and crushed with a pestle. The other conditions were similar to those of Sample 1-3.

A sample formed in a manner similar to that of Sample 1-7 except that the temperature of the third annealing was set at 900° C. is referred to as Sample 1-8.

Lithium cobalt oxide (Cellseed C-TON produced by NIPPON CHEMICAL INDUSTRIAL CO., LTD.) containing cobalt as the transition metal and not containing any added element is referred to as Sample 2, which is a comparative example.

A sample formed in a manner similar to that of Sample 1-3 except that the nickel source and the aluminum source were not used is referred to as Sample 3.

A sample formed in a manner similar to that of Sample 1-5 except that the nickel source and the aluminum source were not used is referred to as Sample 4.

A sample formed in a manner similar to that of Sample 1-5 except that the aluminum source was not used is referred to as Sample 5.

A sample formed in a manner similar to that of Sample 1-5 except that the nickel source was not used is referred to as Sample 6.

A sample formed in a manner similar to that of Sample 3 except that the addition was performed so that the number of molecules of lithium fluoride was 0.17 and the number of molecules of magnesium fluoride was 0.5 with the number of cobalt atoms assumed as 100 is referred to as Sample 7.

A sample formed in a manner similar to that of Sample 6 except that the addition was performed so that the number of molecules of lithium fluoride was 0.17 and the number of molecules of magnesium fluoride was 0.5 with the number of cobalt atoms assumed as 100, the annealing in Step S43 was performed at a temperature of 900° C. for 20 hours, a titanium source was used instead of the aluminum source, and titanium isopropoxide (TTIP) was used as the titanium source is referred to as Sample 8.

Table 1 shows the formation conditions of Sample 1-1 to Sample 8. As is clear from Table 1, a point Sample 1-1 to Sample 1-8 have in common is that annealing was performed after the magnesium source, the fluorine source, the nickel source, and the aluminum source were added to LiCoO₂ not containing any added element; therefore, all of Sample 1-1 to Sample 1-8 may be referred to as Sample 1 to be distinguished from the samples not having the common point.

TABLE 1

| | | Formation conditions | | | | |
|---|---|---|---|---|---|---|
| | | | | Annealing | | Annealing |
| | Flowchart | LiMO₂ | Additive | (° C., (hr)) | Additive (at %) | (° C., (hr)) |
| Sample 1-1 | FIG. 14 | LiCoO₂ | LiF 0.33 | 900 (20) | Ni(OH)₂ 0.5 | 850 (10) |
| | | | MgF₂ 1 | | Al(OH)₃ 0.5 | |
| Sample 1-2 | FIG. 14 | | LiF 0.33 | 850 (60) | Ni(OH)₂ 0.5 | 850 (2) |
| | | | MgF₂ 1 | | Al(OH)₃ 0.5 | |
| Sample 1-3 | FIG. 11 | | LiF 0.33 | 850 (60) | — | |
| | | | MgF₂ 1 | | | |
| | | | Ni(OH)₂ 0.5 | | | |
| | | | Al(OH)₃ 0.5 | | | |
| Sample 1-4 | FIG. 15 | | Ni(OH)₂ 0.5 | 850 (2) | LiF 0.33 | 850 (2) |
| | | | Al(OH)₃ 0.5 | | MgF₂ 1 | |
| Sample 1-5 | FIG. 12 | | LiF 0.33 | 850 (60) | Ni(OH)₂ 0.5 | 850 (2) |
| | | | MgF₂ 1 | | Al(O—i-Pr)₃ 0.5 | |
| Sample 1-6 | FIG. 12 | | LiF 0.66 | 850 (60) | Ni(OH)₂ 0.5 | 850 (2) |
| | | | MgF₂ 2 | | Al(O—i-Pr)₃ 0.5 | |
| Sample 1-7 | FIG. 13 | | LiF 0.33 | 900 (10) | — | |
| | | | MgF₂ 1 | 900 (10) | | |
| | | | Ni(OH)₂ 0.5 | 920 (10) | | |
| | | | Al(OH)₃ 0.5 | | | |
| Sample 1-8 | FIG. 13 | | LiF 0.33 | 900 (10) | — | |
| | | | MgF₂ 1 | 900 (10) | | |
| | | | Ni(OH)₂ 0.5 | 900 (10) | | |
| | | | Al(OH)₃ 0.5 | | | |
| Sample 2 | — | LiCoO₂ | — | | — | |
| (Comparative | | | | | | |
| example) | | | | | | |
| Sample 3 | — | LiCoO₂ | LiF 0.33 | 850 (60) | — | |
| | | | MgF₂ 1 | | | |
| Sample 4 | — | | LiF 0.66 | 850 (60) | — | |
| | | | MgF₂ 2 | | | |
| Sample 5 | — | | LiF 0.66 | 850 (60) | Ni(OH)₂ 0.5 | 850 (2) |
| | | | MgF₂ 2 | | | |
| Sample 6 | — | | LiF 0.66 | 850 (60) | Al(O—i-Pr)₃ 0.5 | 850 (2) |
| | | | MgF₂ 2 | | | |
| Sample 7 | — | | LiF 0.17 | 850 (60) | — | |
| | | | MgF₂ 0.5 | | | |
| Sample 8 | — | | LiF 0.17 | 900 (20) | TTIP 0.5 | 850 (2) |
| | | | MgF₂ 0.5 | | | |

### <SEM>

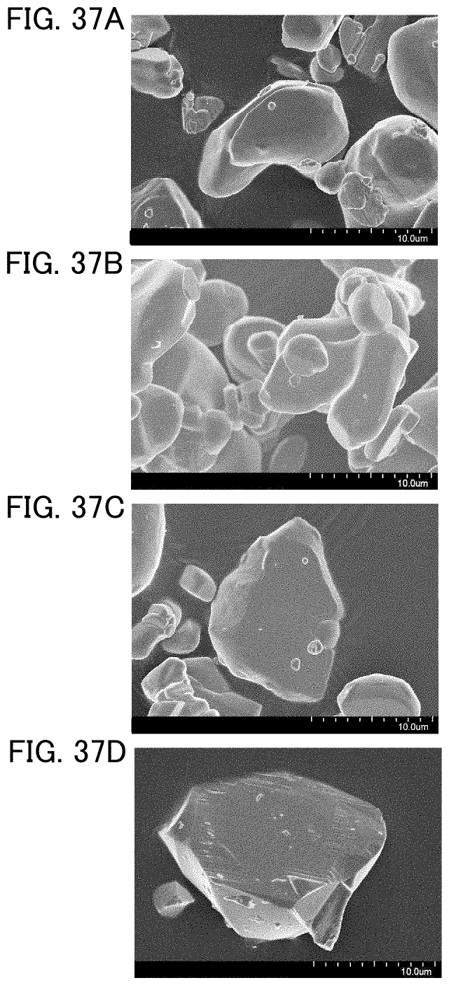

FIG. 37A, FIG. 37B, FIG. 37C, and FIG. 37D are surface SEM images of Sample 1-2, Sample 1-3, Sample 1-4, and Sample 2, respectively. Sample 1-2 to Sample 1-4 annealed after addition of additives each having a rounded corner and a smooth surface with little unevenness were observed. In contrast, Sample 2 not subjected to annealing having a relatively sharp corner and a rough surface with much unevenness was observed.

### <Electron Diffraction>

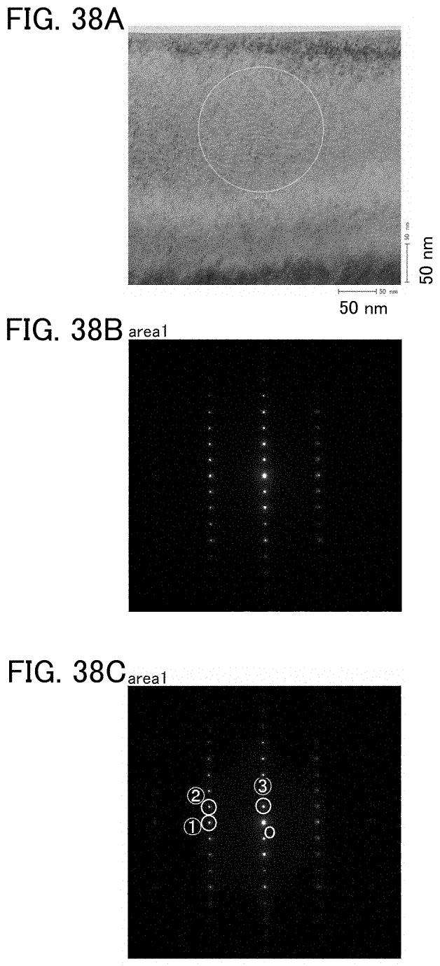

FIG. 38 to FIG. 41 show results of analysis on the positive electrode active material of Sample 1-1 formed as described above by cross-sectional TEM and an electron diffraction method.

FIG. 38A is a cross-sectional TEM image of the positive electrode active material from the surface to a depth of approximately 3 μm. A selected-area electron diffraction pattern of an areal indicated by a white circle in FIG. 38A is shown in FIG. 38B. Some of bright spots in FIG. 38B are denoted as 1, 2, 3, and O as shown in FIG. 38C. O represents transmitted light, and 1, 2, and 3 represent diffraction spots.

The areal is an inner portion of the positive electrode active material at depths of more than or equal to 50 nm from the surface. The measured values of the selected-area diffraction pattern of the inner portion was as follows: 1 had d=0.144 nm, 2 had d=0.138 nm, and 3 had d=0.479 nm. The interplanar angles were ∠1O2=17°, ∠1O3=90°, and ∠2O3=74°.

It was confirmed from these results that the inner portion of the positive electrode active material has the layered rock-salt crystal structure. The a-axis lattice constant was 2.88 Å and the c-axis lattice constant was 14.37 Å. Note that 1 Å is 10⁻¹⁰ μm.

Note that according to literature values of a layered rock-salt LiCoO₂, 1 has d=0.141 nm, 2 has d=0.135 nm, 3 has d=0.468 nm, and the interplanar angles are ∠1O2=17°, ∠1O3=90°, and ∠2O3=73°. The difference between the measured values and the literature values is considered to be a measurement error.

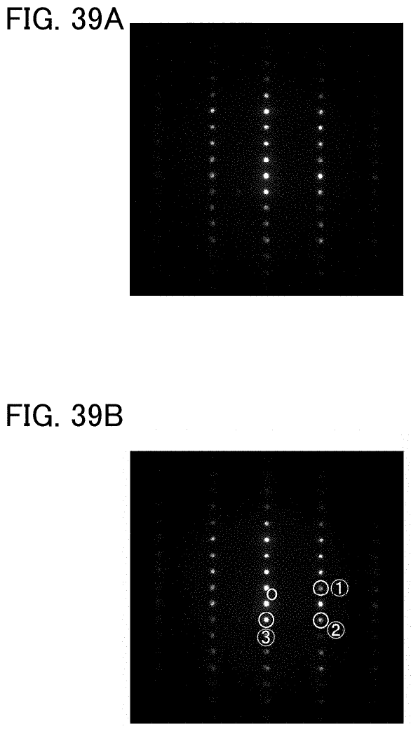

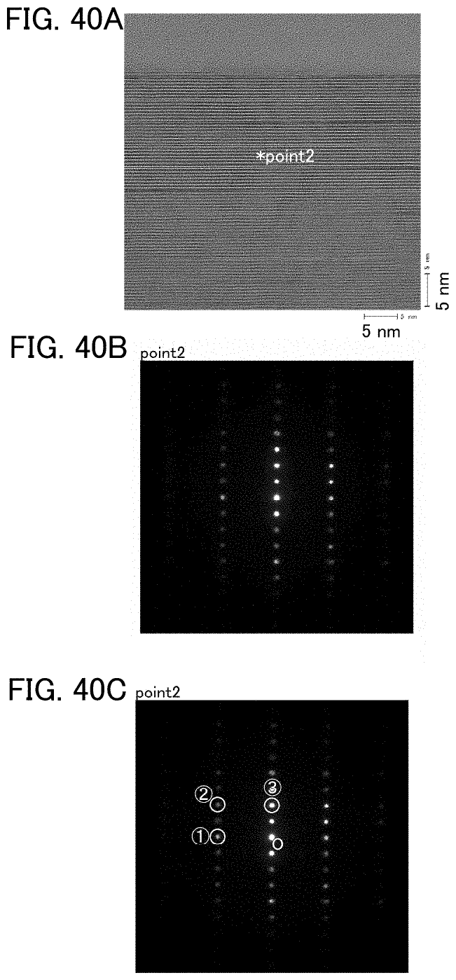

FIG. 39A shows a nanobeam electron diffraction pattern of the inner portion of the positive electrode active material. Some of bright spots in FIG. 39A are denoted as 1, 2, 3, and O as shown in FIG. 39B.

The measured values of the nanobeam electron diffraction pattern of the inner portion was as follows: 1 had d=0.142 nm, 2 had d=0.122 nm, and 3 had d=0.240 nm. The interplanar angles were ∠1O2=30°, ∠1O3=90°, and ∠2O3=59°.

It was confirmed also from these results that the inner portion of the positive electrode active material has the layered rock-salt crystal structure. The a-axis lattice constant A_{core} was 2.84 Å and the c-axis lattice constant C_{core} was 14.4 Å.

FIG. 40A is a cross-sectional TEM image of the positive electrode active material from the surface to a depth of approximately 40 nm. A nanobeam electron diffraction pattern of a point2 indicated by * in FIG. 40A is shown in FIG. 40B. Some of bright spots in FIG. 40B are denoted as 1, 2, 3, and O as shown in FIG. 40C.

The point2 is at a depth of approximately 13 nm from the surface and is a portion that has a high aluminum concentration in the inner portion of the positive electrode active material when analyzed by linear EDX line analysis described later. The measured values of the nanobeam electron diffraction pattern of this portion was as follows: 1 had d=0.143 nm, 2 had d=0.122 nm, and 3 had d=0.240 nm. The interplanar angles were ∠1O2=31°, ∠1O3=89°, and ∠2O3=59°.

It was confirmed also from these results that the inner portion of the positive electrode active material has the layered rock-salt crystal structure. The a-axis lattice constant was 2.86 Å and the c-axis lattice constant was 14.4 Å. These values are close to the values calculated from FIG. 39A and FIG. 39B, showing no large difference in lattice constants in the inner portion even in the region having a high aluminum concentration.

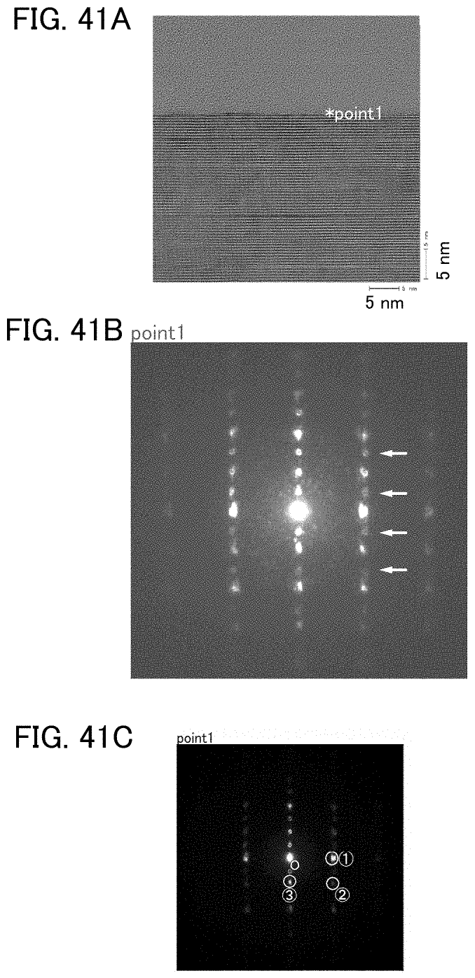

FIG. 41A is a cross-sectional TEM image of the positive electrode active material from the surface to a depth of approximately 30 nm. A nanobeam electron diffraction pattern of a point1 indicated by * in FIG. 41A is shown in FIG. 41B. Some of bright spots in FIG. 41B are denoted as 1, 2, 3, and O as shown in FIG. 41C.

The point 1 is in the outermost surface layer in the surface portion of the positive electrode active material. The measured values of the nanobeam electron diffraction pattern of the outermost surface layer was as follows: 1 had d=0.151 nm, 2 had d=0.128 nm, and 3 had d=0.266 nm. The interplanar angles were ∠1O2=31°, ∠1O3=90°, and ∠2O3=59°.

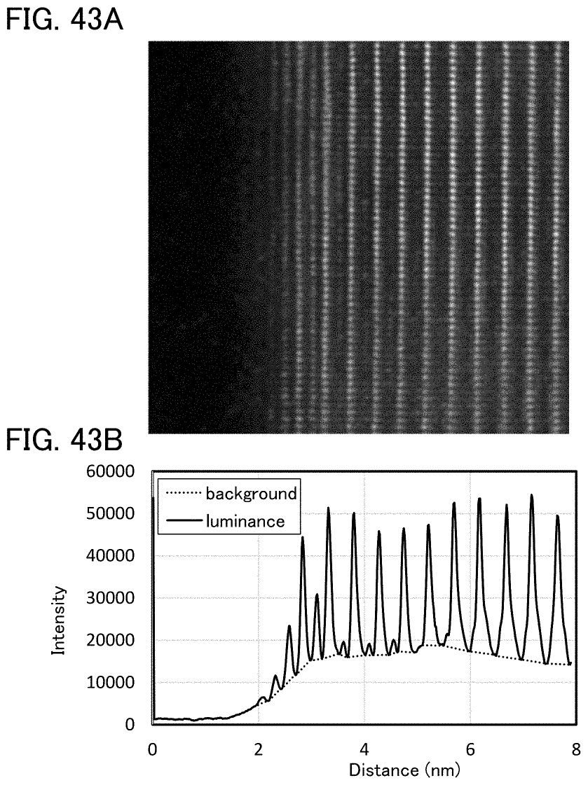

As shown in FIG. 41B, a bright spot with high luminance and a bright spot with low luminance as indicated by an arrow are alternately arranged in a nanobeam electron diffraction pattern of the outermost surface layer. When focusing on the arrangement of the bright spots including the spots with low luminance, the crystal structure identified from the diffraction pattern with such an arrangement is the layered rock-salt structure. By contrast, in the case of extracting only the bright spots with high luminance, the crystal structure can be judged to be close to the rock-salt structure. Thus, the outermost surface layer with the diffraction pattern has the feature of the layered rock-salt crystal structure and also partly has the feature of the rock-salt crystal structure. Note that such a difference in luminance in the diffraction pattern corresponds to a difference in luminance in a TEM image or the like shown in FIG. 43B or the like.

The a-axis lattice constant A_{surface} was 3.02 Å, and the c-axis lattice constant C_{surface} was 15.96 Å.

Table 2 shows the lattice constants of the inner portion and the outermost surface layer obtained as described above. For comparison, literature values are also noted.

TABLE 2

| Measurement region | Analysis method | a-axis (Å) | c-axis (Å) |
|---|---|---|---|
| Inner portion | Selected-area electron diffraction | 2.88 | 14.37 |
| Inner portion | Nanobeam electron diffraction | 2.84 (A_{core}) | 14.4 (C_{core}) |
| Inner portion (with Al | Nanobeam electron diffraction | 2.86 | 14.4 |
| distribution) | | | |
| Outermost surface layer | Nanobeam electron diffraction | 3.02 (A_{surface}) | 15.96 (C_{surface}) |
| Inner portion | Literature value | 2.816 | 14.06 |

As shown in Table 2, in the positive electrode active material of one embodiment of the present invention, the a-axis lattice constant A_{surface} of the outermost surface layer, which is part of the surface portion, calculated by nanobeam electron diffraction was 3.02 Å and larger than 2.84 Å which was the a-axis lattice constant A_{core} of the inner portion calculated by nanobeam electron diffraction. Similarly, the c-axis lattice constant C_{surface} of the outermost surface layer was 15.96 Å and larger than 14.4 Å which was the c-axis lattice constant C_{core} of the inner portion calculated by nanobeam electron diffraction.

Table 3 shows the differences between the lattice constants of the inner portion and the lattice constants of the outermost surface layer, which were obtained by nanobeam electron diffraction, and the rates of change in the lattice constants.

TABLE 3

| Crystal axis | Difference and rate of change in lattice constants (Å) | |
|---|---|---|
| a | Outermost surface layer A_{surface} | 3.02 |
| | Inner portion A_{core} | 2.84 |
| | Difference Δ_{A} | 0.18 |
| | Rate of change R_{A} (Δ_{A}/A_{core}) | 0.063 |
| c | Outermost surface layer C_{surface} | 15.96 |
| | Inner portion C_{core} | 14.4 |
| | Difference Δ_{C} | 1.56 |
| | Rate of change R_{C} (Δ_{C}/C_{core}) | 0.108 |

As shown in Table 3, the difference Δ_{C} between the c-axis lattice constant C_{surface} of the outermost surface layer and the c-axis lattice constant C_{core} of the inner portion of 1.56 Å was larger than the difference Δ_{A} between the a-axis lattice constant A_{surface} of the outermost surface layer and the a-axis lattice constant A_{core} of the inner portion of 0.18 Å.

The rate of change R_{A} between the a-axis lattice constant A_{surface} of the outermost surface layer and the a-axis lattice constant A_{core} of the inner portion was 0.063. Furthermore, the rate of change R_{C} between the c-axis lattice constant C_{surface} of the outermost surface layer and the c-axis lattice constant C_{core} of the inner portion was 0.108.

These revealed that the change in the lattice constant in the c-axis direction between the inner portion and the outermost surface layer was larger than that in the lattice constant in the a-axis direction therebetween.

### <Cross-Sectional STEM and Luminance>

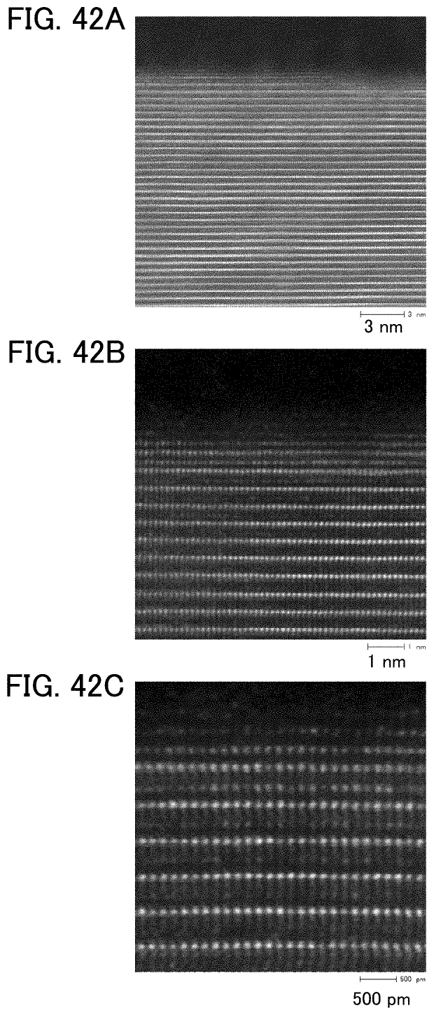

Cross-sectional STEM images of the positive electrode active material of Sample 1-1 formed as described above are shown in FIG. 42A to FIG. 42C. FIG. 42A is a cross-sectional STEM image of the positive electrode active material from the surface to a depth of approximately 15 nm. FIG. 42B is a cross-sectional STEM image of the positive electrode active material in a range with a depth of approximately 6 μm from the surface and a width of approximately 8 nm. FIG. 42C is a cross-sectional STEM image from the surface to a depth of approximately 3.5 nm. These are dark-field images.

As shown in FIG. 42A, transition metal M layers were observed as strong white bright-spot rows in the inner portion of the positive electrode active material, showing that the inner portion has the layered rock-salt crystal structure and high crystallinity. The surface of the positive electrode active material was substantially parallel to the (001) plane of the layered rock-salt crystal structure. Lithium layers existing between the transition metal M layers were only shown in slight gray, where bright spots were not observed. The same applied to oxygen that forms an octahedron having the transition metal M as a center. It was revealed that elements with small atomic numbers, such as lithium and oxygen, did not appear as clear bright spots in this cross-sectional STEM image.

In contrast, as shown in FIG. 42B and FIG. 42C, weak bright spots were observed in lithium sites in the outermost surface layer. Because the bright spots have higher luminance than lithium and oxygen, the bright spots are possibly owing to an element having a larger atomic number than lithium. Furthermore, since the element exists in the lithium sites, the element is possibly an element that can serve as cations, and thus the element is a metal element having a larger atomic number than lithium. In other words, the element is the transition metal M or a metal element among the added elements. Of the added elements in Sample 1-1, magnesium and aluminum are metals. Therefore, the weak bright spots existing in the lithium sites in the outermost surface layer are considered to be attributed to cobalt, magnesium, or aluminum.

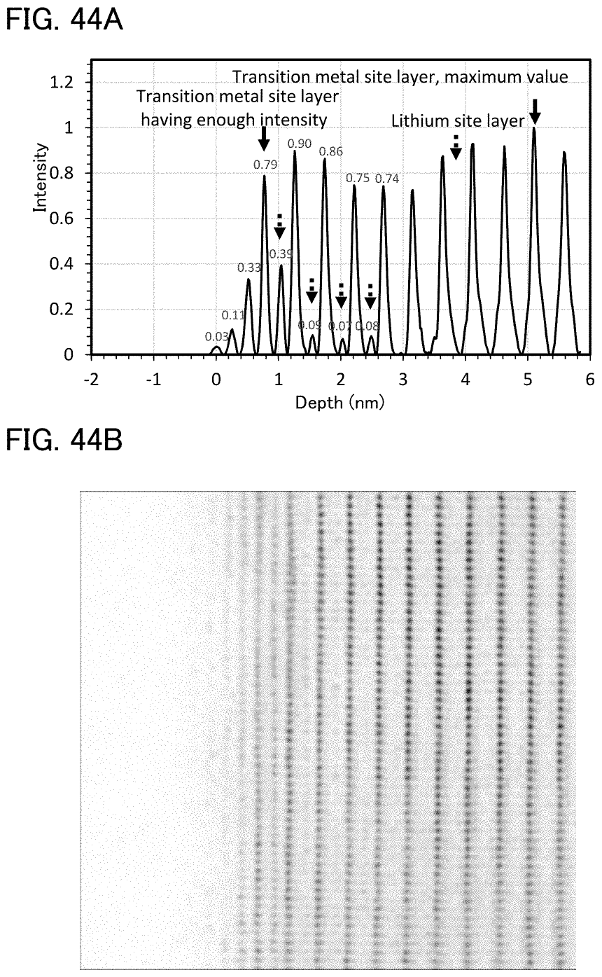

FIG. 43A to FIG. 44B show results of comparing the luminance of the transition metal M site layer and the lithium site layer using the cross-sectional STEM image in FIG. 42B. FIG. 43A is a diagram obtained by rotating FIG. 42B by 90°. The luminance in the image of FIG. 43A was estimated parallel to the transition metal M site layer. FIG. 43B is a graph showing the luminance in each pixel column.

Next, for easy comparison of the luminance of metal elements, the luminance derived from anions of oxygen atoms or the like was corrected as the background. Specifically, vertices of valleys between peaks were approximated with a straight line and corrected. The background is shown by a dotted line in FIG. 43B.

FIG. 44A is a graph after the correction. The horizontal axis represents the depth from the surface. The first luminance peak of a metal element was regarded as the surface. The vertical axis represents intensity and was normalized with the maximum number of white pixels to the depth of 6 nm regarded as 1. For enhanced visibility, FIG. 44B shows brightness inverted diagram of FIG. 43A.

As shown in FIG. 44A, the transition metal M site layers with high luminance existed in a region deeper than 3 nm from the surface. No peak existed in the lithium site layers between the transition metal M site layers.

At depths of less than approximately 0.8 nm from the surface, the transition metal M site layers and the lithium site layers both had low peaks and did not have enough intensities. This can be owing to an error derived from unevenness of the positive electrode active material. However, at depths of 0.8 or more from the surface, the transition metal M site layer had a luminance that was 0.7 or more of the maximum value and had enough intensity.

In a region of approximately 0.8 nm to 3 nm in depth from the surface, peaks lower than those of the transition metal M site layers were observed in the lithium site layers (dotted arrows in FIG. 44A). These low peaks possibly show the existence of the added metal element or the transition metal M in the lithium site layers. The peaks in the lithium site layers were greater than or equal to 3% and less than or equal to 60% of the maximum value, specifically greater than or equal to 4% and less than or equal to 50% of the maximum value, and more specifically greater than or equal to 6% and less than or equal to 40% of the maximum value. Compared with the intensity of the first transition metal site layer having enough intensity, the peaks were greater than or equal to 5% and less than or equal to 65%, specifically greater than or equal to 8% and less than or equal to 50%.

### <EDX Line Surface Analysis>

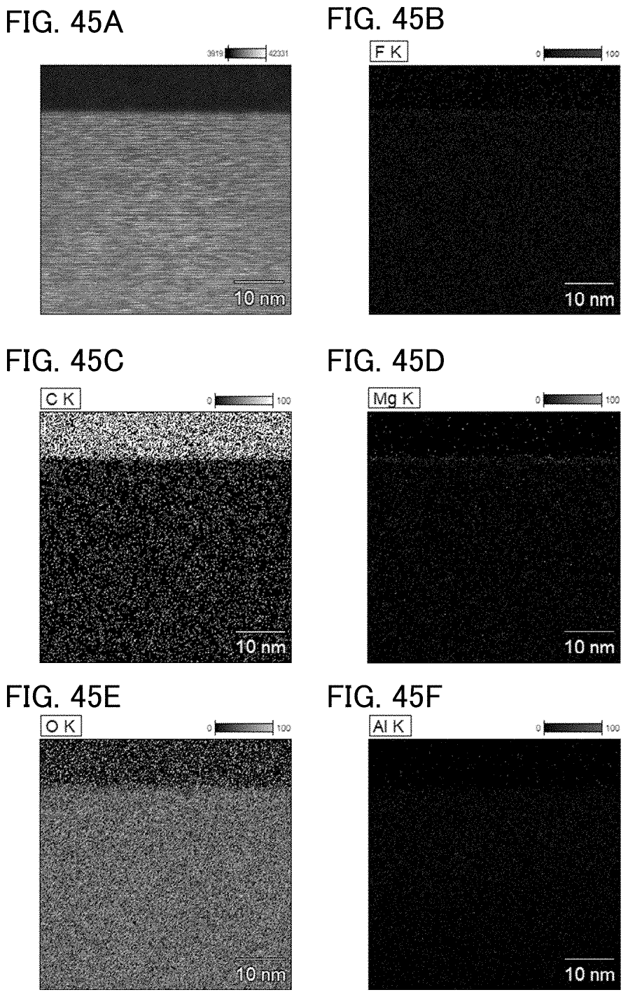

FIG. 45A to FIG. 47E show results of EDX surface analysis on the surface portion of the cross section of the positive electrode active material of Sample 1-1 formed as described above.

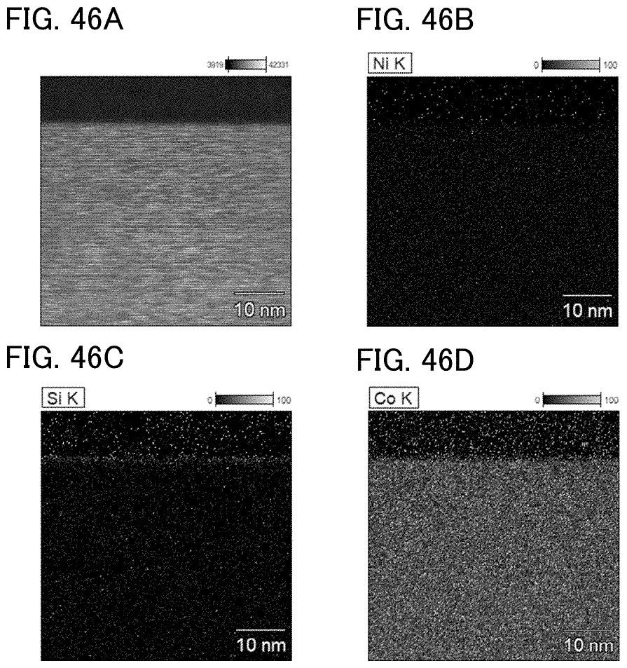

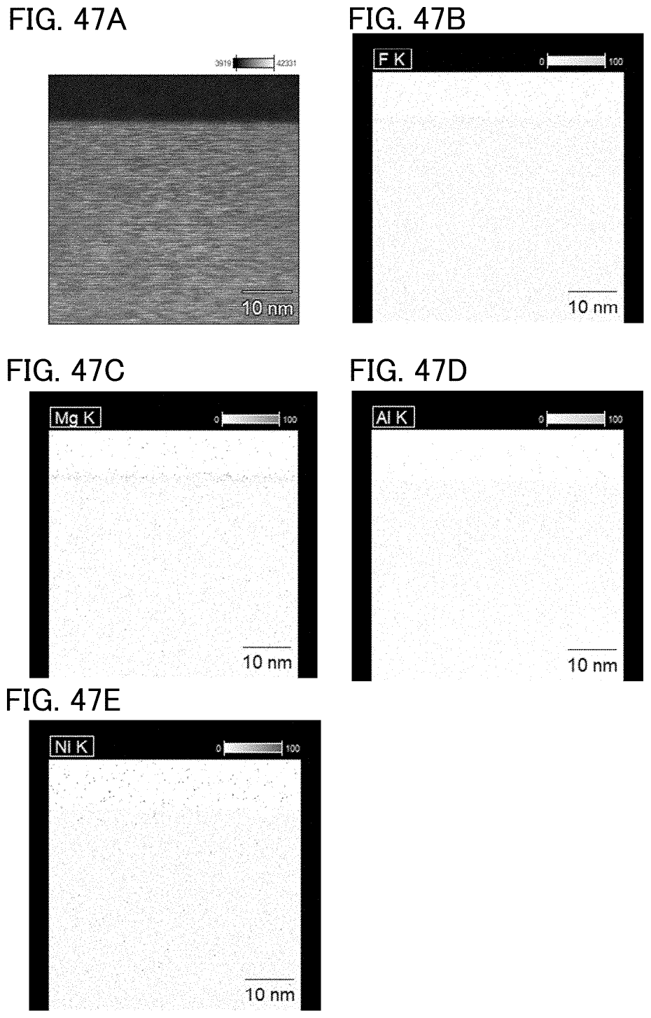

For easy comparison, FIG. 45A, FIG. 46A, and FIG. 47A show the same cross-sectional HAADF-STEM image of the surface and the inner portion of the positive electrode active material. FIG. 45B, FIG. 45C, FIG. 45D, FIG. 45E, and FIG. 45F are mapping images of fluorine, carbon, magnesium, oxygen, and aluminum, respectively, in the same portion as the HAADF-STEM image. FIG. 46B, FIG. 46C, and FIG. 46D are mapping images of nickel, silicon, and cobalt, respectively, in the same portion as the HAADF-STEM image. For enhanced visibility, brightness inverted mapping images for some of the elements are shown in FIG. 47B to FIG. 47E. FIG. 47B, FIG. 47C, FIG. 47D, and FIG. 47E are brightness inverted mapping images of fluorine, magnesium, aluminum, and nickel, respectively.

It was revealed from FIG. 45 to FIG. 47 that oxygen and cobalt were distributed in the entire positive electrode active material. In addition, the concentrations of magnesium and fluorine were high in the surface portion, especially in the outermost surface layer. Aluminum distributed broadly from the surface to approximately 30 nm was observed. Nickel possibly had a concentration lower than the background.

### <EDX Line Analysis>

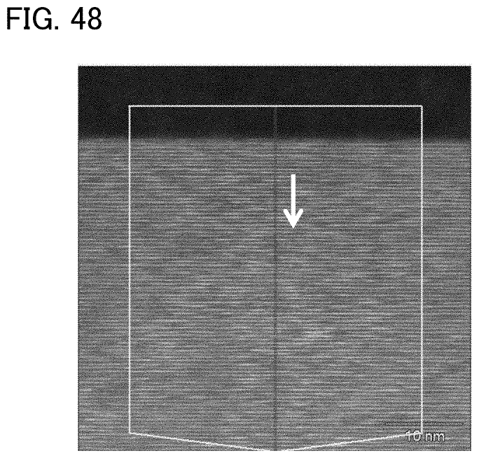

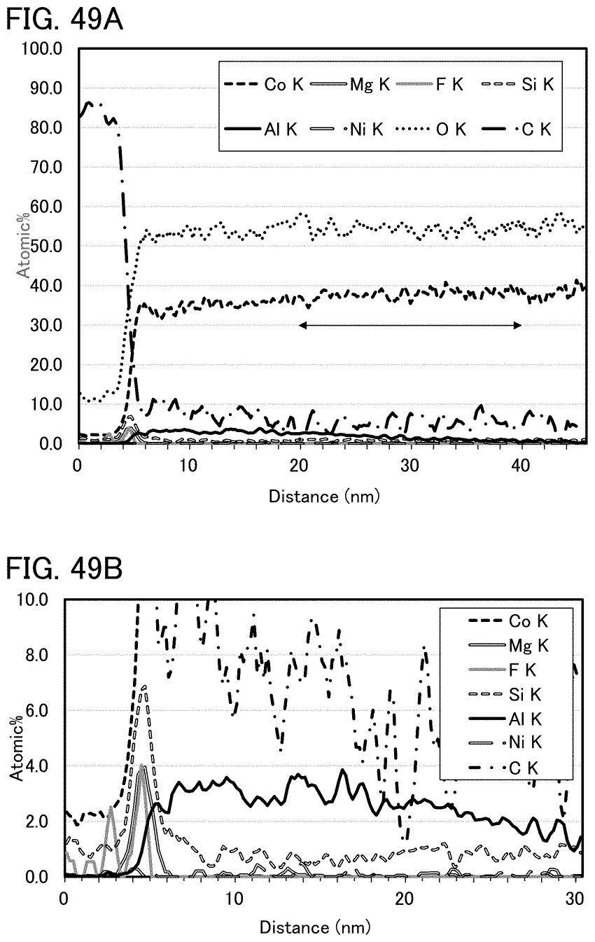

Next, EDX line analysis was performed on the surface portion of the positive electrode active material of Sample 1-1. FIG. 48 is a cross-sectional STEM image of the surface and the inner portion of the positive electrode active material. A region surrounded by a white line in FIG. 48 is a measurement region. The analysis was performed from the outside to the inner portion of the positive electrode active material 100 as indicated by a white arrow in the image. The results are shown in FIG. 49A and FIG. 49B. The horizontal axis represents distance from the measurement start point, and the vertical axis represents atomic %. The detection limit of the EDX line analysis is about 1 atomic % although depending on the element.

FIG. 49B is an enlarged graph of part of FIG. 49A. From FIG. 49A and FIG. 49B, it was confirmed that magnesium and fluorine existed in the outermost surface layer and had a concentration gradient in which the concentration increased from the inner portion toward the surface. The surface had the highest concentration and the sharpest peak. The silicon distribution had a similar tendency.

The magnesium concentration had a peak of 4.0 atomic % at the measurement point with a distance of 4.6 nm. The fluorine concentration had a peak of 4.0 atomic % at the measurement point with a distance of 4.4 nm.

The aluminum concentration had a peak positioned deeper than the peaks of magnesium and fluorine and was distributed broadly over a distance of 20 nm or more. The aluminum concentration had a peak of 3.9 atomic % at the measurement point with a distance of 16.1 nm.

Nickel was below the detection limit at all the measurement points, that is, lower than 1 atomic %.

Oxygen was detected also from the outside of the surface of the positive electrode active material. This is probably owing to the influence of a carbonic acid, a hydroxy group, or the like chemisorbed on the surface after the formation of the positive electrode active material or owing to the background.

Since a carbon protective film was formed when a cross-sectional STEM sample was formed with an FIB, a large amount of carbon was detected outside the surface of the positive electrode active material. Carbon inside the surface can be regarded as the background.

The surface was estimated from the amount of oxygen detected, in the following manner. First, a range from 20 to 40 nm indicated by an arrow in FIG. 49A was regarded as a region with the stable oxygen atomic %. The average oxygen atomic % in this region was 54.4%. A range at distances from 0 to 3 nm was regarded as the background or a region with the stable chemisorbed oxygen atomic %. This region had an average O_{background} of 11.8%. The result of subtracting O_{background} from Oₐᵥₑ, which is 42.6%, was regarded as a corrected average Oₐᵥₑ of oxygen. Thus, ½Oₐᵥₑ was 21.3%. The oxygen measurement point that was the closest thereto was the distance of 4.4 nm. Thus, the distance of 4.4 nm was regarded as the surface in this example and the like. This was the same measurement point as the peak of the fluorine concentration.

Note that the estimation of the surface from the amount of cobalt detected is performed as follows. A range with distances from 20 to 40 nm was regarded as a region with the stabilized cobalt atomic %. This region had an average Coₐᵥₑ of cobalt of 37.8 atomic %. Thus, ½Coₐᵥₑ was 18.9 atomic %. The cobalt measurement point that was the closest thereto was at a distance of 4.6 nm.

Thus, the estimation using either of oxygen and cobalt shows that the measurement point at almost the same distance is the surface. These results prove that the above-described methods are both proper for estimating the surface.

According to the EDX surface analysis and line analysis, it was confirmed that the positive electrode active material of one embodiment of the present invention is the positive electrode active material 100 that includes magnesium and fluorine in the surface portion, especially in the outermost surface layer and has a concentration gradient from the inner portion toward the surface. It was also confirmed that the peak of the aluminum concentration exists at a position deeper than those of the magnesium and fluorine concentrations.

When the surface was considered to exist at the distance of 4.4 nm, which is the value estimated from the amount of oxygen detected, the peak of the magnesium concentration was 0.2 nm deep. The peak of the fluorine concentration was 0 nm deep. The peak of the aluminum concentration was 11.7 nm deep.

### <Surface Unevenness of Active Material>

Next, regarding surface smoothness of the positive electrode active materials formed as described above, surface unevenness of Sample 1-1 and Sample 2 was measured and evaluated by the following method.

First, SEM images of Sample 1-1 and Sample 2 were obtained. At this time, SEM measurement conditions for Sample 1-1 and Sample 2 were the same. Examples of the measurement conditions include acceleration voltage and a magnification. Conductive coating was performed on Sample 1-1 and Sample 2 as pretreatment for the observation in this example. Specifically, platinum sputtering was performed for 20 seconds. An SU8030 scanning electron microscope produced by Hitachi High-Tech Corporation was used for the observation. The measurement conditions were the acceleration voltage of 5 kV and the magnification of 5000 times. Other measurement conditions are as follows: the working distance was 5.0 mm, the emission current was 9 to 10.5 μA, the extraction voltage was 5.8 V, measurement was performed under the same conditions both in an SEU mode (Upper secondary-electron detector) and an ABC mode (Auto Brightness Contrast Control), and observation was performed in an autofocus mode.

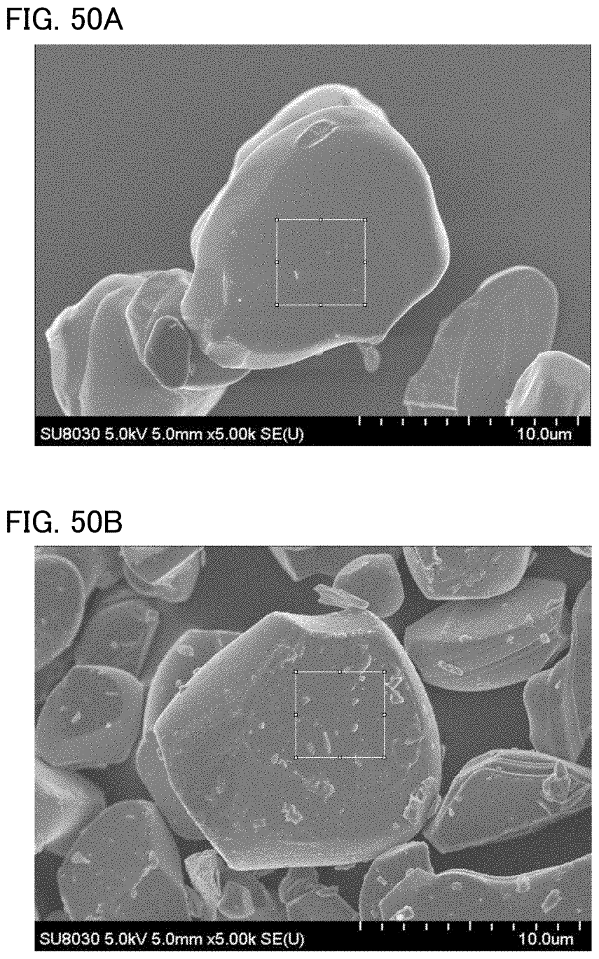

FIG. 50A and FIG. 50B are SEM images of Sample 1-1 and Sample 2, respectively. According to the observation, Sample 1-1, which was heated after the addition of the added elements, had a smoother surface than Sample 2. In each of the images, a region targeted for image analysis performed next was indicated by a square. The area of the target region was 4 μm×4 μm in all the samples. The target region was set horizontal as an SEM observation surface.

Here, the present inventors gave attention to the fact that the taken images of the surface states of the positive electrode active materials in FIG. 50A and FIG. 50B showed a variation in luminance. The present inventors considered the feasibility of quantification of information on surface unevenness by image analysis utilizing the variation in luminance.

Thus, in this example, the images shown in FIG. 50A and FIG. 50B were analyzed using image processing software “ImageJ” to quantify the surface smoothness of the positive electrode active materials. Note that “ImageJ” is merely an example and the image processing software for this analysis is not limited to “ImageJ.”

First, the images shown in FIG. 50A and FIG. 50B were converted into 8-bit images (which are referred to as grayscale images) with the use of “ImageJ.” The grayscale images, in which one pixel is expressed with 8 bits, include luminance (brightness information). For example, in an 8-bit grayscale image, luminance can be represented by 2⁸=256 gradation levels. A dark portion has a low gradation level and a bright portion has a high gradation level. The variation in luminance was quantified in relation to the number of gradation levels. The obtained value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the above-described manner, 8-bit grayscale images were obtained from the images of Sample 1-1 and Sample 2, and grayscale values and luminance histograms were also obtained.

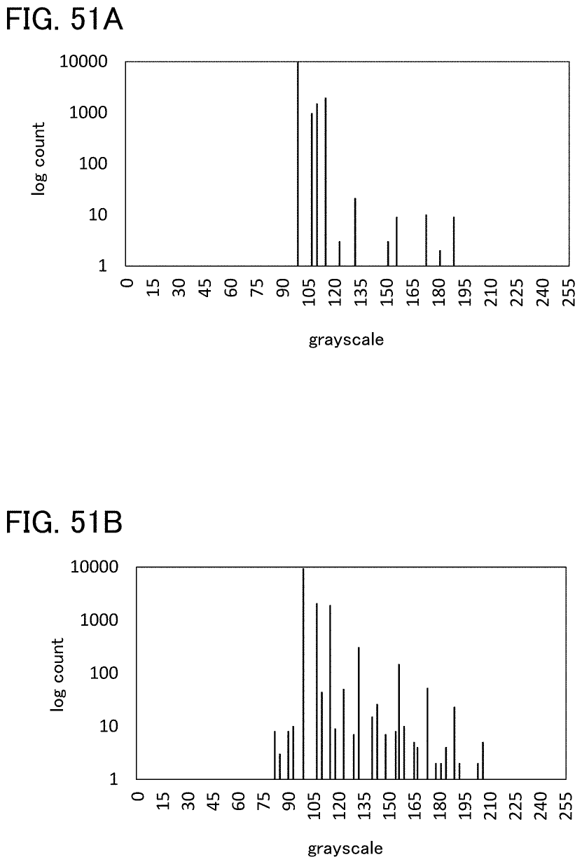

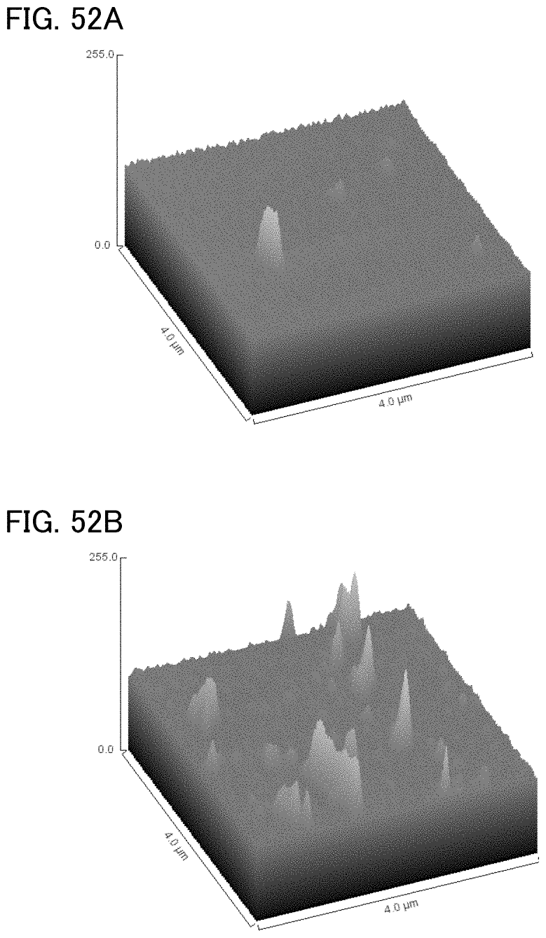

FIG. 51A and FIG. 51B show grayscale values of Sample 1-1 and Sample 2, respectively. The x-axis represents the grayscale value (grayscale), and the y-axis represents the count number which is the value corresponding to the existence ratio of the grayscale value represented by the x-axis. The count number is shown on a logarithmic scale (log count). FIG. 52A and FIG. 52B show luminance histograms of Sample 1-1 and Sample 2.

According to the graphs of FIG. 51A and FIG. 51B, a range including the maximum value and the minimum value of the grayscale value can be noticed. Sample 1-1 had the maximum value and the minimum value in a range greater than or equal to 96 and less than or equal to 206, and Sample 2 had the maximum value and the minimum value in a range greater than or equal to 82 and less than or equal to 206. Table 4 below lists the minimum value, the maximum value, the difference between the maximum value and the minimum value (the maximum value−the minimum value), and the standard deviation.

TABLE 4

| | Minimum | Maximum | Maximum value − | Standard |
|---|---|---|---|---|
| | value | value | minimum value | deviation |
| Sample 1-1 | 96 | 206 | 110 | 7.218 |
| Sample 2 | 82 | 206 | 124 | 11.514 |

As shown in Table 4, Sample 1-1 with the smooth surface had a difference between the maximum value and the minimum value of 120 or less. In addition, the standard deviation was also small and the variation was smaller.

Furthermore, eight samples formed under the same conditions as each of Sample 1-1 and Sample 2 were selected and subjected to image analysis in a manner similar to that in this example. The analysis found that the eight samples also had a tendency similar to the above.

Such image analysis enabled quantitative determination of smoothness. It was found that the positive electrode active material heated after the addition of magnesium, fluorine, nickel, and aluminum had a smooth surface with little surface unevenness.

### <Electrode Density>

Next, positive electrodes using Sample 1-1 were formed with various conductive materials under various pressing conditions, and the electrode density was evaluated.

First, the positive electrode active material, the conductive material, and PVDF were mixed to form a slurry, and the slurry was applied onto a current collector of aluminum. As the conductive material, only AB, a mixture of AB and graphene (AB:graphene=8:2 in weight ratio), or a mixture of AB and VGCF (registered trademark) (produced by SHOWA DENKO K.K.) (AB:VGCF=8:2 in weight ratio) was used. As a solvent of the slurry, NMP was used.

After drying, the positive electrode was pressed weakly zero to five times and pressed hard zero or one time. Weak pressing was performed at 210 kN/m, and hard pressing was performed at 1467 klN/m. A calender roll was used for both types of pressing.

Table 5 shows the compounding ratio, the pressing condition, the conductive material, and the electrode density (g/cc).

TABLE 5

| Compounding | Pressing | | AB & | AB & |
|---|---|---|---|---|
| ratio | condition | AB | graphene | VGCF |
| LCO 95 wt % | Unpressed | 2.27 | 2.28 | 2.28 |
| Conductive material | Weak 1 time | 3.12 | 3.38 | 3.19 |
| 3 wt % | Weak 3 times | 3.32 | 3.54 | 3.4 |
| Binder 2 wt % | Weak 5 times | 3.34 | 3.55 | 3.46 |
| | Weak + Hard | 3.61 | 3.83 | 3.67 |
| LCO 97 wt % | Unpressed | 2.47 | 2.34 | 2.4 |
| Conductive material | Weak 1 time | 3.33 | 3.49 | 3.5 |
| 1 wt % | Weak 2 times | 3.62 | 3.72 | 3.69 |
| Binder 2 wt % | Weak 3 times | 3.55 | 3.74 | 3.75 |
| | Weak 5 times | 3.62 | 3.8 | 3.7 |
| | Weak + Hard | 4 | 4.11 | 4.02 |
| LCO 97.5 wt % | Unpressed | 2.47 | 2.45 | 2.44 |
| Conductive material | Weak 1 time | 3.32 | 3.5 | 3.44 |
| 0.5 wt % | Weak 3 times | 3.63 | 3.79 | 3.67 |
| Binder 2 wt % | Weak 5 times | 3.68 | 3.83 | 3.71 |
| | Weak + Hard | 4.02 | 3.99 | 4.08 |

As shown in Table 5, it was revealed that the electrode density after pressing tended to be increased in the case of using the mixture of AB and graphene as the conductive material, rather than the case of using only AB. Under the conditions where the mixture of AB and graphene was used, the conductive material was contained at 1 wt %, and weak pressing was performed two times or more, the electrode density was 3.72 g/cc or higher.

### <XRD>

Secondary batteries including lithium counter electrodes were formed using Sample 1-7 and Sample 2 formed as described above, and the crystal structure after charging was analyzed by XRD.

First, a slurry was formed by mixing the positive electrode active material, AB, and PVDF at the active material:AB:PVDF=95:3:2 (weight ratio), and the slurry was applied onto a current collector of aluminum. As a solvent of the slurry, NMP was used.

Pressurization was not performed in the formation process of the positive electrodes.

Using the formed positive electrodes, CR2032 type coin battery cells (a diameter of 20 mm, a height of 3.2 mm) were formed.

A lithium metal was used for a counter electrode.

As an electrolyte contained in an electrolyte solution, 1 mol/L of lithium hexafluorophosphate (LiPF₆) was used. As the electrolyte solution, a solution in which ethylene carbonate (EC) and diethyl carbonate (DEC) were mixed at EC:DEC=3:7 (volume ratio) was used.

As a separator, 25-μm-thick polypropylene was used.

A positive electrode can and a negative electrode can that were formed using stainless steel (SUS) were used.

The structure after the initial charging of the secondary batteries formed in the above-described manner was measured. The charge voltage was set at 4.65 V or 4.7 V. The charge temperature was set at 25° C. or 45° C. As a charging method, CC/CV (0.5 C, each voltage, 0.05 C cut) was employed. Note that 1 C was 200 mA/g in the measurement of the crystal structures after charging in this example and the like. Table 6 shows charge capacity.

TABLE 6

| | Voltage | Temperature | Charge capacity |
|---|---|---|---|
| | (V) | (° C.) | (mAh/g) |
| Sample 1-7 | 4.65 | 25 | 217 |
| | | 45 | 222 |
| | 4.7 | 25 | 236 |
| | | 45 | 250 |
| Sample 2 | 4.7 | 25 | 251 |
| | | 45 | 259 |

Then, the secondary batteries in the charged state were disassembled in a glove box with an argon atmosphere to take out the positive electrodes, and the positive electrodes were washed with DMC (dimethyl carbonate) to remove the electrolyte solution. The positive electrode taken out was attached to a flat substrate with a double-sided adhesive tape and sealed in a dedicated cell in an argon atmosphere. The position of the positive electrode active material layer was adjusted to the measurement plane required by the apparatus. The XRD measurement was performed at room temperature irrespective of the charge temperature.

The apparatus and conditions of the XRD measurement were as follows.

XRD apparatus: D8 ADVANCE produced by Bruker AXS
X-ray source: CuKα radiation

### Output: 40 KV, 40 mA

Slit system: Div. Slit, 0.5°

### Detector: LynxEye

Scanning method: 2θ/θ continuous scanning
Measurement range (2θ): from 15° (degrees) to 75°
Step width (2θ): 0.01°
Counting time: 1 second/step
Rotation of sample stage: 15 rpm

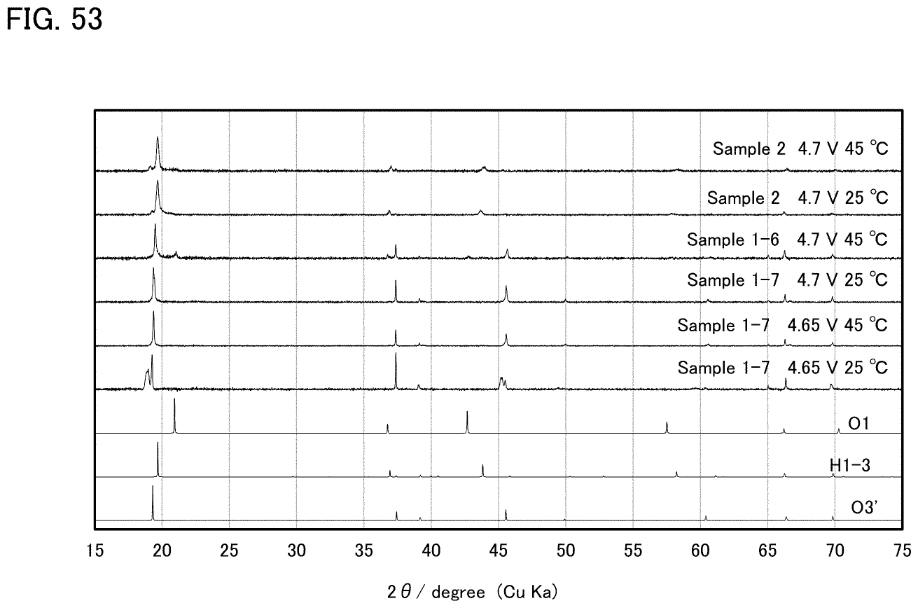

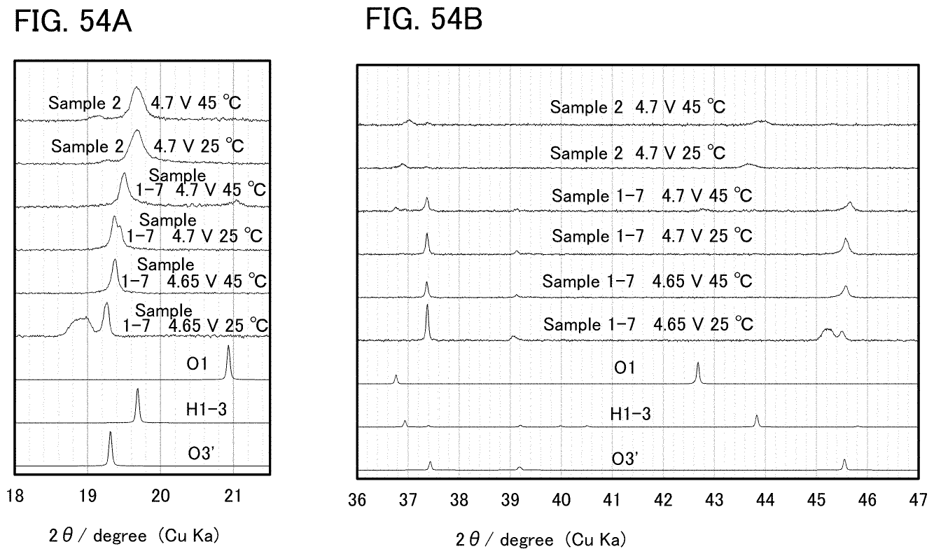

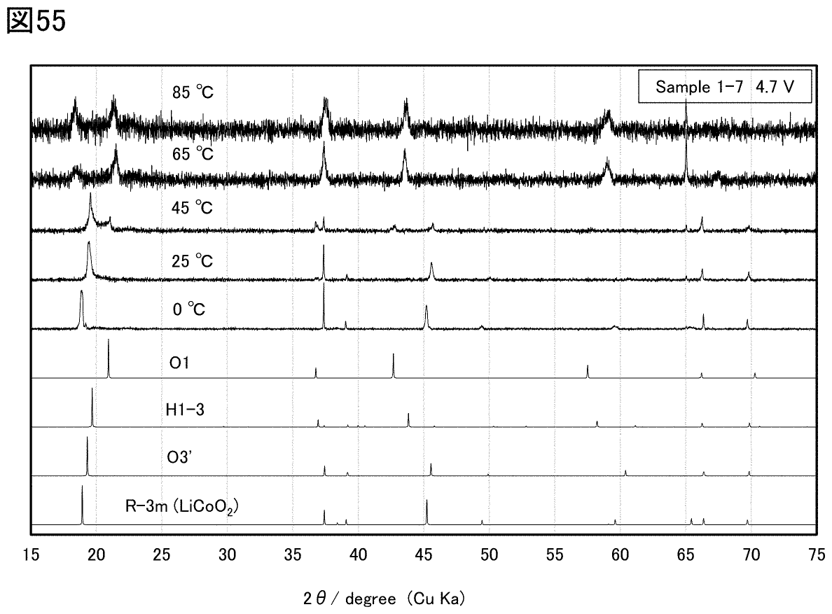

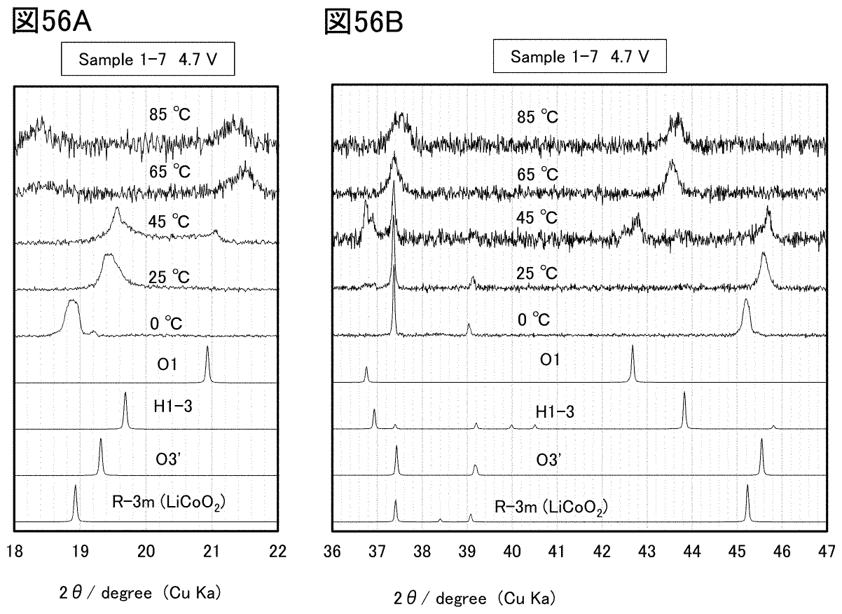

FIG. 53 shows XRD patterns of Sample 1-7 and Sample 2 after charging, at each voltage and each temperature. The enlarged pattern at 18°≤2θ≤21.5° is shown in FIG. 54A, and an enlarged pattern at 36°≤2θ=47° is shown in FIG. 54B. XRD patterns of O1, H1-3, and O3′ are also shown as references.

From FIG. 53 to FIG. 54B, it was revealed that Sample 1-7 had the O3′ type crystal structure under any of the conditions of 4.65 V 25° C., 4.65 V 45° C., 4.7 V 25° C., 4.7 C 45° C. At 4.7 C and 45° C., Sample 1-7 also had the H1-3 type crystal structure and the 01 type crystal structure in addition to the O3′ type structure. Under the conditions of 4.65 V 45° C., the O3′ type crystallinity was the highest.

Sample 2 was found to mainly have the H1-3 type crystal structure under both conditions of 4.7 V 25° C. and 4.7 C 45° C. A peak derived from the O3′ type structure was hardly observed.

Next, the structure of Sample 1-7 after the second charging at charge temperatures of 0° C., 25° C., 45° C., 65° C., and 85° C. was measured. As a charging method, CC/CV (0.5 C, 4.7 V, 0.05 C cut) was employed. As a discharging method, CC (0.5 C, 2.5 V cut) was employed. Table 7 shows charge and discharge capacity.

TABLE 7

| | | Temper- | Capacity (mAh/g) | | |
|---|---|---|---|---|---|
| | Voltage | ature | 1st | 1st | 2nd |
| | (V) | (° C.) | charging | discharging | charging |
| Sample 1-7 | 4.7 | 0 | 212 | 170 | 171 |
| | | 25 | 229 | 217 | 231 |
| | | 45 | 242 | 233 | 247 |
| | | 65 | 270 | 244 | 246 |
| | | 85 | 276 | 229 | 262 |

Then, in a manner similar to the above, the positive electrodes were taken out from the secondary batteries and subjected to XRD measurement.

FIG. 55 shows XRD patterns after charging, at each temperature. The enlarged pattern at 18°≤2θ≤21.5° is shown in FIG. 56A, and an enlarged pattern at 36°≤2θ=47° is shown in FIG. 56B. XRD patterns of O1, H1-3, O3′, and R-3m (LiCoO₂) before charging are also shown as references.

As in the initial charging, it was revealed that Sample 1-7 after the second charging still had the O3′ type crystal structure under the conditions of 4.7 V 25° C. and 4.7 V 45° C. At 4.7 C and 45° C., Sample 1-7 also had the 01 type crystal structure in addition to the O3′ type structure. Under the conditions of 4.7 V 65° C. and 4.7 V 85° C., the crystallinity was low and it was estimated that Sample 1-7 had a crystal structure different from O1, H1-3, and O3′.

Next, the structure of Sample 1-7 after the initial charging and discharging, the 30th charging and discharging, and the 50th charging and discharging at a charge temperature of 25° C. was measured. As a charging method, CC/CV (0.5 C, 4.7 V, 0.05 C cut) was employed. As a discharging method, CC (0.5 C, 2.5 V cut) was employed. Table 8 shows charge and discharge capacity.

TABLE 8

| | | Capacity (mAh/g) | | | | | |
|---|---|---|---|---|---|---|---|
| | | 1st charging | 1st discharging | 30th charging | 30th discharging | 50th charging | 50th discharging |
| Sample 1-7 | 1st charging | 230.5 | | | | | |
| 4.7 V | 1st discharging | 232.9 | 223.2 | | | | |
| 25° C. | 30th charging | 229.6 | 220.0 | 203.7 | | | |
| | 30th discharging | 234.0 | 223.8 | 200.6 | 195.6 | | |
| | 50th charging | 232.8 | 222.6 | 200.8 | 195.7 | 170.6 | |
| | 50th discharging | 231.3 | 221.2 | 200.8 | 196.0 | 170.2 | 164.5 |

Then, in a manner similar to the above, the positive electrodes were taken out from the secondary batteries and subjected to XRD measurement.

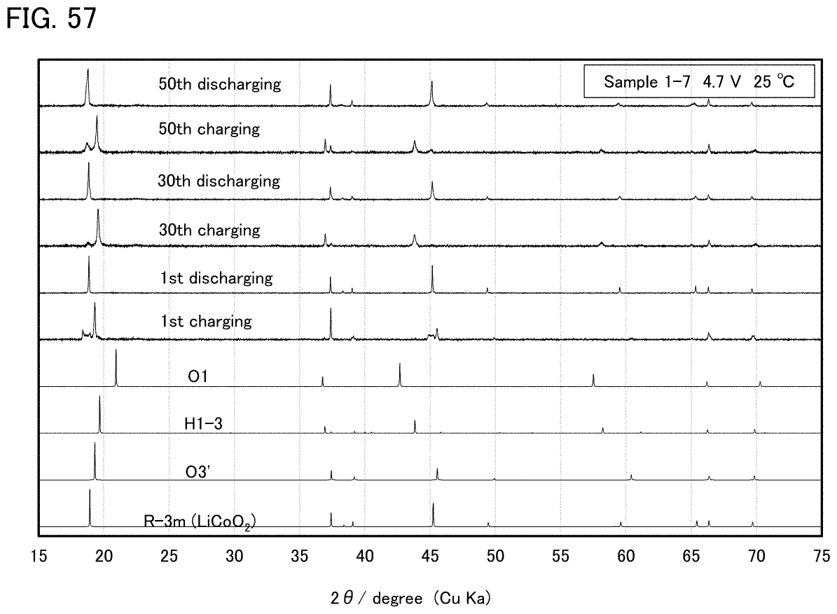

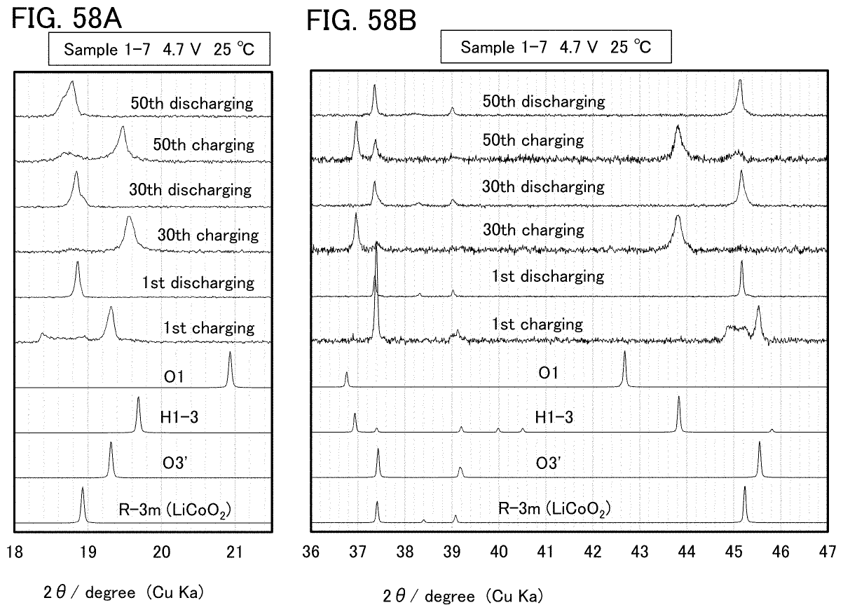

FIG. 57 shows XRD patterns after each charging and discharging. The enlarged pattern at 18°≤2θ≤21.5° is shown in FIG. 58A, and an enlarged pattern at 36°≤2θ=47° is shown in FIG. 58B. XRD patterns of O1, H1-3, O3′, and R-3m (LiCoO₂) before charging are also shown as references.

After each of the initial, 30th, and 50th discharging, the R-3m (LiCoO₂) crystal structure was observed. There was a tendency for the peak at the time of charging to become broader and for the crystallinity to become lower in accordance with the increase in charge and discharge cycles.

It was also estimated that Sample 1-7 had the O3′ type crystal structure at the time of the initial charging but had the H1-3 type crystal structure at the time of the 30th and 50th charging. In addition, the existence of the R-3m (LiCoO₂) crystal structure at the time of the 50th charging was estimated. This is probably because deterioration of the surface portion of the positive electrode active material proceeds and part of lithium in the inner portion remains inside the positive electrode active material even when charging is performed. On the other hand, the discharge capacity exceeding 160 mAh/g was maintained after 50 cycles, and it can be said that the positive electrode active material is sufficiently resistant to deterioration.

Next, the structure of Sample 1-7 after the initial charging and discharging, the 10th charging and discharging, and the 50th charging and discharging at a charge and discharge temperature of 45° C. was measured. As a charging method, CC/CV (0.5 C, 4.7 V, 0.05 C cut) was employed. As a discharging method, CC (0.5 C, 2.5 V cut) was employed. Table 9 shows charge and discharge capacity.

TABLE 9

| | | Capacity (mAh/g) | | | | | |
|---|---|---|---|---|---|---|---|
| XRD pattern | | 1st charging | 1st discharging | 30th charging | 30th discharging | 50th charging | 50th discharging |
| Sample 1-7 | 1st charging | 244.2 | | | | | |
| 4.7 V | 1st discharging | 244.7 | 235.8 | | | | |
| 45° C. | 10th charging | 250.8 | 234.5 | 196.5 | | | |
| | 10th discharging | 244.9 | 236.1 | 188.8 | 177.4 | | |
| | 50th charging | 256.9 | 235.0 | 188.1 | 176.9 | 70.3 | |
| | 50th discharging | 244.0 | 235.0 | 186.4 | 175.4 | 71.7 | 69.6 |

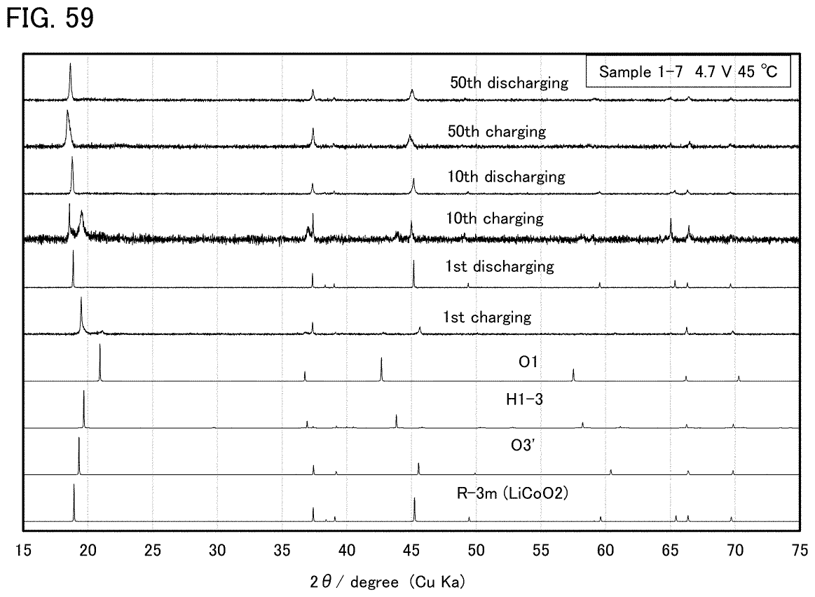

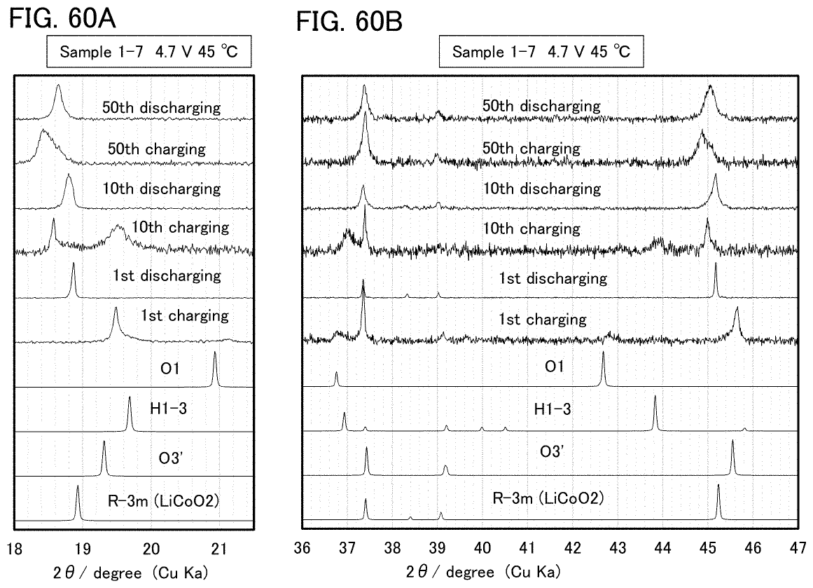

FIG. 59 shows XRD patterns after each charging and discharging. The enlarged pattern at 18°≤2θ≤21.5° is shown in FIG. 60A, and an enlarged pattern at 36°≤2θ=47° is shown in FIG. 60B. XRD patterns of O1, H1-3, O3′, and R-3m (LiCoO₂) before charging are also shown as references.

It was confirmed that Sample 1-7 had the O3′ crystal structure at the time of the initial charging and had the R-3m (LiCoO₂) crystal structure at the time of the initial discharging. After that, the deterioration proceeded faster than the charge and discharge cycles at 25° C., and there was only a small change between the crystal structure at the time of the 50th charging and that at the time of the 50th discharging, from which a decrease in insertion and extraction reactions of lithium was estimated.

### <Charge and Discharge Cycle Performance of Half Cell>

Secondary batteries including lithium counter electrodes were formed using the positive electrode active materials of Sample 1-1 and Sample 2 formed as described above, and the charge and discharge cycle performance was evaluated.

First, a slurry was formed by mixing the positive electrode active material, AB, and PVDF at the active material:AB:PVDF=95:3:2 (weight ratio), and the slurry was applied onto a current collector of aluminum. As a solvent of the slurry, NMP was used.

After the slurry was applied onto the current collector, the solvent was volatilized. Then, pressure was applied at 210 kN/m, and then pressure was applied at 1467 kN/m. Through the above process, the positive electrode was obtained. The carried amount of the positive electrode was approximately 7 mg/cm². The density was 3.8 g/cc or higher.

Using the formed positive electrodes, CR2032 type coin battery cells (a diameter of 20 mm, a height of 3.2 mm) were formed.

A lithium metal was used for a counter electrode.

As an electrolyte contained in an electrolyte solution, 1 mol/L lithium hexafluorophosphate (LiPF₆) was used. As the electrolyte solution, a solution which is obtained by adding vinylene carbonate (VC) at 2 wt % to a mixture of ethylene carbonate (EC) and diethyl carbonate (DEC) at EC:DEC=3:7 (volume ratio) was used.

As a separator, 25-μm-thick polypropylene was used.

A positive electrode can and a negative electrode can that were formed using stainless steel (SUS) were used.

In the evaluation of charge and discharge cycle performance, the charge voltage was set at 4.4 V, 4.5 V, or 4.6 V. The measurement temperature was set at 25° C., 45° C., 50° C., 55° C., 60° C., 65° C., or 85° C. CC/CV charging (0.5 C, each voltage, 0.05 C cut) and CC discharging (0.5 C, 2.5 V cut) were performed, and a 10-minute break was taken before the next charging. Note that 1 C was 200 mA/g in this example and the like.

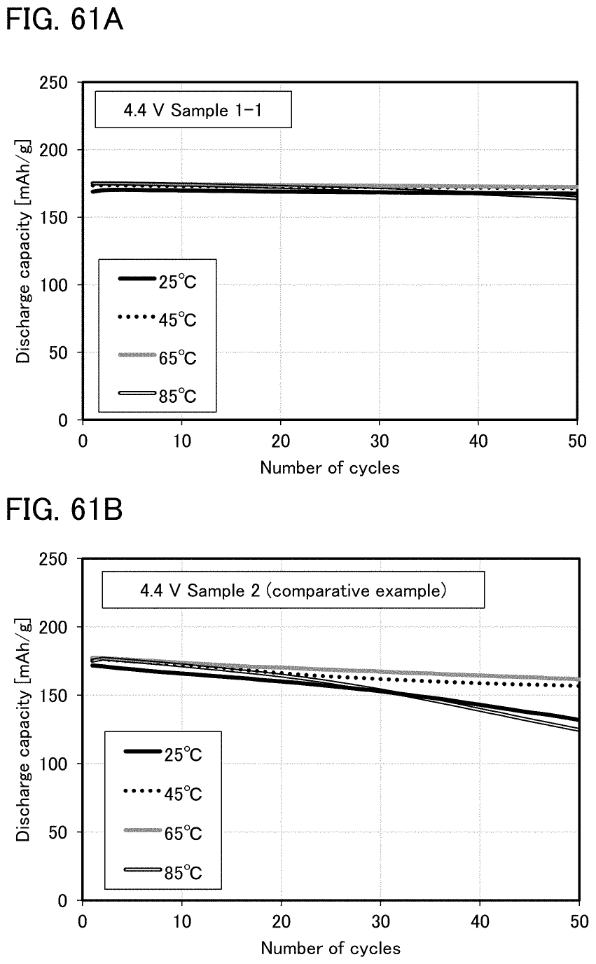

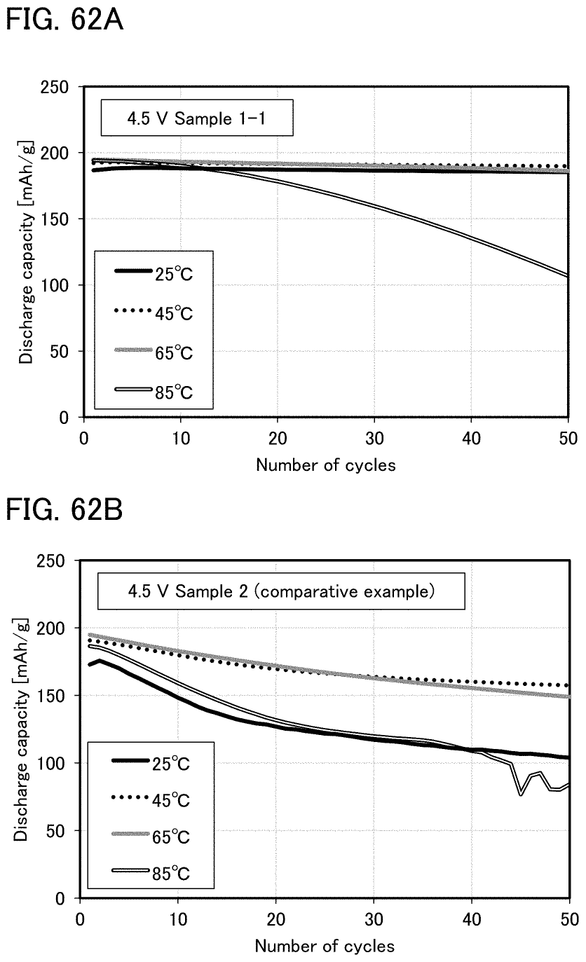

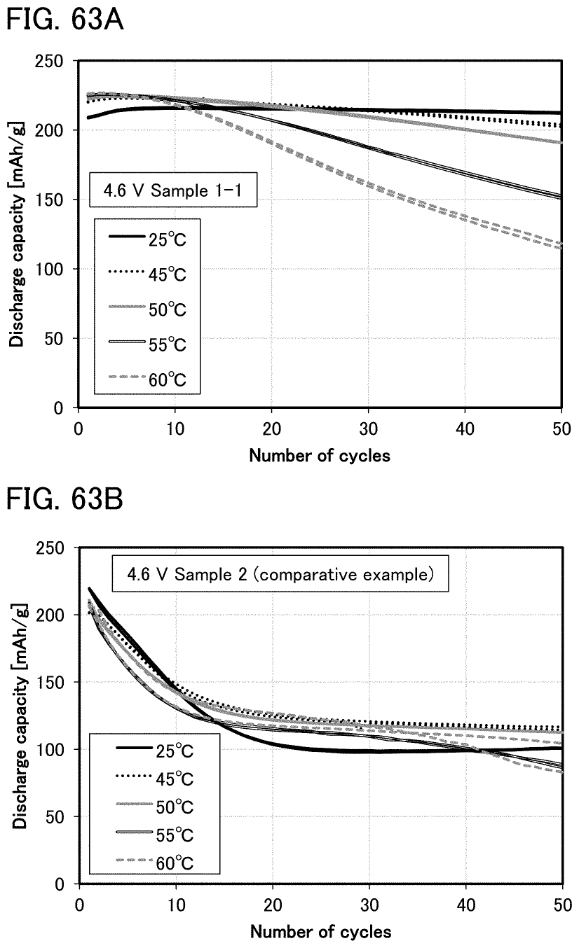

FIG. 61A and FIG. 61B show charge and discharge cycle performance of Sample 1-1 at a charge voltage of 4.4 V and Sample 2 (comparative example), respectively. FIG. 62A and FIG. 62B show charge and discharge cycle performance of Sample 1-1 at a charge voltage of 4.5 V and Sample 2 (comparative example), respectively. FIG. 63A and FIG. 63B show charge and discharge cycle performance of Sample 1-1 at a charge voltage of 4.6 V and Sample 2 (comparative example), respectively.

At the charge voltage of 4.4 V, Sample 1-1 showed extremely favorable cycle performance at temperatures from 25° C. to 85° C. Sample 2 (comparative example) had relatively favorable charge and discharge cycle performance but was inferior to Sample 1-1.

At the charge voltage of 4.5 V, Sample 1-1 showed extremely favorable charge and discharge cycle performance at temperatures from 25° C. to 65° C. Since the charge voltage was increased, the discharge capacity was also increased. In contrast, the discharge capacity of Sample 2 (comparative example) was decreased at every temperature by repetitive charge and discharge cycles.

At the charge voltage of 4.6 V, Sample 2 (comparative example) showed a rapid decrease of discharge capacity before the 20th cycles at all the temperatures from 25° C. to 60° C. In contrast, Sample 1-1 had performance superior to that of Sample 2 (comparative example) at all the temperatures from 25° C. to 60° C. Extremely favorable charge and discharge cycle performance was exhibited especially at the temperatures from 25° C. to 55° C.

Next, second batteries including lithium counter electrodes were formed similarly using Sample 1-3, Sample 1-5, Sample 1-7, and Sample 3 formed as described above, and the charge and discharge cycle performance was evaluated.

The charge voltage was set at 4.65 V or 4.7 V. The measurement temperature was set at 25° C. or 45° C. CC/CV charging (0.5 C, each voltage, 0.05 C cut) and CC discharging (0.5 C, 2.5 V cut for only Sample 1-5, 3 hours cut for the other samples) were performed, and a 10-minute break was taken before the next charging.

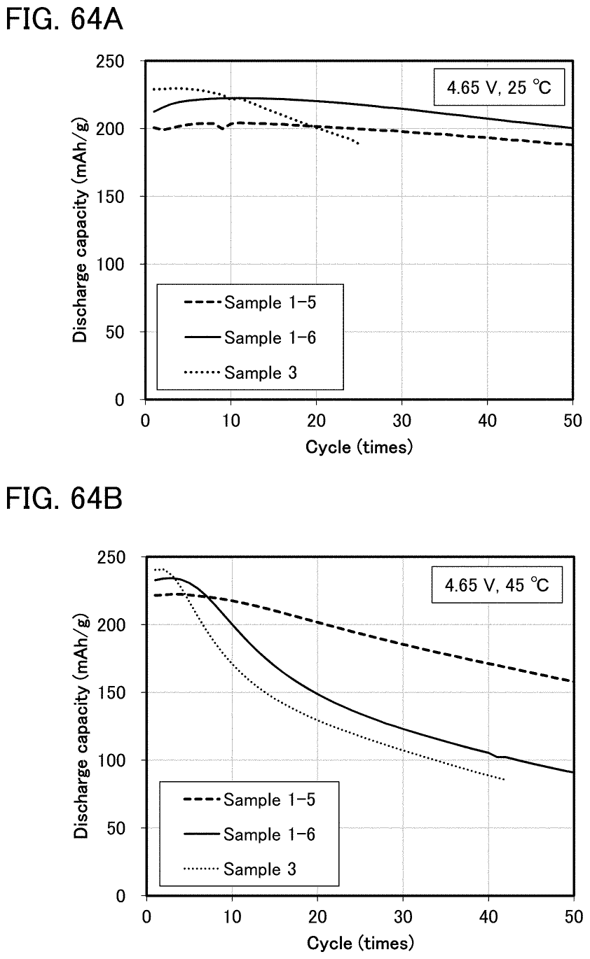

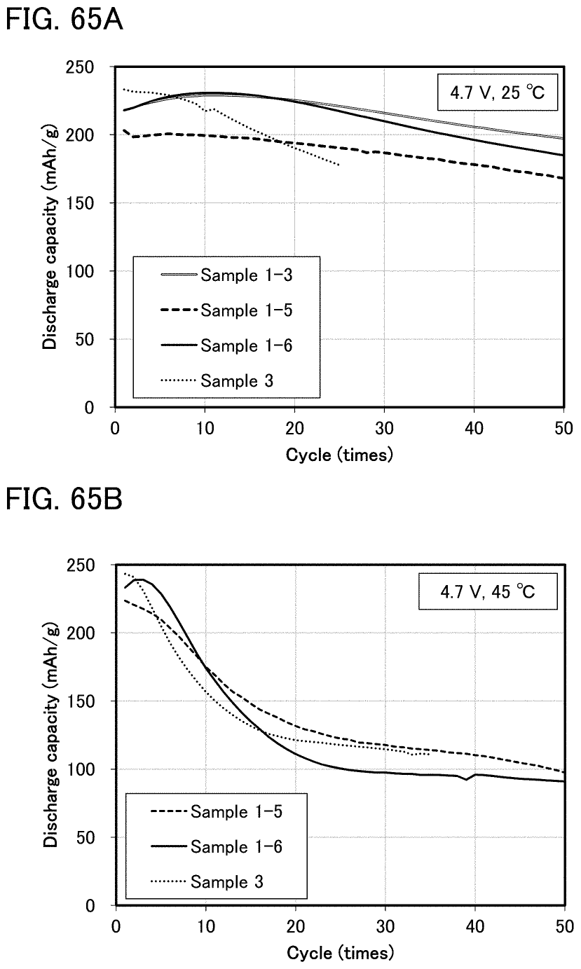

FIG. 64A shows charge and discharge cycle performance of Sample 1-5, Sample 1-7, and Sample 3 at a charge voltage of 4.65 V and a measurement temperature of 25° C. FIG. 64B shows charge and discharge cycle performance of Sample 1-5, Sample 1-7, and Sample 3 at a charge voltage of 4.65 V and a measurement temperature of 45° C. FIG. 65A shows charge and discharge cycle performance of Sample 1-3, Sample 1-5, Sample 1-7, and Sample 3 at a charge voltage of 4.7 V and a measurement temperature of 25° C. FIG. 65B shows charge and discharge cycle performance of Sample 1-5, Sample 1-7, and Sample 3 at a charge voltage of 4.7 V and a measurement temperature of 45° C.

At the measurement temperature of 25° C., Sample 1-3, Sample 1-5, and Sample 1-7 including magnesium, fluorine, nickel, and aluminum as the added elements showed favorable charge and discharge cycle performance up to the charge voltage of 4.7 V. Sample 3, which does not include nickel nor aluminum, had charge and discharge cycle performance slightly inferior to those of Sample 1-3, Sample 1-5, and Sample 1-7.

At the measurement temperature of 45° C., Sample 1-5 showed relatively favorable charge and discharge cycle performance even at 4.65 V. However, at 4.7 V, the discharge capacity of each sample was greatly decreased approximately before the 20th cycle.

Next, second batteries including lithium counter electrodes were formed similarly using Sample 1-6, Sample 4, Sample 5, and Sample 6 formed as described above, and the charge and discharge cycle performance was evaluated.

The charge voltage was set at 4.6 V, and the measurement temperature was set at 25° C. CC/CV charging (0.5 C, 4.6 V, 0.05 C cut) and CC discharging (0.5 C, 2.5 V cut) were performed, and a 10-minute break was taken before the next charging.

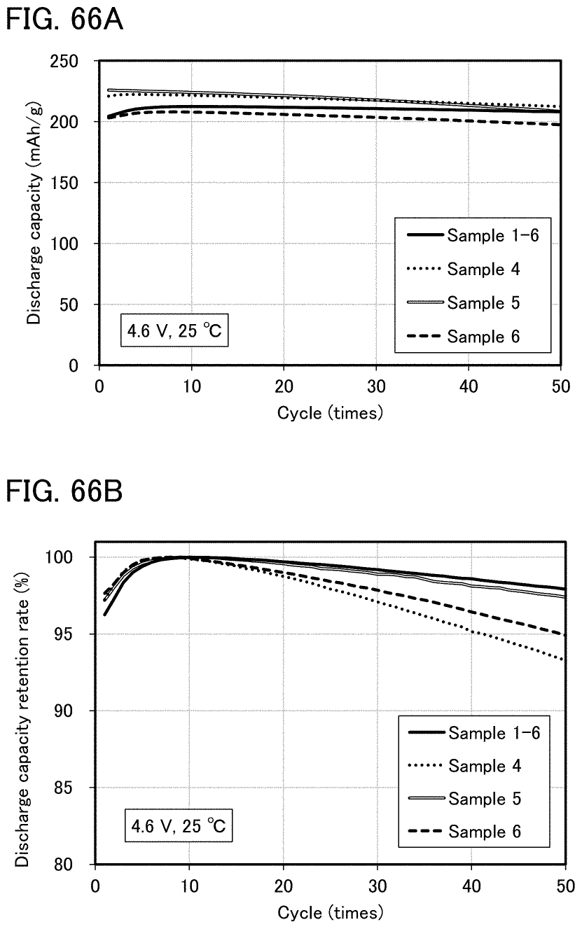

FIG. 66A and FIG. 66B show charge and discharge cycle performance. FIG. 66A shows discharge capacity, and FIG. 66B shows discharge capacity retention rate.

Sample 1-6, Sample 4, Sample 5, and Sample 6 each showed favorable charge and discharge cycle performance. Sample 1-5 including nickel and aluminum had the highest discharge capacity retention rate. Sample 5 including nickel showed the second highest discharge capacity retention rate next to Sample 1-6. Thus, it was revealed that including nickel improves the charge and discharge cycle performance.

Next, second batteries including lithium counter electrodes were formed similarly using Sample 1-8, Sample 2, Sample 7, and Sample 8 formed as described above, and the charge and discharge cycle performance was evaluated.

The charge voltage was set at 4.6 V, and the measurement temperature was set at 25° C. or 45° C. CC/CV charging (0.5 C, 4.6 V, 0.05 C cut) and CC discharging (0.5 C, 2.5 V cut) were performed, and a 10-minute break was taken before the next charging.

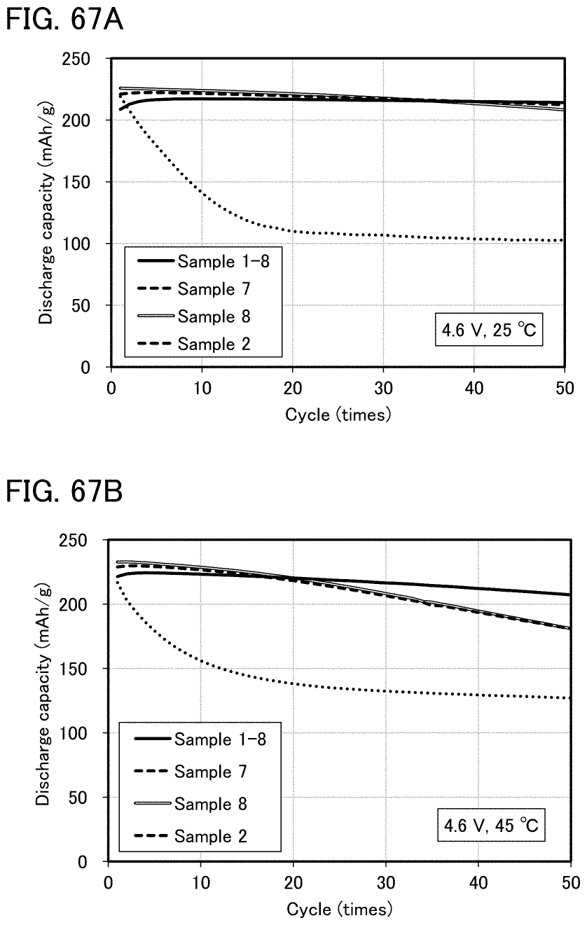

FIG. 67A shows charge and discharge cycle performance of Sample 1-8, Sample 2, Sample 7, and Sample 8 at a measurement temperature of 25° C. FIG. 67B shows charge and discharge cycle performance of Sample 1-8, Sample 2, Sample 7, and Sample 8 at a measurement temperature of 45° C.

Sample 1-8, Sample 7, and Sample 8 each showed favorable charge and discharge cycle performance. Especially at the measurement temperature of 45° C., Sample 1-8 including magnesium, fluorine, nickel, and aluminum showed extremely favorable charge and discharge cycle performance.

Thus, it was shown that including magnesium, fluorine, nickel, and aluminum as the added elements as in Sample 1-8 results in more favorable performance than including magnesium, fluorine, and titanium as the added elements as in Sample 8. This was more significant at a relatively high temperature of 45° C.

Thus, it was shown that the positive electrode active material of one embodiment of the present invention is a positive electrode active material which suppresses a decrease in charge and discharge capacity even when subjected to repetitive charging and discharging at high voltages of 4.5 V, 4.6 V, and 4.7 V in half cells. Furthermore, the positive electrode active material of one embodiment of the present invention showed favorable cycle performance at relatively high temperatures of 45° C., 55° C., and 65° C. This is because the positive electrode active material of one embodiment of the present invention includes the added elements in the surface portion and thereby has a crystal structure that is unlikely to be broken. Furthermore, it was confirmed that including nickel as a transition metal improves cycle performance in high-temperature or high-voltage charging and discharging.

### <Cycle Performance of Full Cell>

Secondary batteries including negative electrodes of graphite were formed using the positive electrode active material of Sample 1-1 formed as described above, and the charge and discharge cycle performance was evaluated.

The positive electrode was formed in a manner similar to that of the half cell.

The negative electrode uses graphite as the negative electrode active material, into which VGCF (registered trademark) (produced by SHOWA DENKO K.K.) which is a vapor-grown carbon fiber serving as the conductive material was mixed at 1.5 wt %.

As an electrolyte contained in an electrolyte solution, 1 mol/L of lithium hexafluorophosphate (LiPF₆) was used. As the electrolyte solution, a solution in which ethylene carbonate (EC) and diethyl carbonate (DEC) were mixed at EC:DEC=3:7 (volume ratio) was used.

As a separator, 25-μm-thick polypropylene was used.

As an exterior body, a laminate film was used.

The charge voltage was set at 4.5 V or 4.6 V. The measurement temperature was set at 25° C. or 45° C. CC/CV charging (0.5 C, each voltage, 0.05 C cut) and CC discharging (0.5 C, 3 V cut) were performed, and a 10-minute break was taken before the next charging.

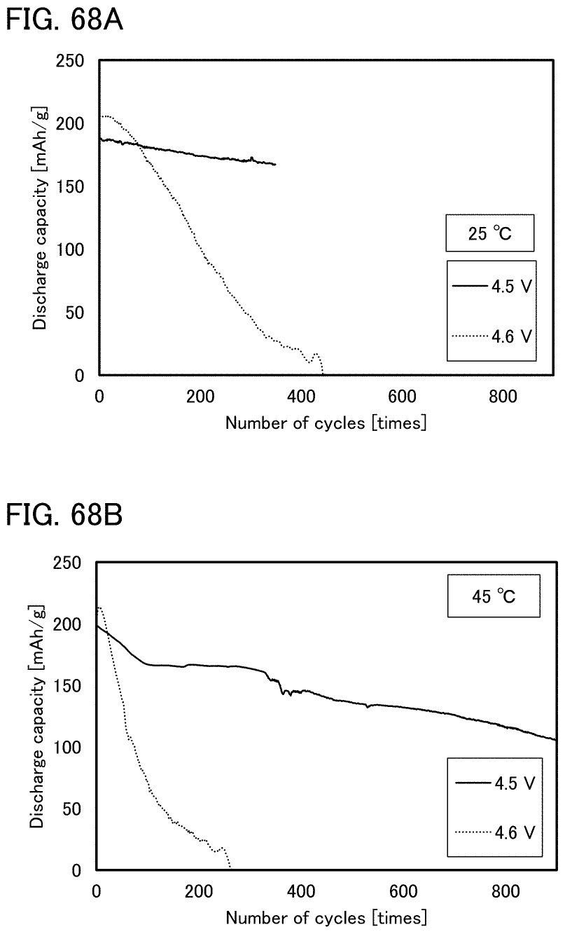

FIG. 68A shows charge and discharge cycle performance of Sample 1-1 at a measurement temperature of 25° C. FIG. 68B shows charge and discharge cycle performance of Sample 1-1 at a measurement temperature of 45° C.

At the charge voltage of 4.5 V in the full cell, Sample 1-1 showed favorable charge and discharge cycle performance.

### REFERENCE NUMERALS

100: positive electrode active material, 100a: surface portion, 100b: inner portion, 100c: outermost surface layer, 101: crystal grain boundary, 102: filling portion, 103: projection, 104: coating film

1. A positive electrode active material comprising lithium, cobalt, nickel, magnesium, and oxygen,
wherein an a-axis lattice constant of an outermost surface layer of the positive electrode active material A_{surface} is larger than an a-axis lattice constant of an inner portion of the positive electrode active material A_{core}, and
wherein a c-axis lattice constant of the outermost surface layer C_{surface} is larger than a c-axis lattice constant of the inner portion C_{core}.

2. The positive electrode active material according to claim 1,
wherein a rate of change R_{A} obtained by dividing a difference Δ_{A} between the a-axis lattice constant of the outermost surface layer A_{surface} and the a-axis lattice constant of the inner portion A_{core} by the lattice constant A_{core} is larger than 0 and less than or equal to 0.12, and
wherein a rate of change R_{C} obtained by dividing a difference Δ_{C} between the c-axis lattice constant of the outermost surface layer C_{surface} and the c-axis lattice constant of the inner portion C_{core} by the lattice constant C_{core} is larger than 0 and less than or equal to 0.18.

3. The positive electrode active material according to claim 2,
wherein the rate of change R_{A} is larger than or equal to 0.05 and less than or equal to 0.07, and
wherein the rate of change R_{C} is larger than or equal to 0.09 and less than or equal to 0.12.

4. The positive electrode active material according to claim 1,
wherein the difference Δ_{C} between the c-axis lattice constant of the outermost surface layer C_{surface} and the c-axis lattice constant of the inner portion C_{core} is larger than the difference Δ_{A} between the a-axis lattice constant of the outermost surface layer A_{surface} and the a-axis lattice constant of the inner portion A_{core}.

5. A positive electrode active material comprising lithium, cobalt, nickel, magnesium, and oxygen,
wherein at least part of an outermost surface layer of the positive electrode active material has a layered rock-salt crystal structure having a transition metal site layer and a lithium site layer alternately, and
wherein part of the lithium site layer comprises a metal element having a larger atomic number than lithium.

6. The positive electrode active material according to claim 5,
wherein the metal element having a larger atomic number than lithium is magnesium, cobalt, or aluminum.

7. The positive electrode active material according to claim 5,
wherein in a cross-sectional TEM image of the outermost surface layer, a luminance of the lithium site layer is greater than or equal to 3% and less than or equal to 60% of a luminance of the transition metal site layer.

8. The positive electrode active material according to claim 1,
wherein a nickel concentration in the outermost surface layer is less than or equal to 1 atomic %, and
wherein a nickel concentration is greater than or equal to 0.05% and less than or equal to 4% of a cobalt concentration in an entire positive electrode active material.

9. The positive electrode active material according to claim 1,
wherein the outermost surface layer comprises a region in which bright spots indicating a rock-salt crystal structure belonging to a space group Fm-3m or Fd-3m are observed and bright spots indicating a layered rock-salt crystal structure belonging to a space group R-3m are observed in a nanobeam electron diffraction pattern, and
wherein the inner portion comprises a region in which bright spots indicating the layered rock-salt crystal structure belonging to the space group R-3m are observed in a nanobeam electron diffraction pattern.

10. The positive electrode active material according to claim 1,
wherein a spin density attributed to any one or more of a divalent nickel ion, a trivalent nickel ion, a divalent cobalt ion, and a tetravalent cobalt ion is higher than or equal to 2.0×10¹⁷ spins/g and lower than or equal to 1.0×10²¹ spins/g.

11. The positive electrode active material according to claim 1,
wherein the positive electrode active material comprises aluminum, and
wherein an aluminum concentration is greater than or equal to 0.05% and less than or equal to 4% of a cobalt concentration in an entire positive electrode active material.

12. The positive electrode active material according to claim 11,
wherein a peak of the aluminum concentration is positioned at a depth of greater than or equal to 5 nm and less than or equal to 30 nm toward a center from a surface by energy dispersive X-ray spectroscopy on a cross section of the positive electrode active material.

13. A lithium-ion secondary battery comprising a positive electrode active material,
wherein the positive electrode active material comprises lithium, cobalt, nickel, magnesium, and oxygen,
wherein an a-axis lattice constant of an outermost surface layer of the positive electrode active material A_{surface} is larger than an a-axis lattice constant of an inner portion of the positive electrode active material A_{core}, and
wherein a c-axis lattice constant of the outermost surface layer of the positive electrode active material C_{surface} is larger than a c-axis lattice constant of the inner portion C_{core}.

14. An electronic device comprising the lithium-ion secondary battery according to claim 13.

15. The positive electrode active material according to claim 5,
wherein a nickel concentration in the outermost surface layer is less than or equal to 1 atomic %, and
wherein a nickel concentration is greater than or equal to 0.05% and less than or equal to 4% of a cobalt concentration in an entire positive electrode active material.

16. The positive electrode active material according to claim 5,
wherein a spin density attributed to any one or more of a divalent nickel ion, a trivalent nickel ion, a divalent cobalt ion, and a tetravalent cobalt ion is higher than or equal to 2.0×10¹⁷ spins/g and lower than or equal to 1.0×10²¹ spins/g.

17. The positive electrode active material according claim 5,
wherein the positive electrode active material comprises aluminum, and
wherein an aluminum concentration is greater than or equal to 0.05% and less than or equal to 4% of a cobalt concentration in an entire positive electrode active material.

18. The positive electrode active material according to claim 17,
wherein a peak of the aluminum concentration is positioned at a depth of greater than or equal to 5 nm and less than or equal to 30 nm toward a center from a surface by energy dispersive X-ray spectroscopy on a cross section of the positive electrode active material.
